(19) United States
(12) Patent Application Publication
(10) Pub. No.: US 2026/0025533 A1
(43) Pub. Date: Jan. 22, 2026

(54) SERVER, TERMINAL, AND METHOD

(71) Applicant: 17LIVE Japan Inc., Tokyo (JP)

(72) Inventors: Hirotaro MATSUMOTO, Tokyo (JP); Ayako YANASE, Tokyo (JP); Ryo YAMAMOTO, Tokyo (JP); Nagisa TASHIRO, Tokyo (JP)

(21) Appl. No.: 19/254,902

(22) Filed: Jun. 30, 2025

(30) Foreign Application Priority Data
Jul. 18, 2024 (JP) 2024-115046
Sep. 10, 2024 (JP) 2024-157030
Oct. 1, 2024 (JP) 2024-172815
Oct. 29, 2024 (JP) 2024-190128

(51) Int. Cl. H04N 21/2187; H04N 21/4788

(52) U.S. Cl. CPC H04N 21/2187; H04N 21/4788

(57) ABSTRACT

A server includes a circuitry, wherein the circuitry is configured to: obtain, at a first point of time during progress of a livestream, first time-series data representing content of the livestream recorded as the livestream progresses; generate summary information of the livestream as of the first point of time based on the first time-series data obtained; obtain, at a second point of time during progress of the livestream later than first point of time, second time-series data representing content of the livestream recorded as the livestream progresses; and generate summary information of the livestream as of the second point of time based on the second time-series data obtained.

### CROSS-REFERENCE TO RELATED APPLICATIONS

This application is based on and claims the benefit of priority from Japanese Patent Applications Serial Nos. 2024-115046 (filed on Jul. 18, 2024), 2024-157030 (filed on Sep. 10, 2024), 2024-172815 (filed on Oct. 1, 2024), and 2024-190128 (filed on Oct. 29, 2024), the contents of which are hereby incorporated by reference in their entirety.

### TECHNICAL FIELD

The present disclosure relates to a server, a terminal, and a method.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video streaming services also became popular as storage costs were reduced. And nowadays or in the Reiwa period (2019 to present), with the sophistication of smartphones and further improvements in network speed as typified by 5G, services that enable real-time communication through video, especially livestreaming services, are gaining recognition. The number of users of livestreaming services is expanding, especially among young people, as such services allow people to share the same good time even when they are in the separate locations from each other.

### SUMMARY

One aspect of the disclosure relates to a server. This server comprises a circuitry, wherein the circuitry is configured to: obtain, at a first point of time during progress of a livestream, first time-series data representing content of the livestream recorded as the livestream progresses; generate summary information of the livestream as of the first point of time based on the first time-series data obtained; obtain, at a second point of time during progress of the livestream later than first point of time, second time-series data representing content of the livestream recorded as the livestream progresses; and generate summary information of the livestream as of the second point of time based on the second time-series data obtained.

Another aspect of the disclosure relates to a terminal. This terminal of a livestreamer of a livestream comprises: one or more processors; and memory storing one or more computer programs configured to be executed by the one or more processors, the one or more computer programs including instructions for: transmitting a request to a server over a network; receiving, from the server over the network, summary information of a livestream in progress, the summary information having content that is variable according to a timing at which the request takes place; starting reproduction of a video related to the livestream; and displaying the summary information on a display as the reproduction of the video is started.

One aspect of the disclosure relates to a server. This server comprises: means for receiving, from a terminal of a livestreamer of a livestream over a network, data including behavior of the livestreamer, participants of the livestream including the livestreamer and a plurality of viewers including a virtual viewer realized by a machine learning model; means for obtaining a reaction output by the machine learning model, the machine learning model taking as input the behavior of the livestreamer and outputting the reaction that would be made by a viewer with a property set thereto; and means for transmitting data for realizing the reaction to the terminal over the network.

Another aspect of the disclosure relates to a computer program. This computer program causes a terminal of a livestreamer of a livestream, participants of which include the livestreamer and a plurality of different virtual viewers realized by a plurality of different machine learning models, to perform the functions of: transmitting data including behavior of the livestreamer to a server providing the livestream over a network; receiving, from the server over the network, data for realizing a plurality of reactions output from the plurality of machine learning models by inputting the behavior to the plurality of machine learning models; and displaying a plurality of objects representing the plurality of reactions on a display based on the data.

One aspect of the disclosure relates to a server. This server comprises: means for generating a plurality of different video data, each of which is a portion of an original video data; means for obtaining, from a terminal of a user over a network, information indicating at least one video data selected by the user from among the plurality of video data; means for obtaining, from the terminal over the network, an editing instruction by the user; means for obtaining edited video data output by a machine learning model to which the information and the editing instruction have been input; and means for providing the edited video data to the terminal over the network.

Another aspect of the disclosure relates to a computer program. This computer program causes a terminal of a livestreamer of a livestream to perform the functions of: displaying an object on a display of the terminal during the livestream in association with a video of the livestream; receiving designation of the object by the livestreamer during the livestream; and transmitting, to a server over a network, a timing at which the object was designated in the livestream. It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### BRIEF DESCRIPTION OF THE DRAWINGS

FIG. 1 schematically illustrates a configuration of a livestreaming system according to a first embodiment.

FIG. 2 is a block diagram showing functions and configuration of a user terminal in FIG. 1.

FIG. 3 is a block diagram showing functions and configuration of a server in FIG. 1.

FIG. 4 is a data structure diagram showing an example of a stream DB in FIG. 3.

FIG. 5 is a data structure diagram showing an example of a user DB in FIG. 3.

FIG. 6 is a data structure diagram showing an example of a gift DB shown in FIG. 3.

FIG. 7 illustrates the relationship between the progress of a livestream and the summaries generated.

FIG. 8 is a flowchart showing a series of steps related to dynamic summary generation for a livestream.

FIG. 9 is a representative screen image of a livestream selection screen on a display of an active user's user terminal.

FIG. 10 is a representative screen image of a livestreaming room screen on a display of a viewer's user terminal.

FIG. 11 is a representative screen image of the livestreaming room screen having a summary region superimposed thereon, which appears on the display of the viewer's user terminal.

FIG. 12 is a representative screen image of the livestreaming room screen having a summary region superimposed thereon, which appears on the display of the viewer's user terminal.

FIG. 13 is a representative screen image of a livestreaming room screen having a candidate comment display region superimposed thereon, which appears on the display of the viewer's user terminal.

FIG. 14 is a representative screen image of a livestream preparation screen displayed on the display of the livestreamer's user terminal.

FIG. 15 is a representative screen image of a livestreaming room screen on the display of the livestreamer's user terminal.

FIG. 16 is a block diagram showing an example of hardware configuration of an information processing device according to the embodiment.

FIG. 17 is a representative screen image of the livestreaming room screen on having a modified summary region superimposed thereon, which appears on the display of the viewer's user terminal.

FIG. 18 is a representative screen image of a livestreaming room screen in a preview mode on the display of the user terminal.

FIG. 19 is a schematic view for explaining an AI training livestream.

FIG. 20 is a block diagram showing functions and configuration of a server according to a second embodiment.

FIG. 21 is a data structure diagram showing an example of a stream DB in FIG. 20.

FIG. 22 is a data structure diagram showing an example of a user DB in FIG. 20.

FIG. 23 is a data structure diagram showing an example of an ML model DB in

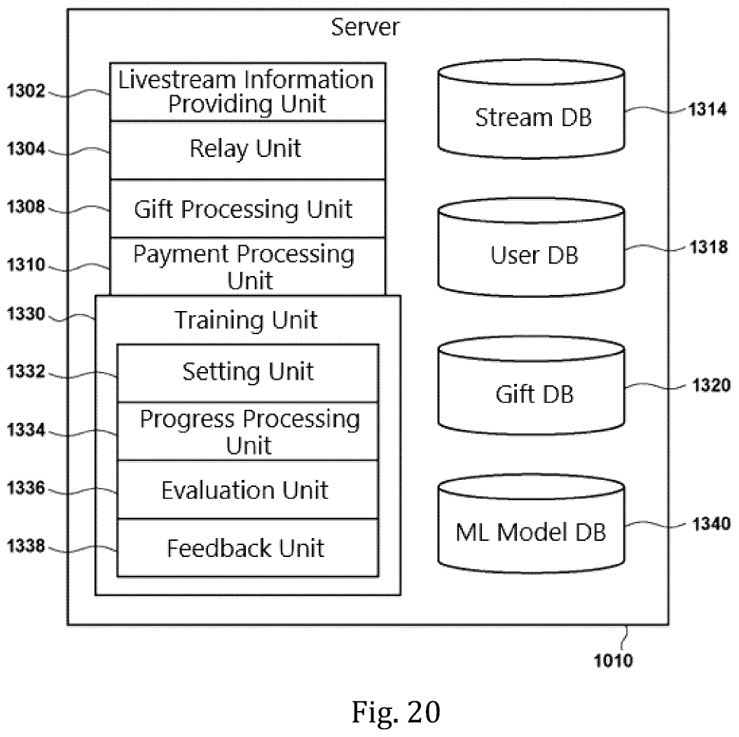

FIG. 20.

FIG. 24 is a flowchart showing a series of steps performed in an AI training livestream.

FIG. 25 is a representative screen image of a livestream preparation screen displayed on the display of the livestreamer's user terminal.

FIG. 26 is a representative screen image of a livestreaming room screen in the AI training livestream on the display of the livestreamer's user terminal.

FIG. 27 is a representative screen image of a livestreaming room screen in the AI training livestream on the display of the livestreamer's user terminal.

FIG. 28 is a representative screen image of a livestreaming room screen in the AI training livestream on the display of the livestreamer's user terminal.

FIG. 29 is a representative screen image of a livestream ending screen displayed on the display of the livestreamer's user terminal.

FIG. 30 is a representative screen image of a livestreaming room screen displayed on the display of the user terminal of a real-life viewer participating in the AI training livestream.

FIG. 31 is a representative screen image of a livestream selection screen on a display of an active user's user terminal.

FIG. 32 is a block diagram showing functions and configuration of a server according to a third embodiment.

FIG. 33 is a data structure diagram showing an example of a stream DB in FIG. 32.

FIG. 34 is a data structure diagram showing an example of an ML model DB in FIG. 32.

FIG. 35 is a flowchart showing a series of steps performed in a livestream in which an AI viewer participates.

FIG. 36 is a representative screen image of a livestream selection screen on a display of an active user's user terminal.

FIG. 37 is a representative screen image of a livestreaming room screen on a display of a viewer's user terminal.

FIG. 38 is a block diagram showing functions and configuration of a server according to a fourth embodiment.

FIG. 39 is a data structure diagram showing an example of a stream DB in FIG. 38.

FIG. 40 is a data structure diagram showing an example of a user DB in FIG. 38.

FIG. 41 is a data structure diagram showing an example of an archive DB in FIG. 38.

FIG. 42 is a data structure diagram showing an example of a clip DB in FIG. 38.

FIG. 43 is a data structure diagram showing an example of an edited video DB in FIG. 38.

FIG. 44 is a flowchart showing a series of steps performed on a user terminal of an editor during editing.

FIG. 45 is a flowchart showing a series of steps performed on a server during editing.

FIG. 46 is a representative screen image of an editing screen displayed on the display of the editor's user terminal.

FIG. 47 is a representative screen image of a livestreaming room screen displayed on the display of the livestreamer's user terminal during a livestream.

FIG. 48 is a representative screen image of a livestreaming room screen displayed on the display of the livestreamer's user terminal during a livestream.

FIG. 49 is a representative screen image of an archive browsing screen displayed on the display of the active user's user terminal.

### DESCRIPTION OF THE PREFERRED EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

### First Embodiment

Japanese Patent Application Publication No. 2022-075401 (“the '401 Publication”) discloses a technique of generating advice information for a livestreamer and displaying the advice information on the livestreamer's screen during a video livestream. This technique allows the livestreamer to perform a livestream while referring to the advice information displayed in real time.

According to the technique disclosed in the '401 Publication, the livestreamer can obtain information about new viewers who have participated in the livestream. However, the technology described in the '401 Publication does not provide any benefit to new viewers who have participated or are about to participate in a livestream.

One of the characteristics of a livestream is that because there is no script, the content can change from time to time based on interaction and communication with the viewers, and may move in a different direction than originally intended. Therefore, it is difficult for viewers who participate in the livestream in the middle thereof to grasp the flow and content of the livestream in a short time. Even if the title or thumbnails reflect the content of the livestream intended by the livestreamer prior to the start of the livestream, the story actually often goes in a different direction than originally intended as the livestream progresses, resulting in a discrepancy between the title or thumbnails and the actual content. In such a case, viewers who participate in the livestream in the middle thereof, anticipating the content represented by the title or thumbnails, may be confused when they see the actual content of the livestream.

The first embodiment of the disclosure was made in light of these issues, and one object thereof is to provide a technique that can enhance viewer convenience by providing a summary that reflects the current situation of the livestream to viewers who participate in the livestream in the middle thereof. According to the first embodiment, the viewer convenience can be enhanced by providing a summary that reflects the current situation of the livestream to viewers who participate in the livestream in the middle thereof.

In the livestreaming system according to this embodiment, when a viewer participates in a livestream in the middle thereof, the system provides the viewer with a summary of the situation generated by a machine learning model (e.g., a language analysis model such as GPT) from the previous conversations in that livestream. The summary is information that summarizes the topics of conversation, the flow of conversation, symbolic events, the livestreamer's actions, activities, and emotions, viewer's comments, actions, and gifting situations, the atmosphere of the livestream, and the content of the livestream. This allows viewers who participate in the livestream in the middle thereof to read the summary provided and quickly understand what has been discussed so far in the livestream and what the current flow of the conversation is. As a result, it is easier for viewers who participate in the livestream in the middle thereof to enter the livestream conversation, and therefore, the viewers can enjoy the livestream more, which increases retention and engagement.

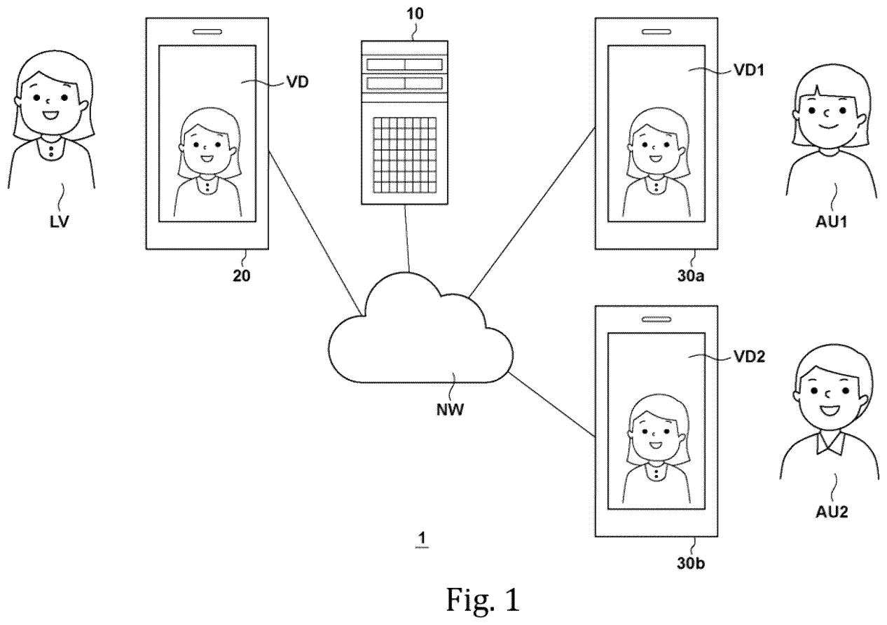

FIG. 1 schematically illustrates a configuration of a livestreaming system 1 according to the first embodiment. The livestreaming system 1 provides an interactive livestreaming service that allows a livestreamer LV (also referred to as a liver or streamer) and viewers AU (also referred to as audience) (AU1, AU2, . . . ) to communicate in real time. As shown in FIG. 1, the livestreaming system 1 includes a server 10, a user terminal 20 on the livestreamer side, and user terminals 30 (30a, 30b . . . ) on the viewer side. In addition to the livestreamer who is livestreaming and the viewers who are watching the livestream, there may be users who have logged in the livestreaming platform but are neither livestreaming nor watching the livestream. Such users are herein referred to as active users. The livestreamer, viewers, and active users may be collectively referred to as users. The server 10 may be constituted by one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, user terminal 20, and user terminals 30 are interconnected so as to be able to communicate with each other over the various wired or wireless networks NW.

The livestreaming system 1 involves the livestreamer LV, the viewers AU, and an administrator (not shown) who manages the server 10. The livestreamer LV is a person who broadcasts contents in real time by recording the contents with his/her user terminal 20 and uploading them directly to the server 10. Examples of the contents may include the livestreamer's own songs, talks, performances, fortune-telling, gameplays, and any other contents. The administrator provides a platform for livestreaming contents on the server 10, and also mediates or manages real-time interactions between the livestreamer LV and the viewers AU. The viewers AU access the platform through their user terminals 30 to select and view a desired content. During livestreaming of the selected content, the viewer AU performs operations to comment, cheer, or ask fortune-telling via the user terminal 30, the livestreamer LV who is delivering the content responds to such a comment, cheer, or request, and such response is transmitted to the viewer AU via video and/or audio, thereby establishing an interactive communication.

As used herein, the term “livestreaming” or “livestream” may mean a mode of data transmission that allows a content recorded at the user terminal 20 of the livestreamer LV to be played and viewed at the user terminals 30 of the viewers AU substantially in real time, or it may mean a live broadcast realized by such a mode of transmission. The livestreaming may be achieved using existing livestreaming technologies such as HTTP Live Streaming, Common Media Application Format, Web Real-Time Communications, Real-Time Messaging Protocol and MPEG DASH. The livestreaming includes a transmission mode in which, while the livestreamer LV is recording contents, the viewers AU can view the contents with a certain delay. The delay is acceptable as long as interaction between the livestreamer LV and the viewers AU can be at least established. Note that the livestreaming is distinguished from so-called on-demand distribution, in which contents are entirely recorded and the entire data is once stored on the server and the server provides users with the data at any subsequent time upon request from the users.

The term “video data” herein refers to data that includes image data (also referred to as moving image data) generated using an image capturing function of the user terminals 20 and 30 and audio data generated using an audio input function of the user terminals 20 and 30. Video data is played back on the user terminals 20 and 30, so that the users can view contents. In this embodiment, it is assumed that between video data generation at the livestreamer's user terminal and video data reproduction at the viewer's user terminal, processing is performed onto the video data to change its format, size, or specifications of the data, such as compression, decompression, encoding, decoding, or transcoding. However, such processing does not substantially change the content (e.g., video images and audios) represented by the video data, so that the video data after such processing is herein described as the same as the video data before such processing. In other words, when video data is generated at the livestreamer's user terminal, transmitted via the server 10, and then reproduced at the viewer's user terminal, the video data generated at the livestreamer's user terminal, the video data that passes through the server 10, and the video data received and reproduced at the viewer's user terminal are all the same video data.

In the example in FIG. 1, a livestreamer LV is livestreaming his/her talk. The user terminal 20 of the livestreamer LV generates video data by recording images and sounds of the livestreamer LV who is talking, and the generated video data is transmitted to the server 10 over the network NW. At the same time, the user terminal 20 displays the recorded video image VD of the livestreamer LV on the display of the user terminal 20 to allow the livestreamer LV to check the livestream currently performed.

The respective user terminals 30a and 30b of the viewers AU1 and AU2, who have requested the platform to enable them to view the livestream of the livestreamer LV, receive video data related to the livestream over the network NW and reproduce the received video data, to display video images VD1 and VD2 on the displays and output audio through the speakers. The video images VD1 and VD2 displayed at the user terminals 30a and 30b, respectively, are substantially the same as the video image VD captured by the user terminal 20 of the livestreamer LV, and the audio outputted at the user terminals 30a and 30b is substantially the same as the audio recorded by the user terminal 20 of the livestreamer LV.

Recording of the images and sounds at the user terminal 20 of the livestreamer LV and reproduction of the video data at the user terminals 30a and 30b of the viewers AU1 and AU2 are performed substantially simultaneously. The viewer AU1 may type a comment about the talk of the livestreamer LV on the user terminal 30a, and the server 10 may display the comment on the user terminal 20 of the livestreamer LV in real time and also display the comment on the user terminals 30a and 30b of the viewers AU1 and AU2, respectively. The livestreamer LV may read the comment and develop his/her talk to cover and respond to the comment, and the video and sound of the talk are output on the user terminals 30a and 30b of the viewers AU1 and AU2, respectively. This interactive action is recognized as establishment of a conversation between the livestreamer LV and the viewer AU1. In this way, the livestreaming system 1 realizes a livestream that enables the interactive communication, not one-way communication.

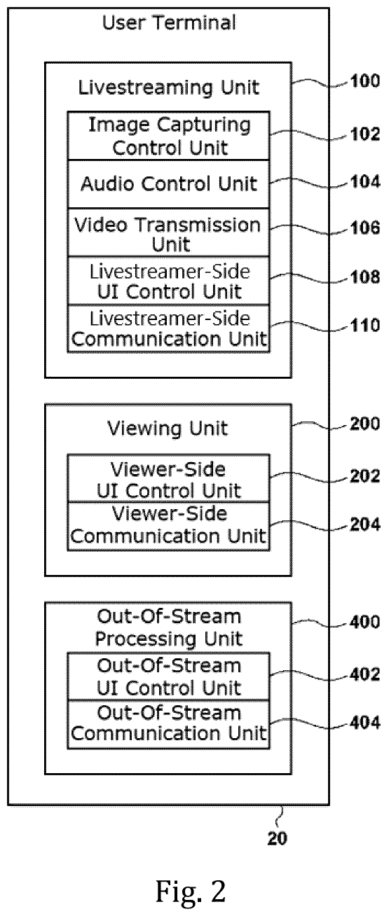

FIG. 2 is a block diagram showing functions and configuration of the user terminal 20 of FIG. 1. The user terminals 30 have the same functions and configuration as the user terminal 20. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The livestreamer LV and the viewers AU download and install a livestreaming application program (hereinafter referred to as a livestreaming application), onto the user terminals 20 and 30 from a download site over the network NW. Alternatively, the livestreaming application may be pre-installed on the user terminals 20 and 30. When the livestreaming application is executed on the user terminals 20 and 30, the user terminals 20 and 30 communicate with the server 10 over the network NW to implement various functions. Hereinafter, the functions implemented by (processors such as CPUs of) the user terminals 20 and 30 running the livestreaming application will be described as functions of the user terminals 20 and 30. These functions are realized in practice by the livestreaming application on the user terminals 20 and 30. In any other embodiments, these functions may be realized by a computer program written in a programming language such as HTML (HyperText Markup Language), which is transmitted from the server 10 to web browsers of the user terminals 20 and 30 over the network NW and executed by the web browsers.

The user terminal 20 includes a livestreaming unit 100 for recording the user's image and sound to generate and provide video data to the server 10, a viewing unit 200 for acquiring and reproducing the video data from the server 10, and an out-of-livestream processing unit 400 for processing requests made by active users. The user activates the livestreaming unit 100 to livestream, the viewing unit 200 to view a livestream, and the out-of-livestream processing unit 400 to look for a livestream, view a livestreamer's profile, or watch an archive. The user terminal having the livestreaming unit 100 activated is the livestreamer's terminal, i.e., the user terminal that generates video data, the user terminal having the viewing unit 200 activated is the viewer's terminal, i.e., the user terminal that reproduces video data, and the user terminal having the out-of-livestream processing unit 400 activated is the active user's terminal.

The livestreaming unit 100 includes an image capturing control unit 102, an audio control unit 104, a video transmission unit 106, a livestreamer-side UI control unit 108, and a livestreamer-side communication unit 110. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time.

The livestreamer-side UI control unit 108 controls a UI for the livestreamer. The livestreamer-side UI control unit 108 is connected to a display (not shown in FIG. 2), and displays a video image on the display by reproducing the video data that is to be transmitted by the video transmission unit 106. The livestreamer-side UI control unit 108 is also connected to input means (not shown in FIG. 2) such as touch panels, keyboards, and displays, and obtains the livestreamer's input via the input means. The livestreamer-side UI control unit 108 superimposes a predetermined frame image on the video image. The frame image includes various user interface objects (hereinafter simply referred to as “objects”) for receiving inputs from the livestreamer, comments entered by the viewers, and information obtained from the server 10. The livestreamer-side UI control unit 108 receives, for example, the livestreamer's inputs made by the livestreamer tapping the objects.

The livestreamer-side communication unit 110 controls communication with the server 10 during a livestream. The livestreamer-side communication unit 110 transmits the content of the livestreamer's input that has been obtained by the livestreamer-side UI control unit 108 to the server 10 over the network NW. The livestreamer-side communication unit 110 receives various information associated with the livestream from the server 10 over the network NW.

The viewing unit 200 includes a viewer-side UI control unit 202 and a viewer-side communication unit 204. The viewer-side communication unit 204 controls communication with the server 10 during a livestream. The viewer-side communication unit 204 receives, from the server 10 over the network NW, video data related to the livestream in which the livestreamer and the viewer participate.

The viewer-side UI control unit 202 controls the UI for the viewer. The viewer-side UI control unit 202 is connected to a display and a speaker (not shown in FIG. 2), and reproduces the received video data so that video images are displayed on the display and sounds are output through the speaker. The state where the images and sounds are respectively output through the display and speaker can be referred to as “the video data is reproduced”. The viewer-side UI control unit 202 is also connected to input means (not shown in FIG. 2) such as touch panels, keyboards, and displays, and obtains the viewer's input via the input means. The viewer-side UI control unit 202 superimposes a predetermined frame image on an image generated from the video data obtained from the server 10. The frame image includes various objects for receiving inputs from the viewer, comments entered by the viewer, and information obtained from the server 10. The viewer-side communication unit 204 transmits the content of the viewer's input that has been obtained by the viewer-side UI control unit 202 to the server 10 over the network NW.

The out-of-livestream processing unit 400 includes an out-of-livestream UI control unit 402 and an out-of-livestream communication unit 404. The out-of-livestream UI control unit 402 controls a UI for the active user. For example, the out-of-stream UI control unit 402 generates a livestream selection screen and shows the screen on the display. The livestream selection screen presents a list of livestreams to which the active user is currently invited to participate, to allow the active user to select a livestream. The out-of-livestream UI control unit 402 generates a profile screen for any user and shows the screen on the display. The out-of-livestream UI control unit 402 generates a search screen for enabling an input of a search keyword to be used in a search for a livestreamer and shows the screen on the display. The out-of-livestream UI control unit 402 generates a search result display screen including results of the search for the livestreamer and shows the screen on the display. The out-of-livestream UI control unit 402 plays back an archived past livestream, which is recorded and stored.

The out-of-livestream communication unit 404 controls communication with the server 10 that takes place outside a livestream. The out-of-livestream communication unit 404 receives, from the server 10 over the network NW, information necessary to generate the livestream selection screen, results of searches for livestreamers, information necessary to generate the profile screen, and archived data. The out-of-livestream communication unit 404 transmits the content of the active user's input to the server 10 over the network NW.

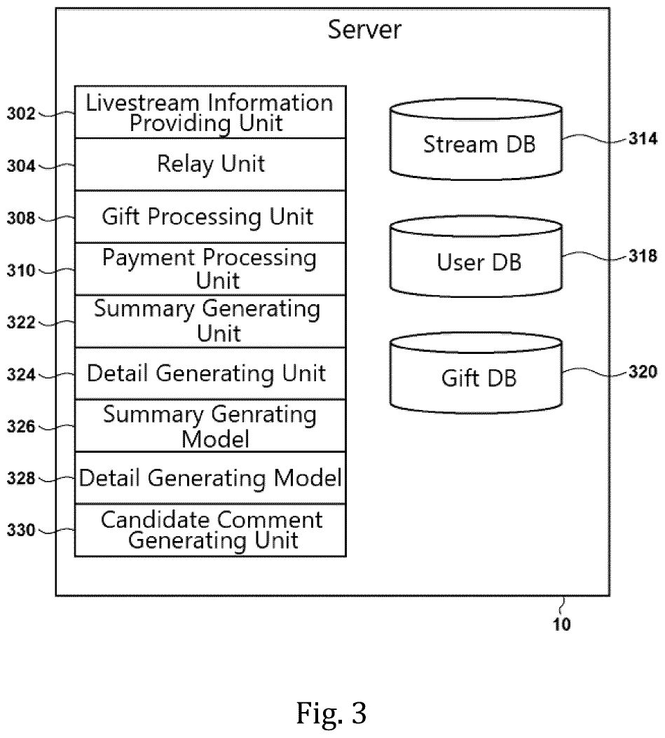

FIG. 3 is a block diagram showing functions and configuration of the server 10 of FIG. 1. The server 10 includes a livestream information providing unit 302, a relay unit 304, a gift processing unit 308, a payment processing unit 310, a stream DB 314, a user DB 318, a gift DB 320, s summary generating unit 322, a detail generating unit 324, a summary generating model 326, a detail generating model 328, and a candidate comment generating unit 330.

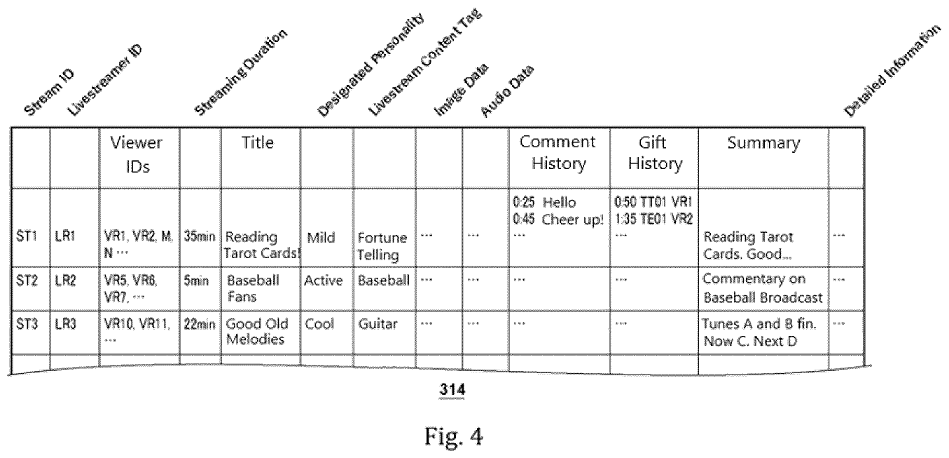

FIG. 4 is a data structure diagram showing an example of the stream DB 314 of FIG. 3. The stream DB 314 holds information regarding livestreams currently taking place. The stream DB 314 holds video data including images and audio of videos livestreamed by livestreamers. The stream DB 314 stores a stream ID for identifying a livestream on a livestreaming platform provided by the livestreaming system 1, a livestreamer ID, which is a user ID for identifying the livestreamer who delivers the livestream, viewer IDs, which are user IDs for identifying viewers of the livestream, a streaming duration, which is the amount of time from the start of the livestream to the present, a title of the livestream set by the livestreamer prior to the start of the livestream, a personality of the summary generating model set by the livestreamer prior to the start of the livestream, a livestream content tag indicating the content of the livestream, image data of the livestream up to the present, audio data of the livestream up to the present, a history of comments posted in the livestream, a history of gifts used in the livestream, a summary of the livestream at the present, and detailed information on the livestream at the present, in association with each other. The summary and detailed information will be described later.

In the livestreaming platform provided by the livestreaming system 1 of the embodiment, when a user livestreams, the user is referred to as a livestreamer, and when the same user views a livestream delivered by another user, the user is referred to as a viewer. Therefore, the distinction between a livestreamer and a viewer is not fixed, and a user ID entered as a livestreamer ID at one time may be entered as a viewer ID at another time.

The livestream content tag of a livestream may be designated by the livestreamer when starting the livestream or obtained from real-time analysis of the livestream by a machine learning model.

The title of the livestream and the livestream content tag set previously, which represent the content of the livestream, are static information that does not change as the livestream progresses. In contrast, the livestream content tag based on real-time analysis, image data, audio data, comment history, gift history, and number of viewers are dynamic information or time-series data that represent the content of the livestream and change as the livestream progresses. Time-series data has a structure in which data is arranged along a time axis. The time-series data is recorded in the stream DB 314 as the livestream progresses.

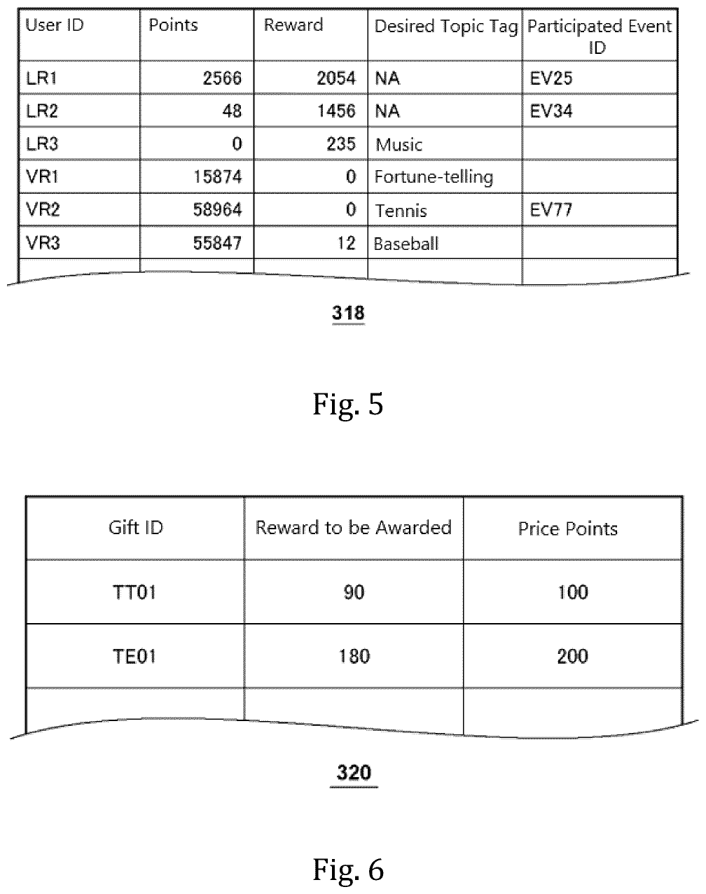

FIG. 5 is a data structure diagram showing an example of the user DB 318 of FIG. 3. The user DB 318 holds information regarding users. The user DB 318 stores a user ID identifying a user, points owned by the user, a reward awarded to the user, a desired topic tag indicating a topic designated by the user based on his/her interest, and a participated event ID identifying an event in which the user is participating. The event is related to the livestream that is held on the livestreaming platform provided by the livestreaming system 1. There are various forms of events, including ranking and prize-winning.

The points are an electronic representation of value circulated in the livestreaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

FIG. 6 is a data structure diagram showing an example of the gift DB 320 of FIG. 3. The gift DB 320 holds information regarding gifts available for the viewers in livestreams. A gift is electronic data with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be used by the viewer at any time after purchased.
When a viewer gives a gift to a livestreamer, the livestreamer is awarded a corresponding reward.
When a gift is used, the use may trigger an effect associated with the gift. For example, an effect corresponding to the gift will appear on the livestreaming room screen.

The gift DB 320 stores: a gift ID for identifying a gift; a reward to be awarded, which is a reward awarded to a livestreamer when the gift is given to the livestreamer; and price points, which is the amount of points to be paid for use of the gift, in association with each other. A viewer is able to give a desired gift to a livestreamer by paying the price points of the desired gift while viewing the livestream. The payment of the price points may be made by appropriate electronic payment means. For example, the payment may be made by the viewer paying the price points to the administrator. Alternatively, bank transfers or credit card payments may be available. The administrator can freely determine the relationship between the reward to be awarded and the price points. For example, the administrator may determine that the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points.

Returning to FIG. 3, the summary generating model 326 is a pre-trained machine learning model that receives as input the time-series data of the livestream and outputs the text representing the summary of the livestream (hereafter referred to simply as the summary). Since the output summary changes as the input time-series data changes, the output summary can be regarded as the summary as of the time the corresponding time-series data was obtained. The machine learning model may be realized using known machine learning techniques such as BERT (Bidirectional Encoder Representations from Transformers) or GPT (Generative Pretrained Transformer). The machine learning model for generating a summary is well known and is not detailed herein. The time-series data includes non-text data such as image data and audio data as described above. If necessary, known image analysis techniques may be used to convert image data into text data representing its content (see, e.g., “Demonstration of AI Answering Content of Image with Text,” ExaWizards Inc.,

URL: https://techblog.exawizards.com/entry/2019/02/15/175416). To convert the audio data into text data, any known STT (Speech to Text) technology may be used. Thus, non-text data may be converted into text data before being input into the summary generating model 326. In addition to the time-series data, the static information on the livestream may be input to the summary generating model 326. For example, information on the event in which the livestreamer of the livestream is participating, as recorded in the user DB 318, may be input into the summary generating model 326.

The summary generating model 326 can be configured with one of several different personalities. On the livestream preparation screen prior to the start of the livestream, the livestreamer designates the personality of the model to be used for generating a summary. When the livestream information providing unit 302 receives a livestream start instruction with the designated personality from the livestreamer's terminal over the network, it adjusts the summary generating model 326 with the designated personality. For example, if the personality “cool” is designated, the summary generating model 326 is adjusted to output text with a cool tone, and if the personality “hot” is designated, the summary generating model 326 is adjusted to output text with a hot tone. This personality setting may be accomplished using known prompt engineering techniques. The summary generating model 326 may receive personality as one of the input parameters, or an instance of the summary generating model 326 may be generated and used for each ongoing livestream or for each of several different personalities.

The detail generating model 328 is a pre-trained machine learning model that receives as input the time-series data of the livestream and outputs the text representing the detailed information on the livestream (hereafter referred to simply as the detailed information). The detailed information on the livestream is text that describes the livestream in more detail than the summary of the livestream, and is longer than the summary. Since the output detailed information changes as the input time-series data changes, the output detailed information can be regarded as the detailed information as of the time the corresponding time-series data was obtained. In addition to the time-series data, the static information on the livestream may be input to the detail generating model 328.

The detail generating model 328 can be configured with one of several different personalities. On the livestream preparation screen prior to the start of the livestream, the livestreamer designates the personality of the model to be used for generating details. When the livestream information providing unit 302 receives a livestream start instruction with the designated personality from the livestreamer's terminal over the network, it adjusts the detail generating model 328 with the designated personality.

Upon reception of a livestream start instruction to start a livestream from the user terminal 20 of a livestreamer over the network NW, the livestream information providing unit 302 enters in the stream DB 314 the stream ID identifying the livestream, the livestreamer ID of the livestreamer who delivers the livestream, the title included in the livestream start instruction, the designated personality included in the livestream start instruction, and the livestream content tag included in the livestream start instruction. At the same time, the livestream information providing unit 302 starts to obtain time-series data of the livestream, i.e., viewers, image data, audio data, comment history, and gift history, and record the obtained time-series data in the stream DB 314.

When the livestream information providing unit 302 receives a request for information about livestreams from the out-of-livestream communication unit 404 of a user terminal of an active user over the network NW, the livestream information providing unit 302 refers to the stream DB 314 and generates a list of currently available livestreams. The livestream information providing unit 302 transmits the generated list to the requesting user terminal over the network NW. The out-of-stream UI control unit 402 of the requesting user terminal generates a livestream selection screen based on the received list and shows the livestream selection screen on the display of the user terminal.

Once the out-of-livestream UI control unit 402 of the user terminal receives the active user's selection of a livestream on the livestream selection screen, the out-of-livestream UI control unit 402 generates a livestream request including the stream ID of the selected livestream, and transmits the livestream request to the server 10 over the network NW. The livestream information providing unit 302 obtains from the stream DB 314 the summary and the detailed information of the livestream identified by the stream ID included in the received livestream request, and transmits them to the requesting user terminal over the network NW. At the same time, the livestream information providing unit 302 starts providing, to the requesting user terminal, the livestream identified by the stream ID included in the received livestream request. The livestream information providing unit 302 updates the stream DB 314 such that the user ID of the active user of the requesting user terminal is included in the viewer IDs associated with the stream ID. In this way, the active user can be a viewer of the selected livestream.

The relay unit 304 relays the video data from the user terminal 20 of the livestreamer to the user terminals 30 of the viewers in the livestream started by the livestream information providing unit 302. The relay unit 304 receives from the viewer-side communication unit 204 a signal that represents user input by a viewer during the livestream, or during reproduction of the video data. The signal that represents user input may be an object designation signal that indicates designation of an object displayed on the display of the user terminal 30, and the object designation signal includes the viewer ID of the viewer, the livestreamer ID of the livestreamer of the livestream that the viewer watches, and an object ID that identifies the object. When the object is a gift icon, the object ID is a gift ID. The object designation signal in that case is a gift use signal indicating that the viewer uses a gift for the livestreamer. Similarly, the relay unit 304 receives from the livestreamer-side communication unit 110 of the livestreaming unit 100 in the user terminal 20 a signal that represents user input by the livestreamer during reproduction of the video data, such as the object designation signal.

The gift processing unit 308 updates the user DB 318 so as to increase the reward for the livestreamer according to the reward to be awarded of the gift identified by the gift ID included in the gift use signal. Specifically, the gift processing unit 308 refers to the gift DB 320 to specify a reward to be awarded for the gift ID included in the received gift use signal. The gift processing unit 308 then updates the user DB 318 to add the specified reward to be awarded to the reward for the livestreamer ID included in the gift use signal.

The payment processing unit 310 processes payment of a price of the gift by the viewer in response to reception of the gift use signal. Specifically, the payment processing unit 310 refers to the gift DB 320 to specify the price points of the gift identified by the gift ID included in the gift use signal. The payment processing unit 310 then updates the user DB 318 to subtract the specified price points from the points of the viewer identified by the viewer ID included in the gift use signal.

The summary generating unit 322 periodically obtains time-series data and generates a summary. The summary generating unit 322 periodically, e.g., once every 5 minutes, obtains time-series data of an ongoing livestream from the stream DB 314. The summary generating unit 322 generates a summary as of the time of obtaining the time-series data of the ongoing livestream based on the obtained time-series data. The summary generating unit 322 inputs the obtained time-series data to the summary generating model 326 and obtains the summary output by the summary generating model 326 as the summary as of the time of obtaining the time-series data. The summary generating unit 322 updates the stream DB 314 with the obtained summary. For example, when the summary generating unit 322 newly obtains a summary of a certain livestream, it overwrites the summary previously held for that livestream in the stream DB 314 with the obtained summary.

The first time-series data obtained by the summary generating unit 322 at the first point of time during the progress of the livestream is different from the second time-series data obtained by the summary generating unit 322 at the second point of time during the progress of the livestream, which is later than the first point of time. Therefore, there may be difference between the summary as of the first point of time generated based on the first time-series data and the summary as of the second point of time generated based on the second time-series data.

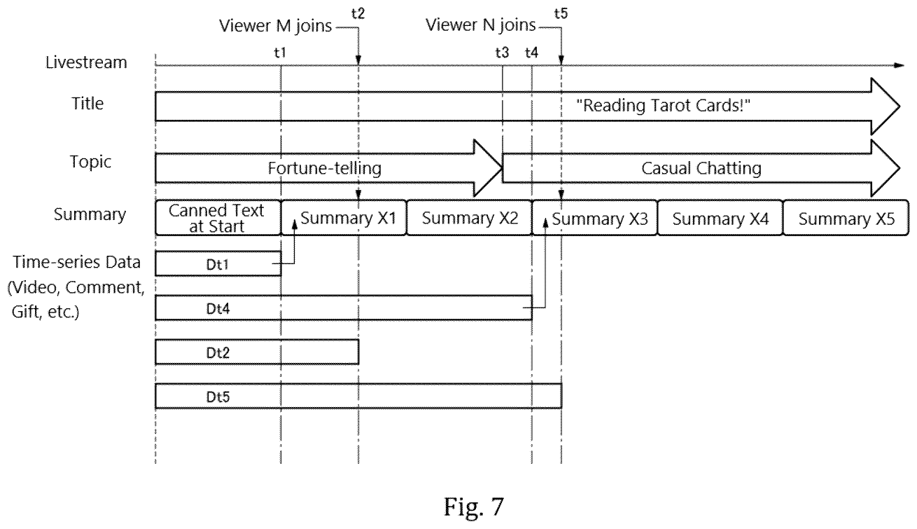

FIG. 7 illustrates the relationship between the progress of a livestream and the summaries generated. The top row of FIG. 7 shows the time line of the livestream progression. In this example, the title is designated by the livestreamer prior to the start of the livestream, so regardless of the progress of the livestream, the title is fixed to the text “I am doing tarot reading!” However, the topic in the livestream, which was initially fortune-telling, changed to casual chatting at point of time t3.

The summary generating unit 322 generates a summary constituted by canned text at the start of livestream and enters it in the stream DB 314. The canned text (also called default text) does not depend on the time-series data of the livestream, but is text generated based on information (static information) entered by the livestreamer prior to the start of the livestream or fixed text that does not depend on the livestreamer, such as “I have just started the livestream”. Then, at point of time t1 during the progress of the livestream, the summary generating unit 322 obtains the time-series data Dt1 from the stream DB 314. This time-series data Dt1 represents the content of fortune-telling, which is the topic in the livestream up to point of time t1. For example, if the livestreamer has performed fortune-telling for three viewers by point of time t1, the time-series data Dt1 includes the results of the fortune-telling for those three viewers in chronological order. The summary generating unit 322 inputs the obtained time-series data Dt1 to the summary generating model 326, obtains the summary output by the summary generating model 326 as the summary X1 as of the point of time t1, and enters the summary X1 in the stream DB 314.

Subsequently, a viewer M joins in the livestream at point of time t2 before the next summary update point. At this time, the livestream information providing unit 302 obtains the summary X1 as of point of time t1 from the stream DB 314 and transmits it to the user terminal of the viewer M over the network NW. This allows the viewer M to immediately understand that a fortune-telling session has recently taken place in the livestream, just as the title indicates.

Then, at point of time t3, the topic changes from fortune-telling to casual chatting. Then, at point of time t4 during the progress of the livestream, the summary generating unit 322 obtains the time-series data Dt4 from the stream DB 314. This time-series data Dt4 represents the content of the livestream up to point of time t4, initially focused on fortune-telling but later shifting to casual chatting. The summary generating unit 322 inputs the obtained time-series data Dt4 to the summary generating model 326, obtains the summary output by the summary generating model 326 as the summary X3 as of the point of time t4, and enters the summary X3 in the stream DB 314.

Subsequently (after point of time t4), a viewer N joins in the livestream at point of time t5 before the next summary update point. At this time, the livestream information providing unit 302 obtains the summary X3 as of point of time t4 from the stream DB 314 and transmits it to the user terminal of the viewer N over the network NW. This allows the viewer N to immediately understand that, contrary to the title, casual chatting is taking place in the recent part of the livestream.

Returning to FIG. 3, the detail generating unit 324 generates detailed information as of the time of obtaining the time-series data of the ongoing livestream based on the time-series data obtained by the summary generating unit 322. The detail generating unit 324 inputs the obtained time-series data to the detail generating model 328 and obtains the detailed information output by the detail generating model 328 as the detailed information as of the time of obtaining the time-series data. The detail generating unit 324 updates the stream DB 314 with the obtained detailed information. For example, when the detail generating unit 324 newly obtains detailed information on a certain livestream, it overwrites the detailed information previously held for that livestream in the stream DB 314 with the obtained detailed information.

When the candidate comment generating unit 330 receives a livestream request for a livestream, it obtains from the stream DB 314 the time-series data of the ongoing livestream identified by the stream ID included in the livestream request. The candidate comment generating unit 330 generates a plurality of different candidate comments based on the obtained time-series data. The candidate comment generating unit 330 transmits the generated candidate comments to the requesting user terminal over the network NW.

The candidate comment generating unit 330 inputs the obtained time-series data to the candidate comment generating model and obtains a plurality of different candidate comments output by the candidate comment generating model. The candidate comment generating model is a pre-trained machine learning model that receives as input the time-series data of the livestream and outputs a plurality of candidate comments that are suitable for posting by the viewer at the time of obtaining the time-series data. Since the output candidate comments change as the input time-series data changes, the contents of the candidate comments may vary depending on when the livestream request takes place.

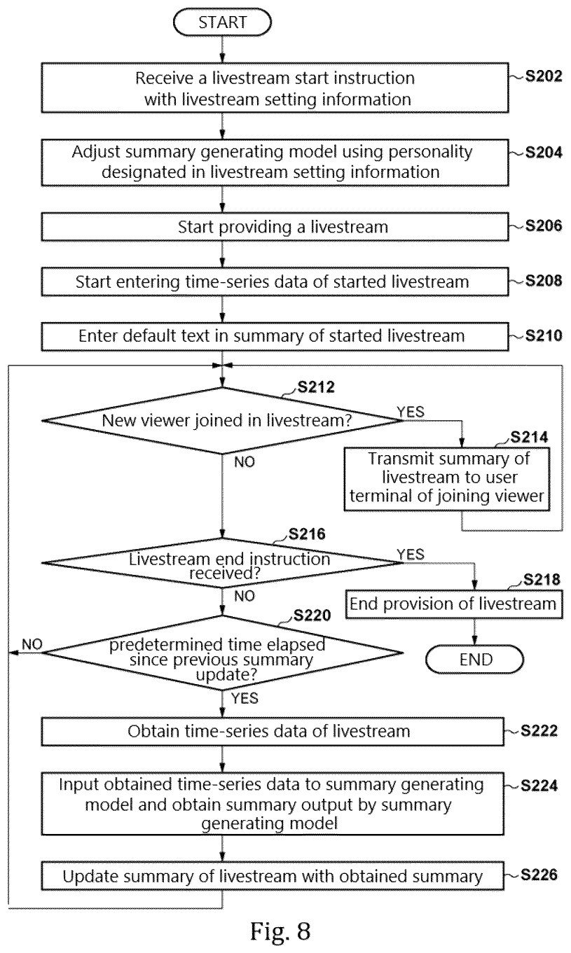

The operation of the livestreaming system 1 with the above configuration will be now described. FIG. 8 is a flowchart showing a series of steps related to dynamic summary generation for a livestream. The livestream information providing unit 302 receives a livestream start instruction with livestream setting information including the personality designated by the livestreamer (S202). The summary generating unit 322 adjusts the summary generating model 326 using the personality designated in the livestream setting information received in step S202 (S204). The livestream information providing unit 302 starts providing a livestream in response to the livestream start instruction received in step S202 (S206). The livestream information providing unit 302 starts entering time-series data of the started livestream (S208). The summary generating unit 322 updates the stream DB 314 so that a default text is entered in the summary of the started livestream (S210).

The livestream information providing unit 302 determines whether or not a new viewer has joined in the livestream that it started to provide in step S206 (S212). If a new viewer has joined (YES in S212), the livestream information providing unit 302 extracts the summary of the livestream from the stream DB 314 and transmits it to the user terminal of the joining viewer (S214) as the video of the livestream starts to be provided. The process then returns to step S212.

If no viewer has joined in step S212 (NO in S212), the livestream information providing unit 302 determines whether or not a livestream end instruction has been received from the user terminal of the livestreamer (S216). If a livestream end instruction has been received (YES in S216), the livestream information providing unit 302 ends the provision of the livestream (S218). If a livestream end instruction has not been received (NO in S216), the summary generating unit 322 determines whether or not a predetermined period of time, e.g., 5 or 15 minutes, has elapsed since the previous summary update for the livestream started in step S206 (S220). If the predetermined period of time has not elapsed (NO in S220), the process returns to step S212.

If the predetermined period of time has elapsed (YES in S220), the summary generating unit 322 obtains from the stream DB 314 the time-series data of the livestream started in step S206 (S222). The summary generating unit 322 inputs the obtained time-series data to the summary generating model 326 and obtains the summary output by the summary generating model 326 (S224). The summary generating unit 322 updates the stream DB 314 so that the summary of the livestream started in step S206 is updated or replaced with the summary obtained in step S224 (S226). The process then returns to step S212.

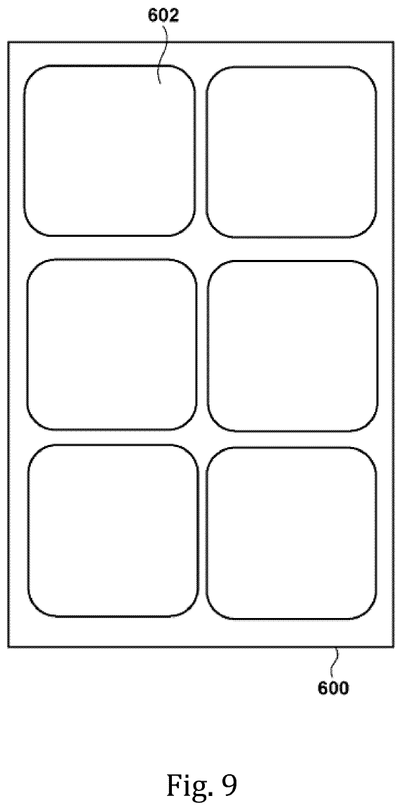

FIG. 9 is a representative screen image of a livestream selection screen 600 on a user terminal display of an active user. The livestream selection screen 600 includes thumbnails 602 representing livestreams in the list of currently available livestreams received from the server 10. The out-of-livestream UI control unit 402 generates the livestream selection screen 600 based on the list of livestreams obtained from the server 10 and shows the screen on the display. Once the out-of-livestream UI control unit 402 receives the active user's selection of a thumbnail on the livestream selection screen 600, the out-of-livestream UI control unit 402 generates a livestream request including the stream ID of the livestream corresponding to the selected thumbnail, and transmits the livestream request to the server 10 over the network NW. The livestream information providing unit 302 obtains from the stream DB 314 the summary and the detailed information of the livestream identified by the stream ID included in the received livestream request, and transmits them to the requesting user terminal over the network NW. At the same time, the livestream information providing unit 302 transmits a plurality of candidate comments generated in response to the livestream request to the requesting user terminal over the network NW. The out-of-livestream communication unit 404 receives the summary, detailed information, and candidate comments thus transmitted, from the server 10 over the network NW. As described above, the summary and the detailed information are information about the currently available, i.e., currently ongoing, livestream, and their contents may vary depending on when the livestream request takes place.

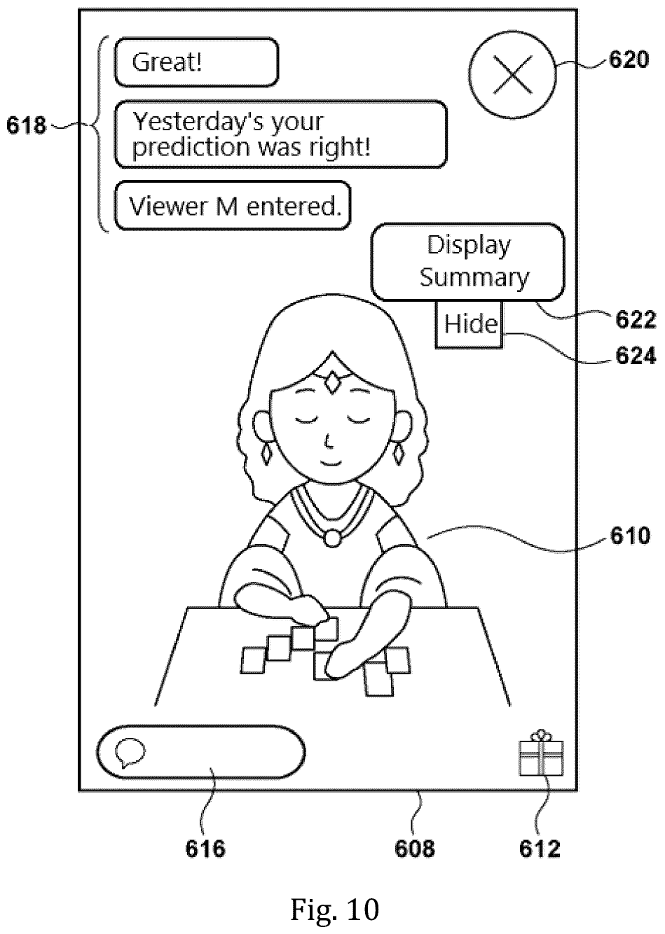

FIG. 10 is a representative screen image of a livestreaming room screen 608 shown on the display of the viewer's user terminal. When the active user taps the thumbnail 602 on the livestream selection screen 600 of FIG. 9, the viewer-side UI control unit 202 starts displaying the livestreaming room screen 608 of FIG. 10 on the display, and starts playing a video related to the livestream in the livestreaming room screen 608. The livestreaming room screen 608 displays a video image generated by the user terminal 20 of the livestreamer in real time. The livestreaming room screen 608 includes a video image 610 of the livestreamer obtained by reproducing the video data received from the server 10, a gift object 612, a comment input region 616, a comment display region 618, a quit viewing button 620, and a summary display object 622. The viewer-side UI control unit 202 superimposes objects such as the gift object 612, the comment input region 616, the comment display region 618, the quit viewing button 620, and the summary display object 622 on the video image 610 obtained by reproducing the video data, to generate the livestreaming room screen 608.

The comment display region 618 may include a comment entered by the viewer and comments entered by other viewers, and notifications from the system. The notifications from the system may include information indicating who gave which gift to the livestreamer and information indicating that a new viewer has joined in the livestream. The viewer-side UI control unit 202 generates the comment display region 618 that includes comments of other viewers received from the server 10 and notifications from the system, and the viewer-side UI control unit 202 inserts the generated comment display region 618 in the livestreaming room screen 608.

The comment input region 616 receives a comment input by the viewer. The viewer-side communication unit 204 generates a comment input signal that includes the comment entered in the comment input region 616, and transmits the signal to the server 10 over the network NW. At the same time, the viewer-side UI control unit 202 updates the comment display region 618 to display the comment entered in the comment input region 616.

The quit viewing button 620 is an object for receiving an instruction from the viewer to quit viewing the livestream. A hide object 624 is an object for hiding the summary display object 622. When a tap on the hide object 624 is detected, the viewer-side UI control unit 202 ends the display of the summary display object 622 and the hide object 624.

Once the playback of the video related to the livestream is started, the viewer-side UI control unit 202 of the user terminal displays a summary of the livestream received from the server 10 on the display. In the example shown in FIG. 10, the viewer-side UI control unit 202 first displays the summary display object 622 on the display as playback of the video related to the livestream is started, and when receiving a designation of the summary display object 622 (for example, when detecting a tap on the summary display object 622), the viewer-side UI control unit 202 generates a summary region 626 that displays the summary received from server 10 in response to the livestream request. The viewer-side UI control unit 202 displays the generated summary region 626 on the livestreaming room screen 608.

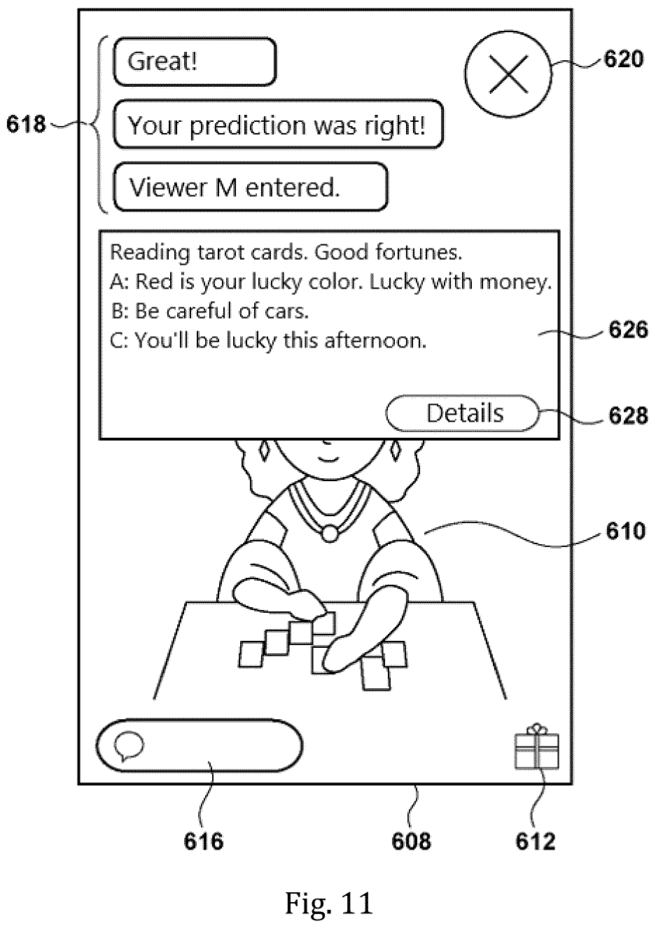

FIG. 11 is a representative screen image of the livestreaming room screen 608 having a summary region 626 superimposed thereon, which appears on the display of the viewer's user terminal. FIG. 11 corresponds to the display of the livestreaming room screen at the time when the viewer M has joined in the livestream in FIG. 7. The summary region 626 displays a detail object 628 as the summary is provided. The summary region 626 includes a summary of the livestream joined in and the detail object 628. When receiving the designation of the detail object 628, the viewer-side UI control unit 202 generates a detailed information region (not shown) that displays the detailed information received from the server 10 in response to the livestream request. The viewer-side UI control unit 202 displays the generated detailed information region on the livestreaming room screen 608.

In other embodiments, instead of or in addition to the summary display region, the summary may be displayed in the comment display region 618, or the summary may be output audibly. Alternatively, in the case where a livestream assistant using a machine learning model is provided on the livestreaming room screen, the assistant may output the summary.

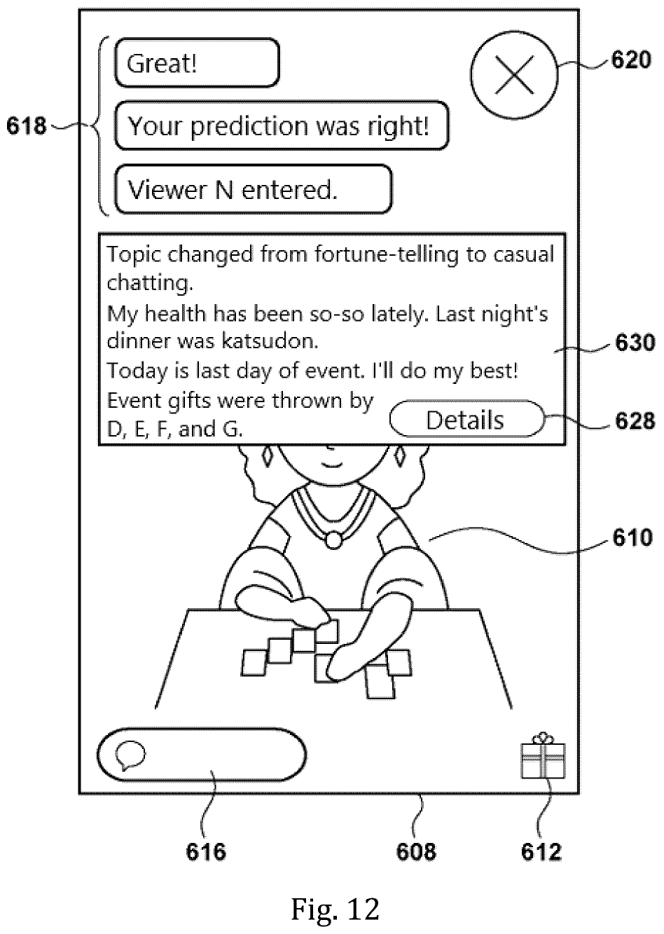

FIG. 12 is a representative screen image of the livestreaming room screen 608 having a summary region 630 superimposed thereon, which appears on the display of the viewer's user terminal. FIG. 12 corresponds to the display of the livestreaming room screen at the time when the viewer N has joined in the livestream in FIG. 7. The summary region 630 displays a detail object 628 as the summary is provided. The summary region 630 includes a summary of the livestream joined in and the detail object 628.

Once the summary is provided, the viewer-side UI control unit 202 of the user terminal displays a plurality of candidate comments received from the server 10 on the display. In the example shown in FIG. 12, the viewer-side UI control unit 202 stops displaying the summary region 630 after a predetermined period of time, e.g., 10 seconds, has elapsed since the display of the summary region 630 is started. Alternatively, the viewer-side UI control unit 202 also stops displaying the summary region 630 when it detects a tap on a region other than the summary region 630. When the viewer-side UI control unit 202 stops displaying the summary region 630, it generates a candidate comment display region 636 that displays a plurality of candidate comments received from the server 10. The viewer-side UI control unit 202 displays the generated candidate comment display region 636 on the livestreaming room screen 608.

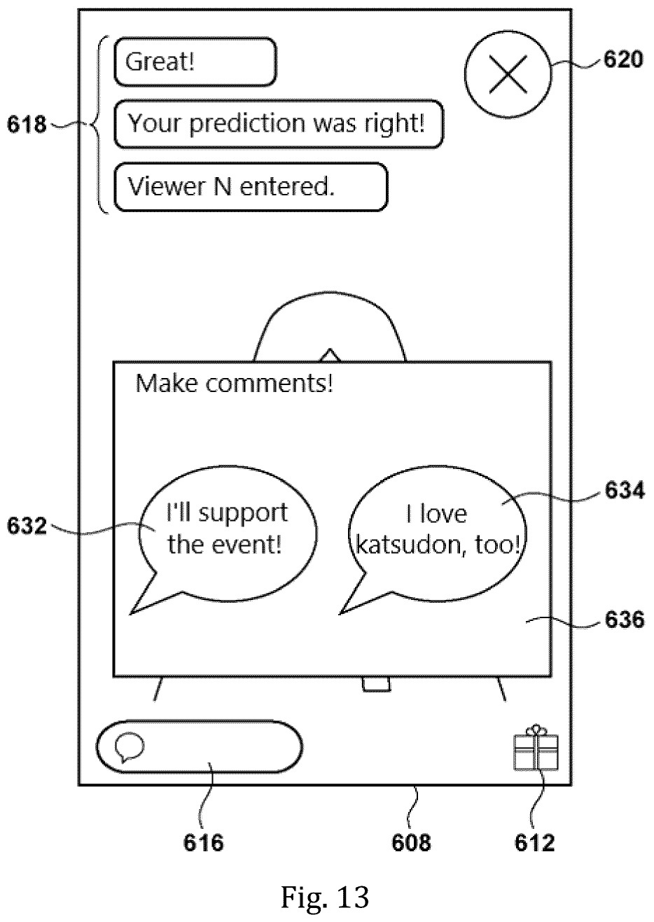

FIG. 13 is a representative screen image of a livestreaming room screen 608 having a candidate comment display region 636 superimposed thereon, which appears on the display of the viewer's user terminal. FIG. 13 corresponds to the state after the display of the summary region 630 in FIG. 12 is ended. The candidate comment display region 636 includes a first candidate object 632 that displays the first candidate comment in text and a second candidate object 634 that displays the second candidate comment in text. On detection of the tap on the first candidate object 632, the viewer-side communication unit 204 generates a comment input signal including the first candidate comment, and transmits the signal to the server 10 over the network NW. At the same time, the viewer-side UI control unit 202 updates the comment display region 618 to display the first candidate comment. The same process is performed when the second candidate object 634 is tapped.

Some viewers are not good at interaction, which can make it difficult for them to post initial comments after joining in the livestream. To address this issue, providing a mechanism to select from appropriate candidate comments for posting can activate the livestream by lowering the barrier to posting an initial comment or making it easier to comment.

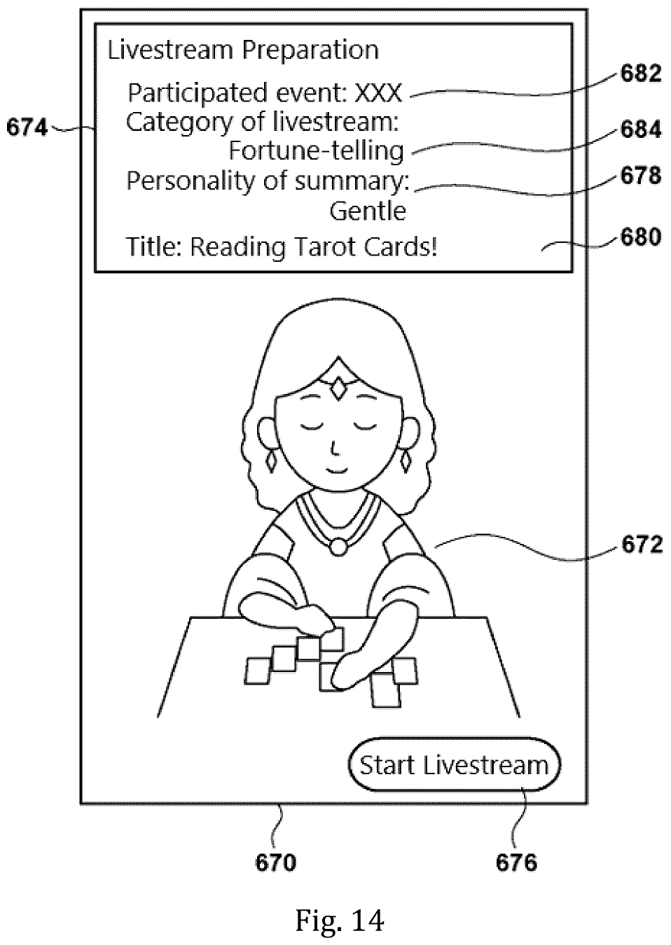

FIG. 14 is a representative screen image of a livestream preparation screen 670 displayed on the display of the livestreamer's user terminal. The livestream preparation screen 670, which is displayed before the livestreamer starts a livestream, receives livestream settings made by the livestreamer. The livestream preparation screen 670 includes a video image 672 of the livestreamer obtained by reproducing the video data transmitted by the video transmission unit 106, a livestream setting region 674 for receiving the livestream settings, and a start livestream button 676.

The livestream setting region 674 includes an event setting region 682 that receives input or selection of an event in which the livestreamer participates, a tag setting region 684 that receives input or selection of a livestream content tag that represent the content of the livestream, a personality setting region 678 that receives input or selection of the personality of the summary generating model 326 or the detail generating model 328, and a title setting region 680 that receives input of the title. The livestreamer inputs the desired settings in the livestream setting region 674 and taps the start livestream button 676. When the tap on the start livestream button 676 is detected, the livestreamer-side communication unit 110 of the livestreamer's user terminal generates livestream setting information including the event, livestream content tag, personality, and title that are currently input in the livestream setting region 674, and transmits a livestream start instruction with the generated livestream setting information to the server 10 over the network NW.

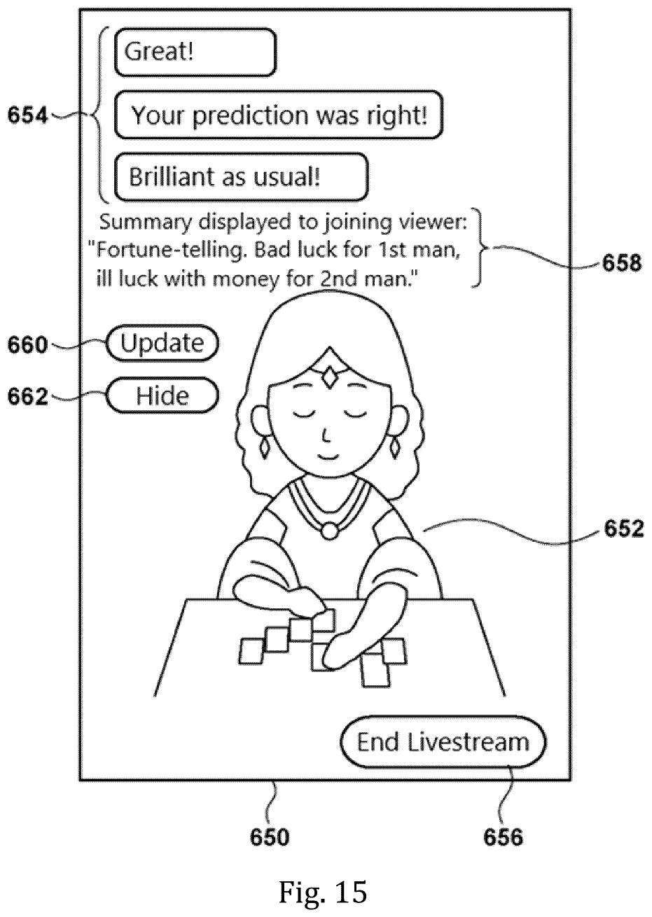

FIG. 15 is a representative screen image of the livestreaming room screen 650 shown on the display of the livestreamer's user terminal. The livestreaming room screen 650 displays a video image generated by the user terminal of the livestreamer in real time. The livestreaming room screen 650 includes a video image 652 of the livestreamer obtained by reproducing the video data transmitted by the video transmission unit 106, a comment display region 654, an end livestream button 656, a summary display region 658, an update object 660, and a hide object 662. The summary display region 658, the update object 660, and the hide object 662 are displayed in association with each other. The livestreamer-side UI control unit 108 superimposes objects such as the end livestream button 656, the comment display region 654, the summary display region 658, the update object 660, and the hide object 662 on the video image 652 obtained by reproducing the video data, to generate the livestreaming room screen 650.

The end livestream button 656 is an object for receiving an instruction from the livestreamer to terminate the delivery of the livestream.

The summary display region 658 displays a summary of the livestream, which is shown on the display of the user terminal of the viewer who is newly joining in the livestream at the present. The livestreamer-side communication unit 110 periodically, e.g., once every five minutes, generates a summary provision request and transmits it to the server 10 over the network NW. Upon receiving the summary provision request from the livestreamer's user terminal, the summary generating unit 322 obtains a summary of the livestream being performed by the livestreamer from the stream DB 314. The summary generating unit 322 transmits the obtained summary to the requesting user terminal over the network NW. The livestreamer-side UI control unit 108 generates a summary display region 658 containing the received summary text and displays it on the livestreaming room screen 650.

When a tap on the update object 660 is detected, the livestreamer-side communication unit 110 generates an update request and transmits it to the server 10 over the network NW. Upon receiving the update request from the livestreamer's user terminal, the summary generating unit 322 obtains time-series data of the livestream being performed by the livestreamer and generates a summary. The summary generating unit 322 transmits the generated summary to the requesting user terminal over the network NW. The livestreamer-side UI control unit 108 updates the display of the summary display region 658 with the received summary text.

When a tap on the hide object 662 is detected, the livestreamer-side UI control unit 108 ends the display of the summary display region 658, the update object 660, and the hide object 662.

The summary display region 658 allows the livestreamer to see the summary presented to new viewers joining in his or her livestream at the present, and to have it changed through the update object 660 if the summary is not appropriate. If the display of the summary is disturbing, it can be turned off through the hide object 662. A rejection object may be displayed in association with the summary display region 658 on the livestreaming room screen 650. When the rejection object is designated, the user terminal generates a summary display rejection signal and sends it to the server 10. The server 10 will not provide a summary to viewers newly joining in the livestream for which it received the summary display rejection signal. This allows the livestreamer to prevent an undesired summary from being provided.

In the above embodiment, an example of the database (DB) is a hard disk or semiconductor memory, for example. By reading the present disclosure, those skilled in the art would understand that each element or component can be realized by a CPU not shown, a module of an installed application program, a module of a system program, or a semiconductor memory that temporarily stores the contents of data read from a hard disk, and the like.

In the livestreaming system 1 according to the embodiment, a summary of the livestream is generated based on the time-series data of the livestream. As the livestream progresses and the time-series data is updated, the content of the summary is also updated. The summary is provided to viewers who join in the livestream in the middle thereof. Thus, newly joining viewers can quickly understand, by watching the summary, what is happening in the livestream and the flow of the conversation. As a result, viewers can smoothly enter the communication circle in the livestream, increasing their satisfaction. In addition, compared to static information such as titles, the summary represents more accurately the content of the livestream, thus reducing or eliminating mismatches between the livestream and the viewers.

In the livestreaming system 1 according to the embodiment, the summary generating model 326 generates a summary by processing the time-series data. This allows for real-time summary generation and updating, which is difficult to achieve manually. Unlike VOD, livestreaming requires real-time performance of summary generation, and such real-time performance can be achieved by applying a machine learning model as in this embodiment.

In the livestreaming system 1 according to the embodiment, the server 10 receives information for adjusting the summary generating model 326 and the detail generating model 328 from the user terminal of the livestreamer when starting a livestream. The summary generating model 326 and the detail generating model 328 are adjusted according to this information. Thus, it is possible to generate summaries and detailed information in line with the livestreamer's intentions, allowing each livestreamer to claim his/her own unique characteristics.

In the first embodiment, it was described that when a viewer joins in an ongoing livestream, a summary of this livestream is presented to the viewer, but this is not limitative. For example, when a viewer starts watching an archive of a livestream, a clip (video) including a portion of the archive, a VOD (video on demand) video, a profile video, or a preview of a livestream, a summary thereof may be provided to the viewer.

In the first embodiment, it was described that the summary generating model 326 outputs the summary in text, but this is not limitative. The summary generating model 326 may generate summary information including marks, effects, sound, still images, and video (such as explanatory video), instead of or in addition to text. Alternatively, in the case of a livestream or a live walk report with an AR application, the summary generating model 326 may obtain the actual video, live video, and recorded video captured by the camera of the livestreamer's user terminal, and current location based on the GPS function, and generate a summary based on the obtained information. Such a summary may include, for example, text describing the route of the livestreamer's walk that has been followed. Such text may include text describing, for example, the current location of the livestreamer after having traveled from somewhere to somewhere.

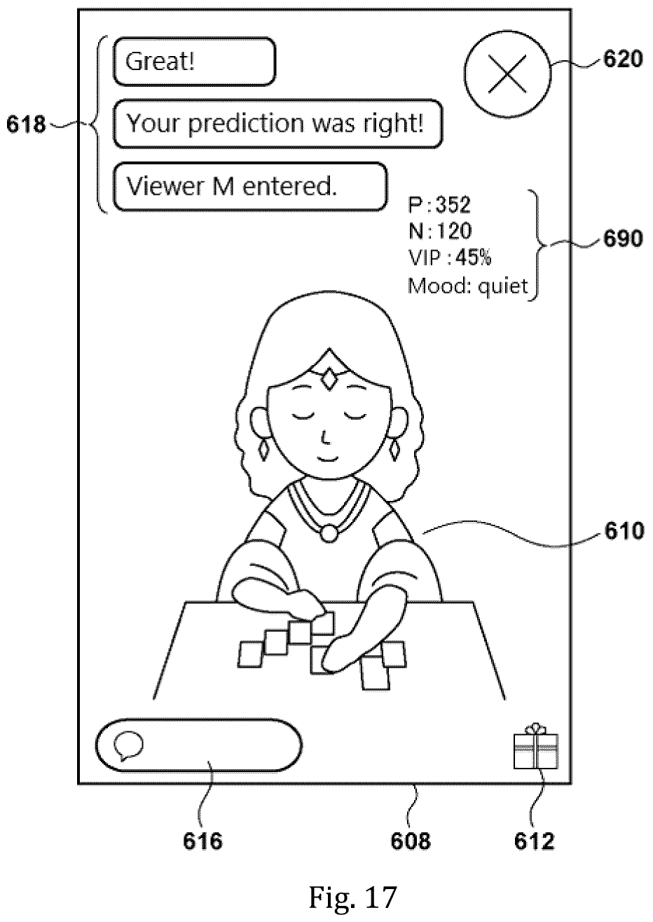

FIG. 17 is a representative screen image of the livestreaming room screen 608 having a summary region 690 according to a modification example superimposed thereon, which appears on the display of the viewer's user terminal. When receiving the time-series data as input, the summary generating model according to this modification example outputs a positive index, negative index, VIP rate, and mood as summary information. The summary region 690 displays these summary information items received from the server 10 at the start of livestream viewing. In the example shown in FIG. 17, the positive index (P) is 352, the negative index (N) is 120, the VIP rate is 45%, and the mood is “quiet”. The positive index is an index that rises when positive comments or livestreamer remarks are made. The negative index is an index that rises when negative comments or livestreamer remarks are made. In another embodiment, the positive and negative indexes may be combined and expressed as a single parameter. For example, a positive rate is 60% (negative rate is 100−60=40%). The VIP rate indicates the percentage of the amount of communication by high-value gifters in the total amount of communication in the livestream. For example, if the total number of comments is 1000, and the summed number of comments from the high-value gifters, i.e., the viewer with the highest total amount of gifting, the viewer with the second highest total amount of gifting, and the viewer with the third highest total amount of gifting in the livestream, is 500, then the VIP rate is 500/1000=0.5, or 50%. The mood indicates the mood of the livestream, and in addition to quiet, there are other moods such as bright, dark, complaining, high tension, low tension, and encouraged by everyone.

In addition to the examples of summary information shown in FIG. 17, the generated summary information may include the number, type, and trend of gifts used in the livestream, the gifts that the livestreamer wants and the use thereof, the set list and the information such as the songs that have been played and the song currently being played in a music livestream, and the information such as the games that have been played, the game currently being played, the stage currently being played, and the feature of the stage in a game livestream. In the first embodiment, it was described that a summary is generated by a machine learning model, but this is not limitative. The summary information may be generated using a predetermined formula or lookup table, particularly when marks and parameters as described above are used as summary information. Alternatively, the server may obtain information obtained from the external Internet regarding the livestream and the livestreamer to be summarized, information about the livestream and the livestreamer recorded on the livestream platform, and clip and archived videos of the livestreamer, and generate a summary based on the obtained information.

In the first embodiment, it was described that the summary generating unit 322 periodically obtains time-series data to generate a summary, but this is not limitative. Upon a viewer's joining in the livestream, a summary at that point may be generated and provided to the viewer. Referring to the example shown in FIG. 7, the summary generating unit obtains time-series data Dt2 from the stream DB 314 at point of time t2 when the viewer M joins in the livestream, and generates a summary as of point of time t2 based on the obtained time-series data Dt2. The livestream information providing unit provides the generated summary to the user terminal of the viewer M. The summary generating unit obtains time-series data Dt5 from the stream DB 314 at point of time t5 when the viewer N joins in the livestream, and generates a summary as of point of time t5 based on the obtained time-series data Dt5. The livestream information providing unit provides the generated summary to the user terminal of the viewer N. The summary generating unit may also generate a summary based on viewer properties. In this case, the summary generating unit obtains from the user DB 318 the desired topic tag of the viewer who joined in the livestream, in addition to the time-series data, and generates a summary based on the obtained time-series data and desired topic tag. In addition to the time-series data, the desired topic tag is input to the summary generating model. The summary generating model outputs different summaries for the same time-series data with different desired topic tags. In addition to the desired topic tag, properties such as gender, age (group), region, language, billing amount, duration, and ban history may be used for summary generation.

In the first embodiment, it was described that candidate comments are generated in response to a livestream request, but this is not limitative. The candidate comments may be generated periodically. In the first embodiment, it is also possible to generate the reason why a candidate comment was generated in association with the candidate comment, and present the candidate comment and the reason to the viewer in association with each other.

In the first embodiment, it was described that the summary display object is first displayed at the start of livestream viewing, and then the summary is displayed when the object is tapped, but this is not limitative. The summary may be displayed directly on the livestreaming room screen at the start of livestream viewing.

In the first embodiment, it was described that the generated summary text is displayed on the livestreaming room screen, but this is not limitative. For example, every time the summary generating model 326 generates a character, word, or sentence, it may be displayed on the livestreaming room screen, thereby implementing text screaming in which text is generated and displayed at the same time. In this case, the summary may be progressively updated based on events that occur in the livestream after a new viewer joins.

In the first embodiment, it was described that the personality for adjusting the summary generating model 326 and the detail generating model 328 is received from the user terminal of the livestreamer at the time of starting the livestream, but this is not limitative. Instead of or in addition to the personality, other adjustment information, such as data obtaining periods and lists of banned words, may be received to adjust the models.

In the first embodiment, it was described that when a thumbnail is selected on the livestream selection screen 600, a viewer joins in the livestream, and at the same time, a summary is displayed on the livestreaming room screen 608, but this is not limitative. For example, a summary of the livestream may be displayed on a preview screen of the livestream.

In this modification example, upon selection of a livestream by a viewer, the viewer is first allowed to view the livestream in a preview mode, instead of being allowed to enter the livestream immediately. In the preview mode, the viewer is allowed to view the livestream without notification to the livestreamer or other viewers that he/she is entering the livestream, and the summary of the livestream is provided to the viewer. Reading the summary in the preview mode, the viewer can grasp the content of the conversation that has taken place in the livestream, and then enters the livestream if the viewer finds it interesting. If the viewer finds it uninteresting, then he/she can leave without notification to the livestreamer or other viewers.

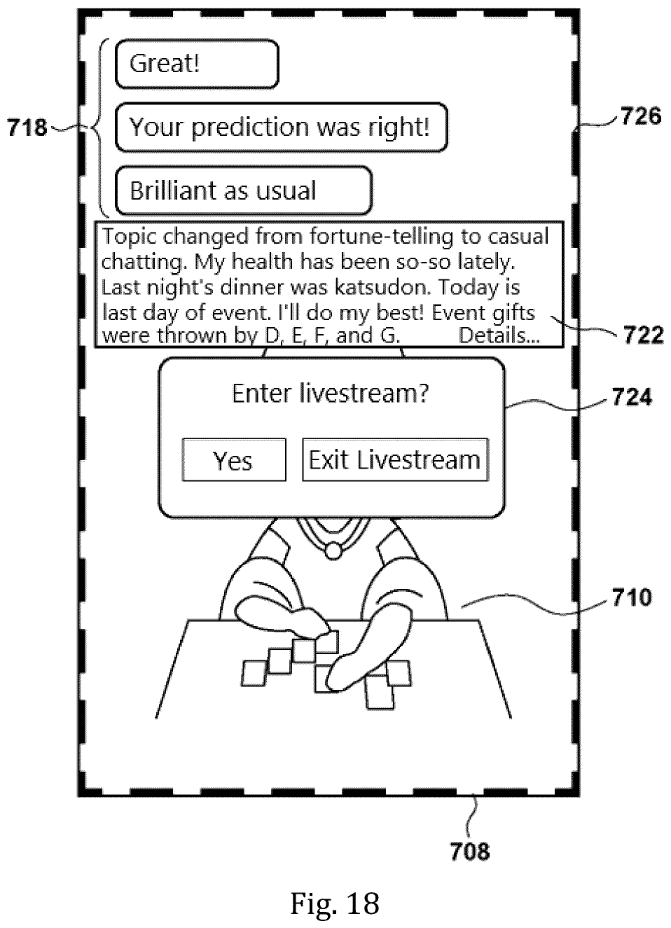

In this modification example, the user terminal waits for detection of a tap on a thumbnail shown on the livestream selection screen. When the tap is detected, the user terminal displays a live streaming room screen in the preview mode on the display. FIG. 18 is a representative screen image of a livestreaming room screen 708 in the preview mode on the display of the user terminal. The livestreaming room screen 708 in the preview mode displays a video image generated by the user terminal 20 of the livestreamer in real time. The livestreaming room screen 708 includes a video image 710 of the livestreamer obtained by reproducing the video data received from the server 10, a comment display region 718, a summary display region 722 that displays a summary of the livestream received from the server 10, an entry inquiry pop-up 724 for inquiring whether the viewer will enter the livestream, and a preview frame 726. The preview frame 726 indicates that the viewer is watching the livestream in the preview mode. The preview frame 726 is an object added to distinguish between a livestreaming room screen in a normal mode as shown in FIG. 10 and a livestreaming room screen in the preview mode. With the presence of the preview frame 726, it can be said that the livestreaming room screen in the normal mode and the livestreaming room screen in the preview mode are displayed in different ways.

In the preview mode immediately after the viewer selects the thumbnail, the server does not notify the information on the viewer to the livestreamer or other viewers. For example, the presence or absence of viewers in the preview mode does not affect the accompanying information (comments, viewer list, etc.) of the relevant livestream. Alternatively, the viewers in preview mode may be managed differently on the server than other viewers. For example, the viewers in preview mode may be managed using a list different from the viewer list in which other viewers are registered, and/or the preview mode viewers may be given a flag in the viewer list to indicate that they are in preview mode. In this case, when the livestreamer requests a viewer list, the server may exclude the viewers with the flag from the list to be provided to the livestreamer.

In the preview mode, the viewer is not allowed to input information. Specifically, the livestreaming room screen 708 in the preview mode includes neither a gift object nor a comment input region.

The viewer taps to select one from the options of “Yes” (that is, enter the livestream) and “Exit Livestream” displayed in the entry inquiry pop-up 724. When the viewer selects “Exit Livestream”, that is, to leave the livestream, the user terminal performs a leaving process. When the viewer selects “Yes”, i.e., to enter the livestream, the user terminal transitions the display from the livestreaming room screen in the preview mode to the livestreaming room screen in the normal mode (corresponding to the livestreaming room screen in FIG. 10 without the summary display object 622 and the hide object 624).

According to this modification example, by reading the summary in addition to watching the preview, the user can understand the contents of the livestream more quickly and accurately, and can decide whether to enter or not.

Instead of or in addition to the text summary displayed in the summary display region 722, marks and parameters as shown in FIG. 17 may be presented as summary information.

In the first embodiment, the server may change the output format of the summary automatically according to the type of the livestream or as designated by the livestreamer. Designation of personality by the livestreamer is one example. Otherwise, the server may identify the type of the livestream (music livestream, fortune-telling livestream, casual chatting livestream, game livestream, etc.) from the information on the livestreamer registered in the user DB 318, and determine the output format of the summary according to the identified type. For example, if the type is music livestream, the summary is set to include a set list and information about the name of the song currently being played and the number of songs that have been played so far.

The conversion rate from the price points of a gift to a reward to be awarded in the first embodiment is merely an example, and the conversion rate may be appropriately set by the administrator of the livestreaming system, for example.

The technical idea according to the first embodiment may be applied to live commerce or virtual livestreaming using an avatar that moves in synchronization with the movement of the livestreamer instead of the image of the livestreamer. In the first embodiment, the video data related to the livestream that is generated at the user terminal of the livestreamer is relayed by the server and transmitted to the user terminal of the viewer, but this is not limitative. For example, the technical ideas of the first embodiment can also be applied to a virtual livestreamer in place of an actual livestreamer. A virtual livestreamer is, for example, an AI virtual livestreamer having an appearance represented by an avatar, emitting audio produced by a text-to-speech (TTS) engine, and saying what is generated by a machine learning model receiving comments posted by viewers. In this case, the livestreamer's user terminal does not exist, and the processing on the livestreamer's side is performed by the server.

### Second Embodiment

Japanese Patent No. 7497002 (“the '002 Patent”) discloses a technique that uses machine learning to realize a virtual livestreamer.

The application of machine learning to livestreaming allows for the implementation of a variety of functions that were previously unfeasible or impractical. The technique disclosed in the '002 Patent is just one example.

The second embodiment of the disclosure was made in light of these issues, and one object thereof is to create new functions or improve existing functions by applying machine learning to livestreaming. According to the second embodiment, new functions can be created or existing functions can be improved by applying machine learning to livestreaming.

The livestreaming system according to the second embodiment provides a livestream the participants of which include a plurality of different virtual viewers (hereinafter referred to as “AI viewers”), realized by a plurality of different machine learning models (hereinafter referred to as “ML models”), and a real-life livestreamer. The livestreamer can simulate a livestream by delivering a livestream supposing that the AI viewers are real-life viewers.

For example, it is anticipated that the livestreaming system according to this embodiment is used in the following manner. Streamer A began livestreaming with a dream of becoming a popular livestreamer. However, streamer A was struggling with how to interact with his/her viewers and make his/her content more exciting. At such a time, streamer A learned about the “AI Livestreamer Training System” provided by the livestreaming system according to this embodiment. This system is set up with AI viewers having a variety of personalities and interests. For example, diverse AI viewers are available, including dedicated fans, critical viewers, and first-time viewers of the livestream. Streamer A uses this system to simulate a livestream. As streamer A speaks, AI viewers send comments and gifts in real time. In addition, AI viewers also initiate conversations with each other, creating an atmosphere of the livestream. The system will analyze streamer A's performance and evaluate the following aspects.
Speed and appropriateness of response to comments
Selection of topics that attract the viewers
Timing of excitement in the livestream
Facilitation of community building among the viewers

In addition, the system simulates different situations. Examples include situations where the livestream is about to be under fire, where the number of viewers declines, or conversely, where it suddenly surges. Streamer A can practice dealing with these situations. After training, the system provides detailed feedback. For example, the system provides specific advice such as, “you tend to be slow to respond to comments,” or “certain topics will increase viewer interest”. Streamer A uses this system regularly to improve his/her skills. Streamer A is now confident in his/her ability to handle the actual livestream, and is gradually gaining fans. What makes this system unique is that it is not just a one-on-one conversation exercise, but can simulate the complex environment unique to livestreaming. Through interaction among multiple AI viewers, the system reproduces a more realistic livestreaming environment and helps livestreamers improve their overall skills.

The livestreaming system 1001 relating to the second embodiment has the same configuration as the livestreaming system 1 shown in FIG. 1. A user terminal 1020 of a livestreamer and a user terminal 1030 of a viewer in the livestreaming system 1001 have the same configuration as the user terminal 20 shown in FIG. 2.

In this embodiment, ML models are provided on the server 1010, and the ML models are trained to learn the activities of real-life viewers AU in livestreams. Through training, the ML models learn to output the reactions that real-life viewers having the specified properties would likely make when the livestreamer's behaviors are input. The AI viewers are realized by such trained ML models. The ML models may be realized using known supervised machine learning technologies such as GPT (Generative Pre-trained Transformer)-3, GPT-3.5, GPT-4 provided by OpenAI, as well as LLAMA (Large Language Model Meta AI) provided by Meta, and BLOOM (BigScience Language Open-science Open-access Multilingual). The ML models can be configured with personalities by entering constraints and behavioral guidelines in the prompts provided by the ML models (see, for example, “How do I give ChatGPT the persona of King Gilgamesh?” Takayuki FUKATSU,

URL: https://note.com/fladdict/n/neff2e9d52224).

A livestreamer may perform an AI training livestream. The AI training livestream will involve a plurality of different AI viewers in addition to the livestreamer. In the AI training livestream, the livestreamer's motions, facial expressions, remarks, and other behaviors are input into the ML models, and in response to the input, the ML models output comments, pseudo-gifts, and other responses as if they are from the AI viewers. The AI training livestream may be configured so that only AI viewers can participate as viewers, or it may be configured so that real-life viewers AU can participate in addition to AI viewers.

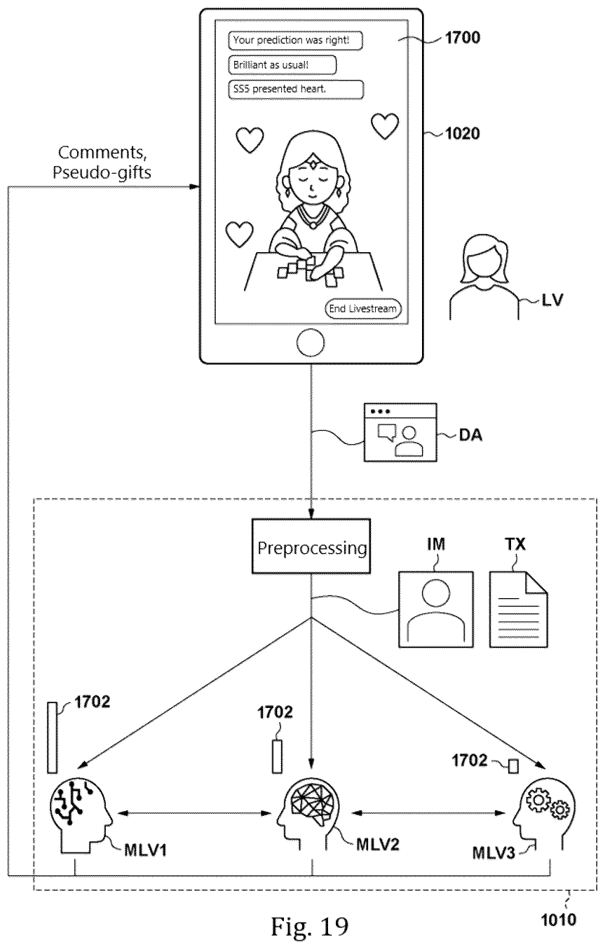

FIG. 19 is a schematic view for explaining an AI training livestream. The livestreamer LV is using the user terminal 1020 to deliver the AI training livestream. The display of the user terminal 1020 shows the livestreaming room screen 1700 for the livestreamer. The livestreaming room screen 1700 contains the video image of the livestreamer LV, comments, and pseudo-gift effects.

The user terminal 1020 of the livestreamer LV generates video data DA by recording the behaviors of the livestreamer, and transmits the generated video data to the server 1010 over the network NW. The server 1010 preprocesses the received video data DA to obtain image data IM and text data TX. The image data IM represents the images included in the video data DA, and the text data TX includes text obtained by converting the audio included in the video data DA to text by STT (Speech to text) and comments.

The image data IM and the text data TX are input into ML models that realizes multiple (three in the example in FIG. 19) AI viewers MLV1001, MLV1002, and MLV1003. Each ML model has different properties specified thereto. Each ML model outputs the reactions that a viewer having the specified properties would likely make, in response to the input of the image data IM and the text data TX. The output reactions include likability rating 1702 for the livestreamer LV (represented by a column graph in the example in FIG. 19), input of comments in the AI training livestream, and use of pseudo-gifts. The pseudo-gifts are items that are used by AI viewers and are valid only in individual AI training livestreams. The pseudo-gift, which indicates the degree of excitement in the AI training livestream, creates an effect in the AI training livestream but does not affect the livestreamer's reward. In this embodiment, the use of the pseudo-gifts by AI viewers will be described, but in other embodiments, AI viewers may use gifts that affect the livestreamer's reward. Such gifts may be the same gifts as used by the real-life viewers AU.

The ML model may output the likability rating 1702, the use of pseudo-gifts, and the input of comments in parallel, or it may first output the likability rating 1702 and then determine the amount of pseudo-gift and the amount of comment according to the value of the likability rating 1702. If the likability rating 1702 is higher, the amount of pseudo-gift may be increased and the amount of positive comment may be increased.

Each ML model can output different reactions even when the same image data IM and text data TX are input. For example, if the first AI viewer MLV1001 and the second AI viewer MLV1002 make comments, and the livestreamer responds to the comment of the first AI viewer MLV1001, then the likability rating 1702 of the first AI viewer MLV1001 increases, while the likability rating 1702 of the second AI viewer MLV1002 decreases. If the interest of the second AI viewer MLV1002 is set to baseball and the interest of the third AI viewer MLV1003 is set to beauty, then when the livestreamer talks about baseball, the second AI viewer MLV1002 will output many comments, while the third AI viewer MLV1003 will be silent.

The reactions output by each ML model are input to the other ML models. This allows for interaction between ML models (between AI viewers) in the AI training livestream. For example, when the first AI viewer MLV1001 uses a large pseudo-gift, the likability ratings of the other AI viewers MLV1002 and MLV1003 increase. If the category of the first AI viewer MLV1001 is set to VIP, then when the comments output by the first AI viewer MLV1001 increase, the comments output by the other AI viewers MLV1002 and MLV1003 will decrease. This represents consideration for the VIP.

In this way, the AI training livestream enables the livestreamer to check the AI viewers' reactions to his or her behavior in real time, so that the livestreamer can learn what to say and do to make the livestream more exciting and enjoyable with the participation of AI viewers having desired properties.

In this embodiment, it is described that the ML models output or update the AI viewers' likability ratings for the livestreamer, but in other embodiments, the ML models may output or update the AI viewers' likability ratings for the livestream, and/or the AI viewers' degrees of interest, emotion, or engagement score for the livestreamer or the livestream, instead of or in addition to the likability ratings for the livestreamer.

FIG. 20 is a block diagram showing functions and configuration of the server 1010 of FIG. 1. The server 1010 includes a livestream information providing unit 1302, a relay unit 1304, a gift processing unit 1308, a payment processing unit 1310, a training unit 1330, a stream DB 1314, a user DB 1318, a gift DB 1320, and an ML model DB 1340. The gift DB 1320 has the same configuration as the gift DB 320 in FIG. 6.

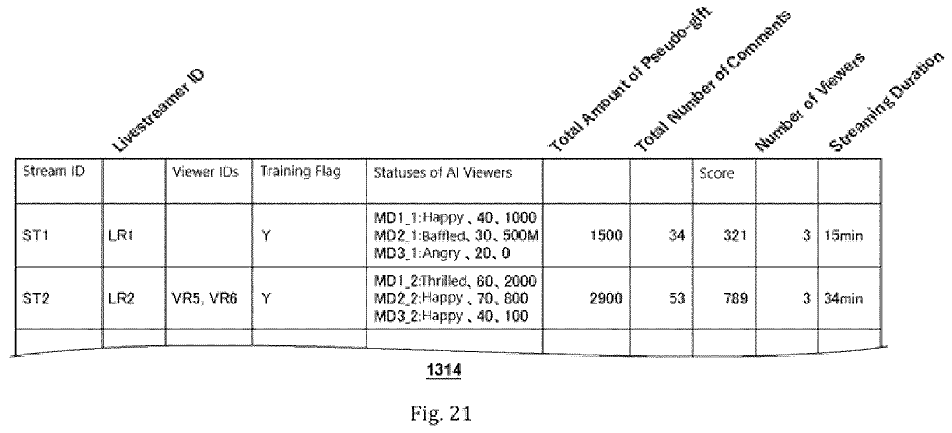

FIG. 21 is a data structure diagram showing an example of the stream DB 1314 in FIG. 20. The stream DB 1314 holds information regarding livestreams currently taking place, including AI training livestreams. The stream DB 1314 stores a stream ID that identifies a livestream (including an AI training livestream) on the livestreaming platform provided by the livestreaming system 1001, a livestreamer ID which is a user ID that identifies a livestreamer of the livestream, viewer IDs which are user IDs that identify real-life viewers (not AI viewers) of the livestream, a flag that indicates whether or not the livestream is an AI training livestream, the statuses of AI viewers participating in the livestream, the total amount of pseudo-gift used in the livestream, and the total number of comments posted in the livestream, a score of the livestream, the number of viewers (including AI viewers) of the livestream, and the streaming duration of the livestream, in association with each other.

In the livestreaming platform provided by the livestreaming system 1001 of the embodiment, when a user delivers a livestream, the user is referred to as a livestreamer, and when the same user views a livestream delivered by another user, the user is referred to as a viewer. Therefore, the distinction between a livestreamer and a viewer is not fixed, and a user ID entered as a livestreamer ID at one time may be entered as a viewer ID at another time.

When the flag is “Y”, the livestream is an AI training livestream, and when the flag is “N”, the livestream is not an AI training livestream.

The statuses of AI viewers include AI viewer IDs that identify the AI viewers participating in the AI training livestream, the AI viewers' emotion, the AI viewers' likability ratings for the livestreamer, and the total amounts of pseudo-gift that the AI viewers have used so far. The number of AI viewers in an AI training livestream is calculated by counting the AI viewer IDs included in the corresponding statuses.

In this embodiment, the ML models that realize the AI viewers participating in an AI training livestream are generated exclusively for that AI training livestream by copying the model data of the original ML model. Thus, AI viewers with the same properties can participate in each of two different AI training livestreams that are going on at the same time. In the example in FIG. 21, three AI viewers are participating in the AI training livestream “ST1”. The AI viewer identified by the AI viewer ID “MD1_1”, which is realized by the ML model with the model ID “MD1” described below, outputs the emotion “fun”, outputs a likability rating of “40”, and has so far used pseudo-gifts in an amount of “1000”. Three AI viewers are participating in the AI training livestream “ST2”. The AI viewer identified by the AI viewer ID “MD1_2”, which is realized by the ML model with the same model ID “MD1” as described above, outputs the emotion “delight”, outputs a likability rating of “60”, and has so far used pseudo-gifts in an amount of “2000”.

The score is an indicator of excitement in the livestream. A livestream with a high score value is recognized as “exciting” or “popular”. The score varies depending on, for example, the number of viewers, streaming duration, number of comments, content of comments, number of shares, total amount of gift, number of viewers who gave gifts, and number of cheers. The score is reset when the livestream ends. The cheer is a digital item given to the livestreamer by viewers and, unlike gifts, requires no payment for it. Once a cheer is sent, the viewer must wait a specified period of time before being able to give another cheer. The score is an example of an indicator of a livestreamer's performance in the livestream. The score in an AI training livestream will be discussed below.

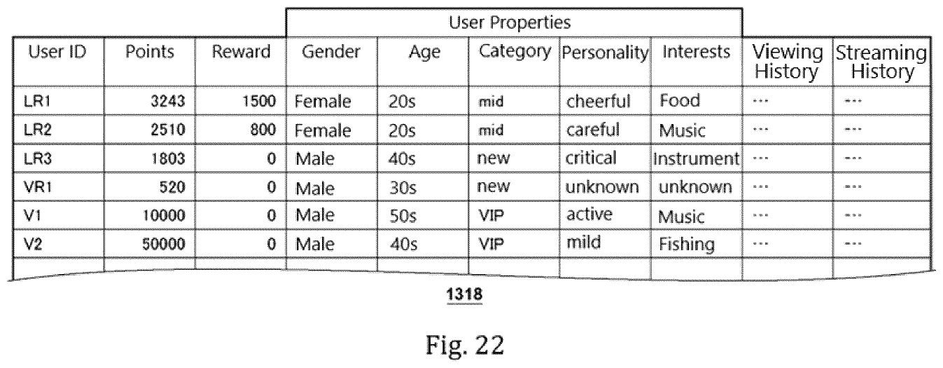

FIG. 22 is a data structure diagram showing an example of the user DB 1318 of FIG. 20. The user DB 1318 holds information regarding users. The user DB 1318 holds a user ID identifying a user, points the user has, a reward given to the user, properties of the user, viewing history of the user, and streaming history of the user, in association with each other. The properties of the user include the gender of the user, the age of the user, the category of the user, the personality of the user, and the interests of the user. With the exception of the category, the properties of the user may be entered by the users themselves through the livestreaming application, or they may be predicted by the system using machine learning or other methods based on the user's viewing history and streaming history.

The category is an indicator of the user's past performance as a viewer on the livestreaming platform. In other embodiments, the category may be an indicator of the user's past performance as a livestreamer on the livestreaming platform or it may be an indicator of the user's past performance both as a livestreamer and as a viewer. The category may be determined based on the viewing history. The category may increase or decrease depending on the total viewing time as a viewer of livestreams, the number and/or amount of gifts the user has given, the number of comments, etc. Alternatively, the category may be evaluated and determined by the administrator. Alternatively, the category may be automatically determined based on predetermined rules or by a machine learning model. In the example in FIG. 22, the category is selected from three: “new”, “mid”, and “VIP”.

The points are an electronic representation of value circulated in the livestreaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

The viewing history is collected data on the history of activities related to viewing of livestreams on the livestreaming platform, such as which livestream was viewed at what time and for what duration, what comments were made, and how many gifts were given by the user. The streaming history is collected data on the history of activities related to delivery of livestreams on the livestreaming platform, such as when a livestream was delivered for what duration, what remarks were made, and how many scores and gifts were received by the user.

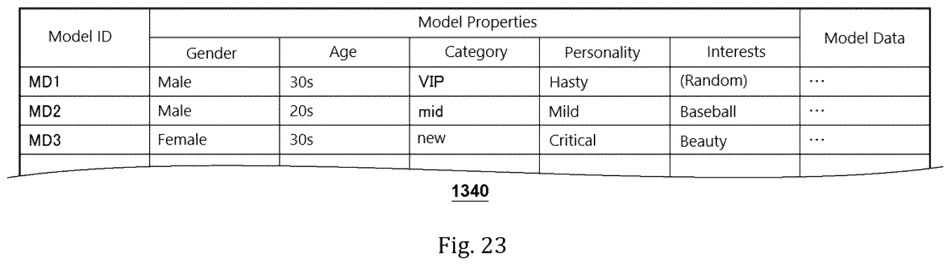

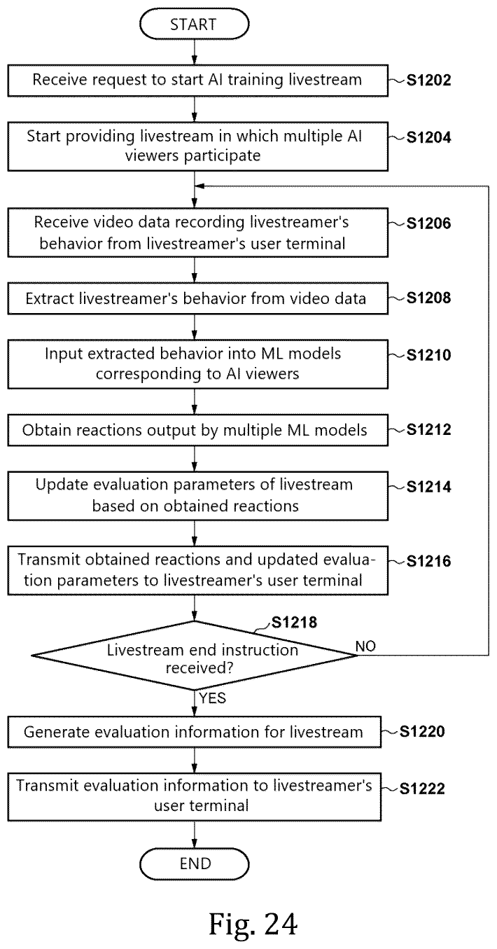

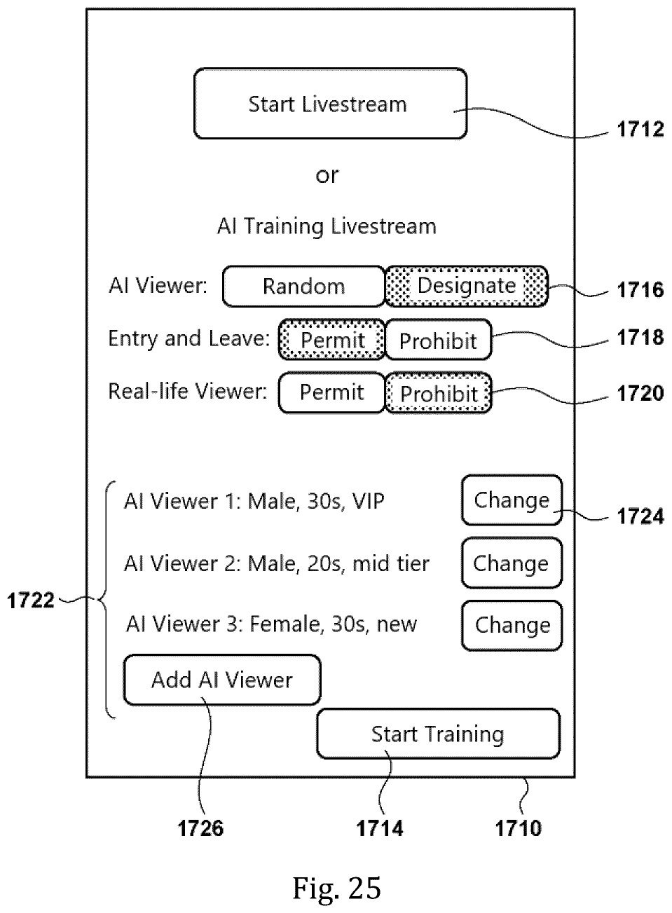

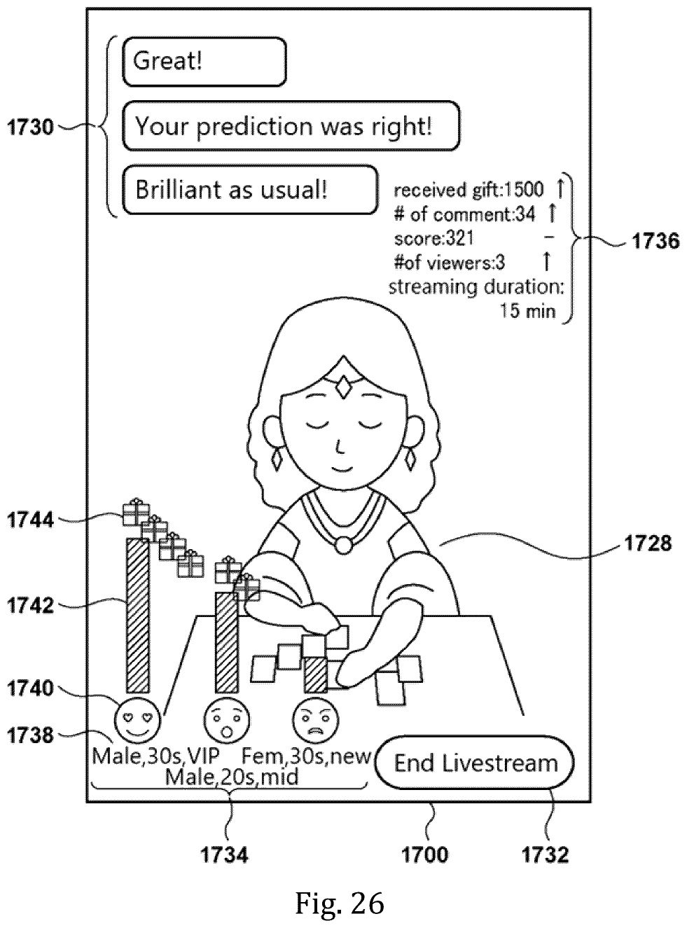

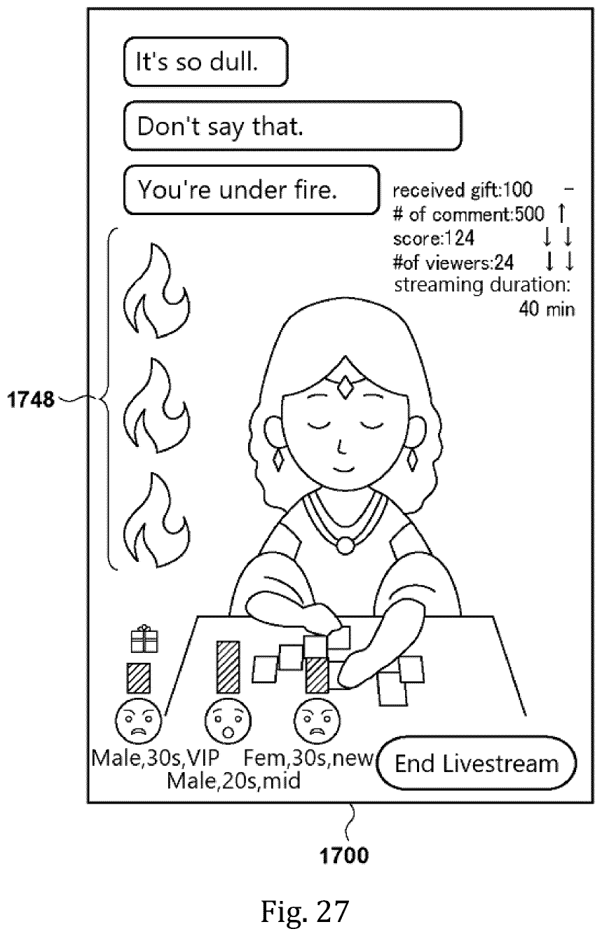

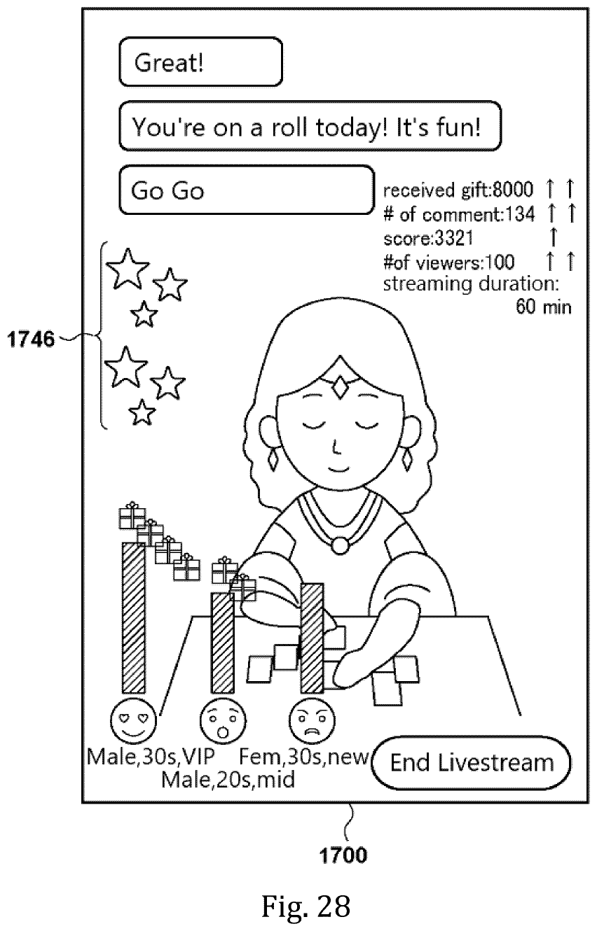

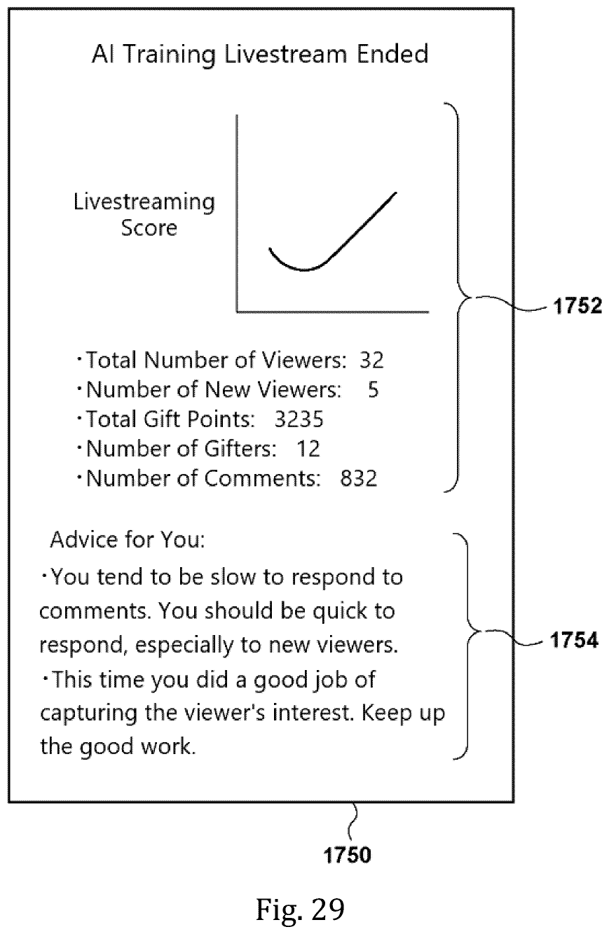

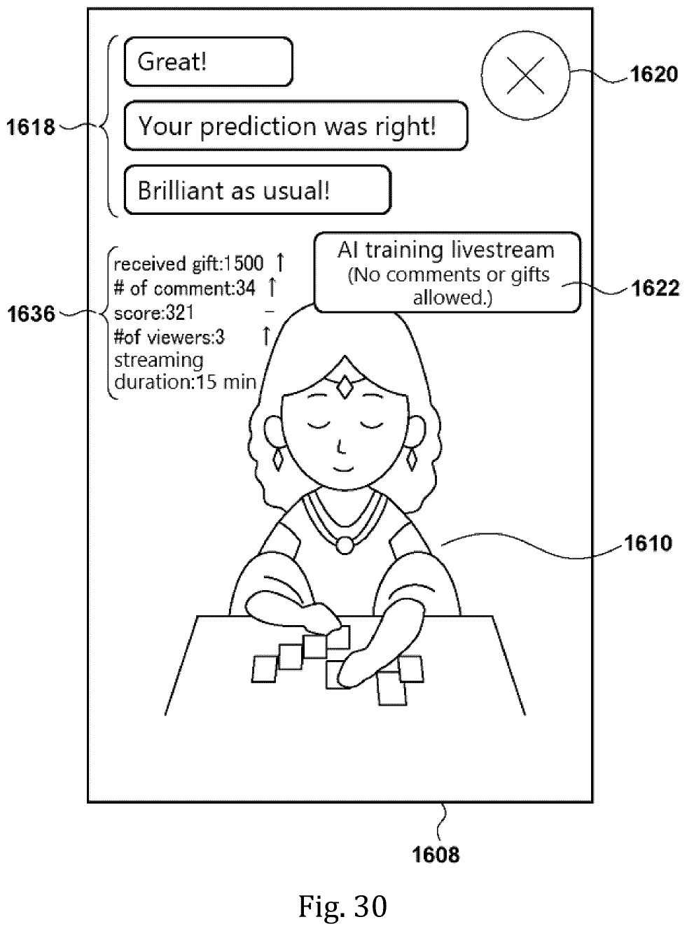

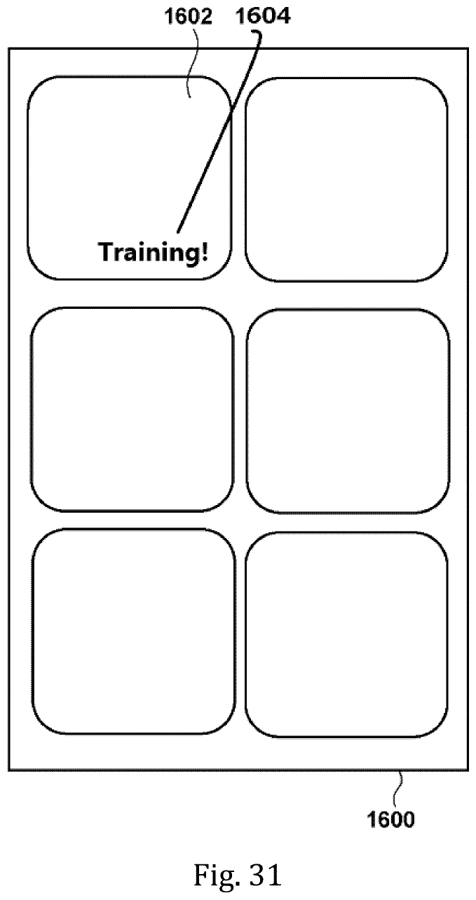

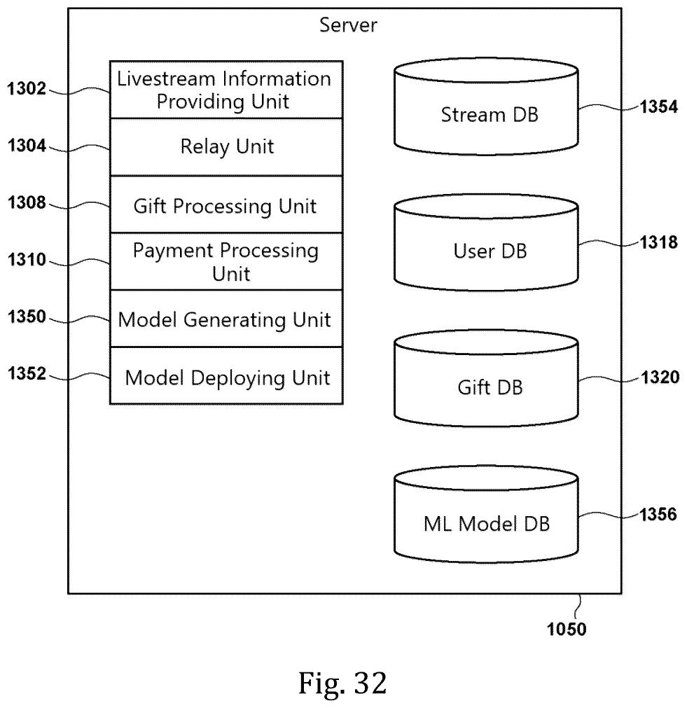

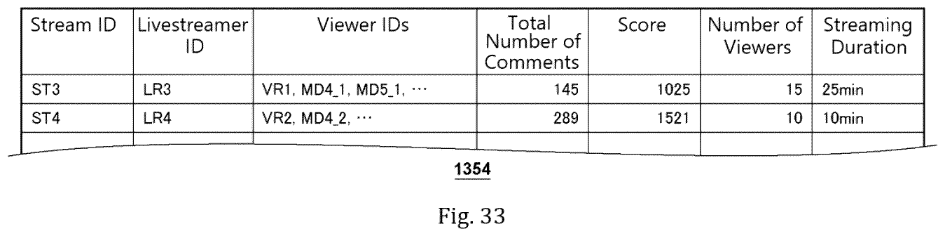

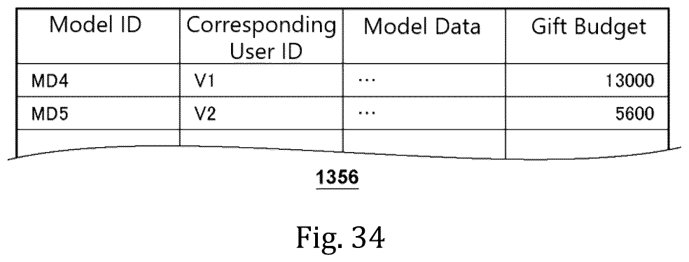

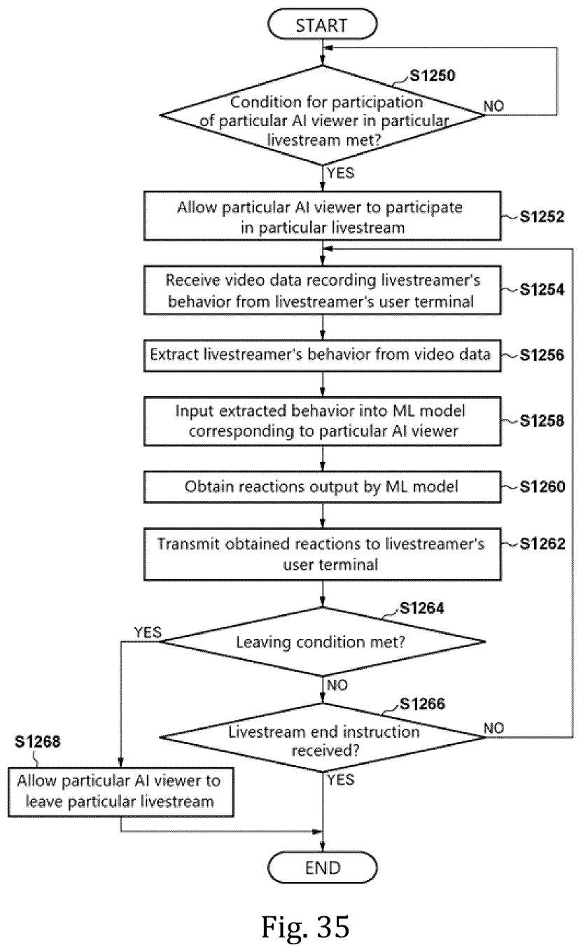

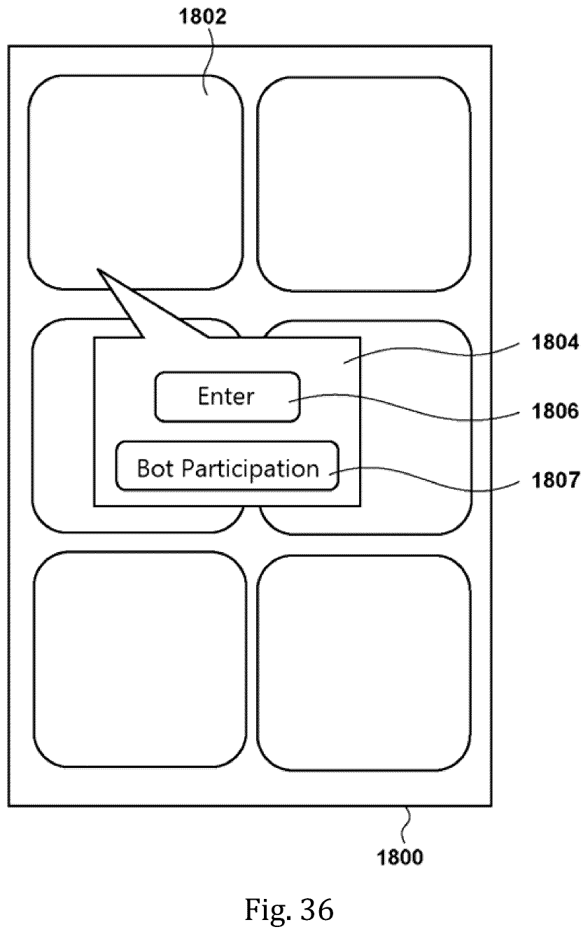

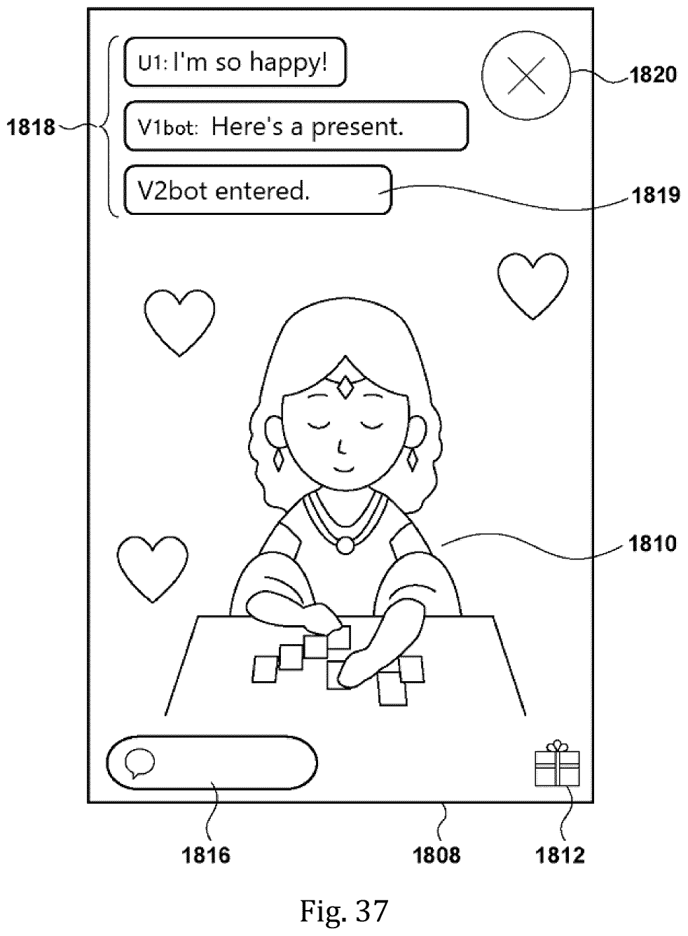

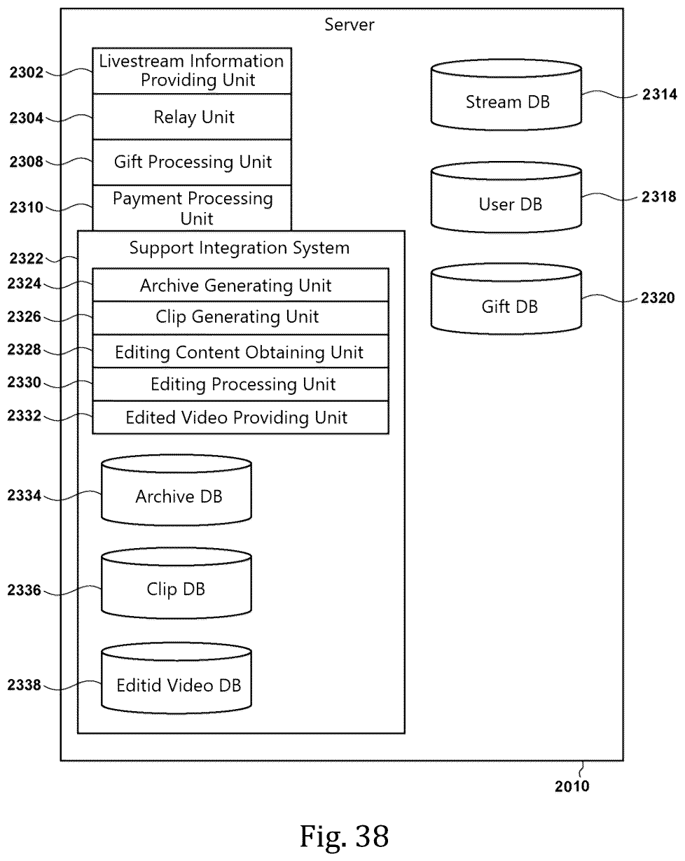

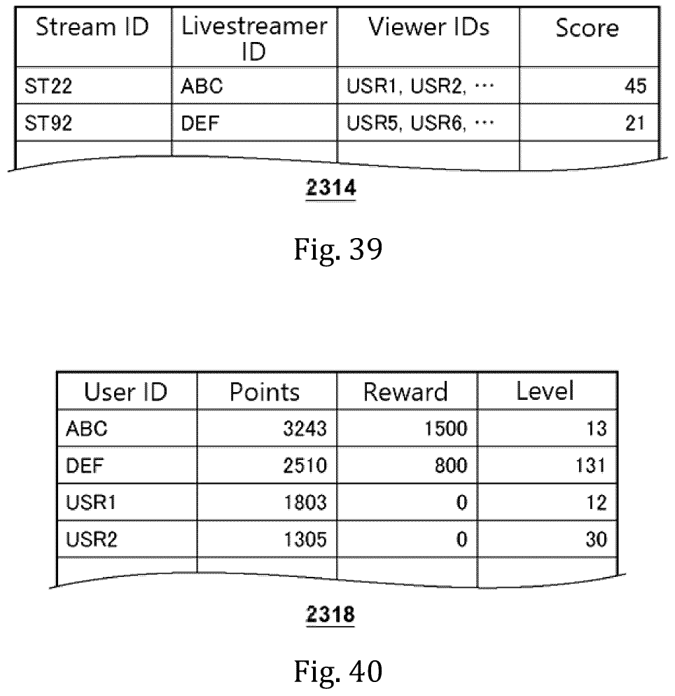

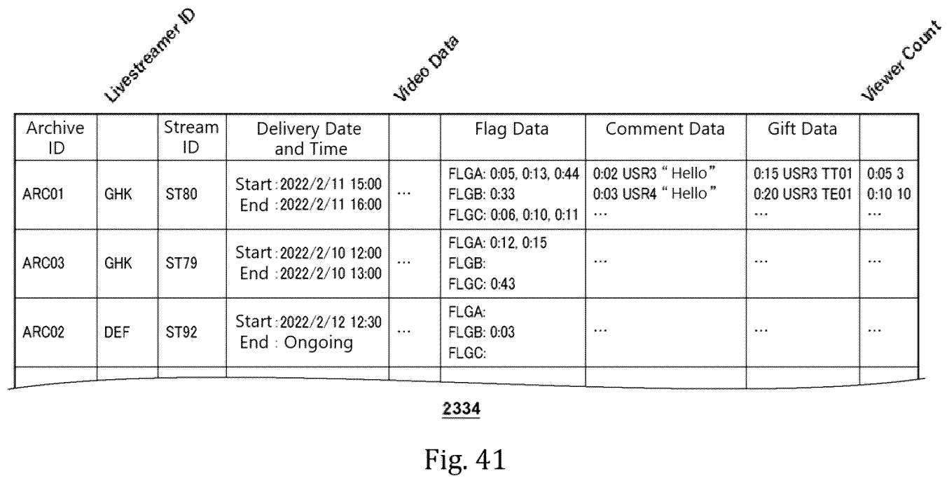

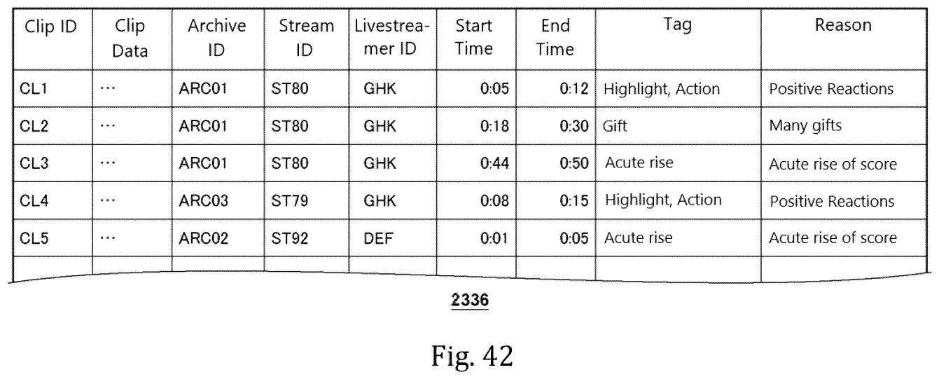

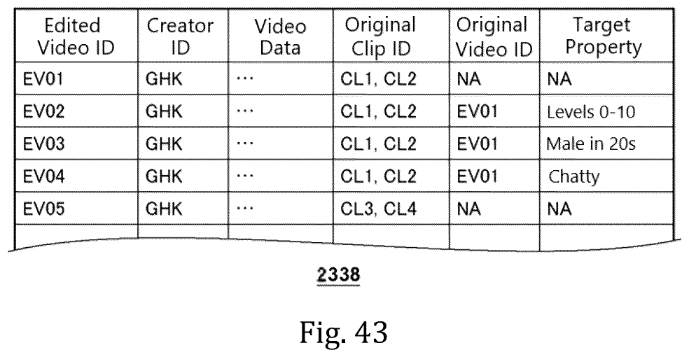

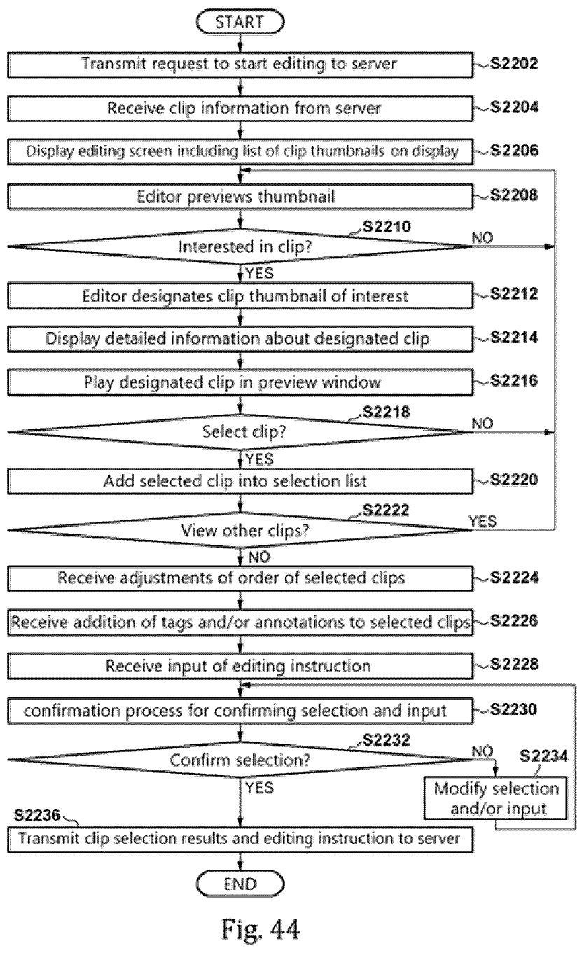

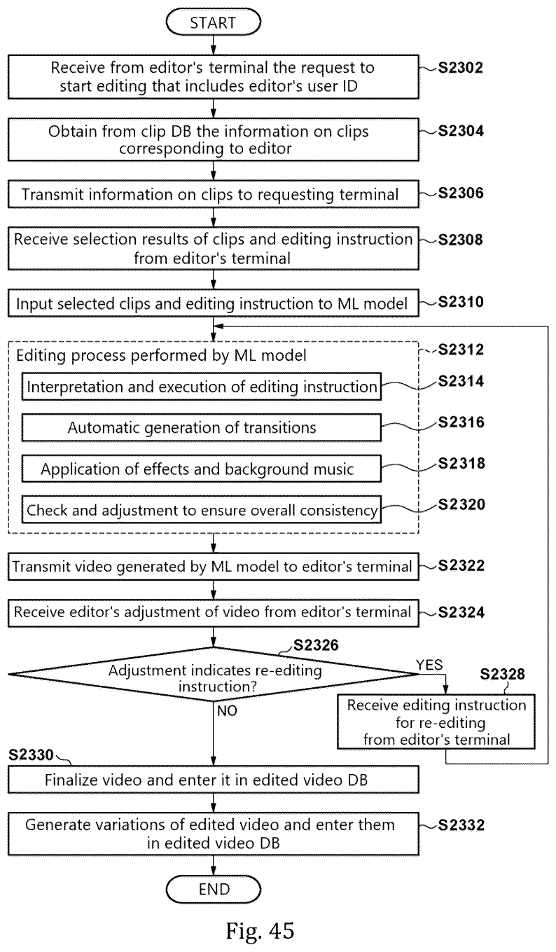

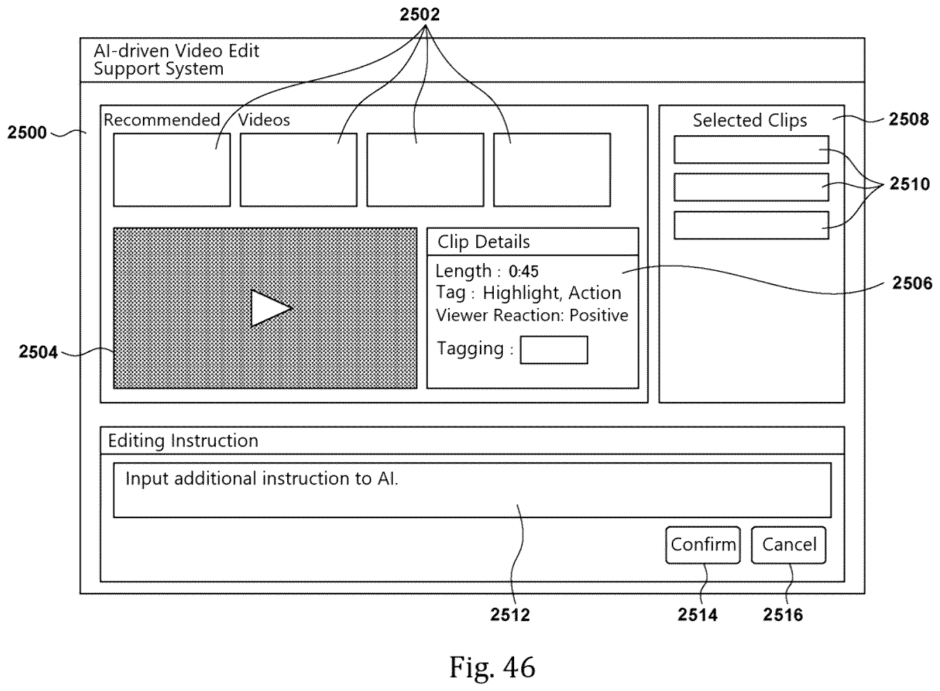

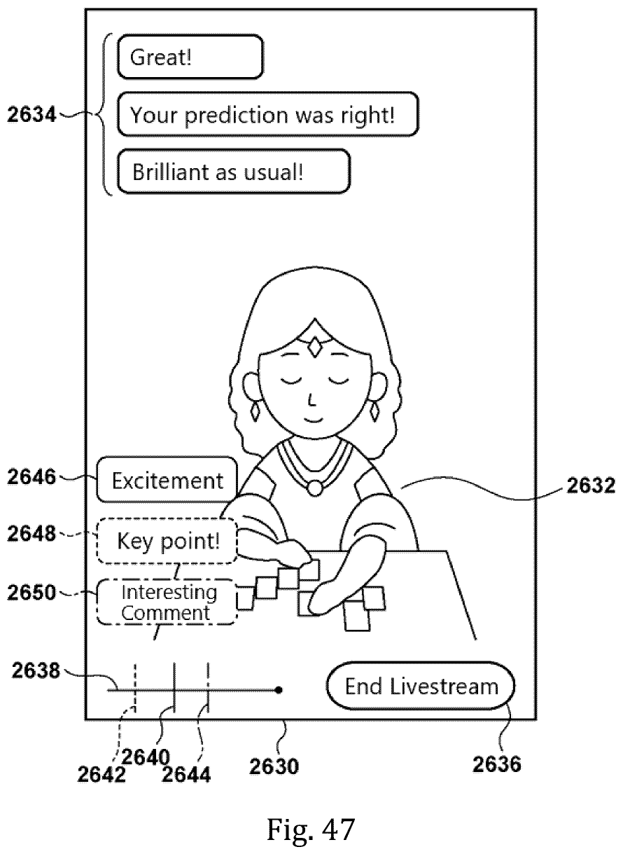

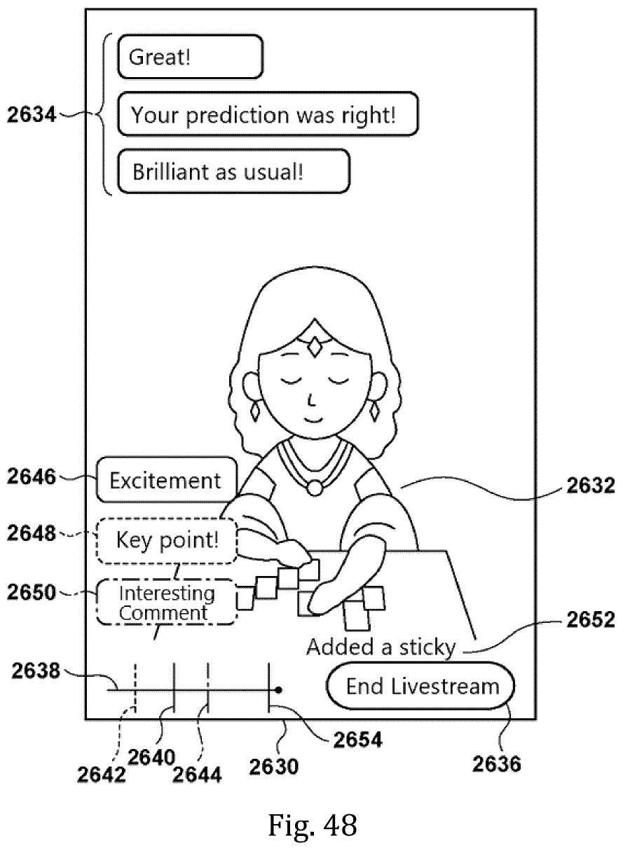

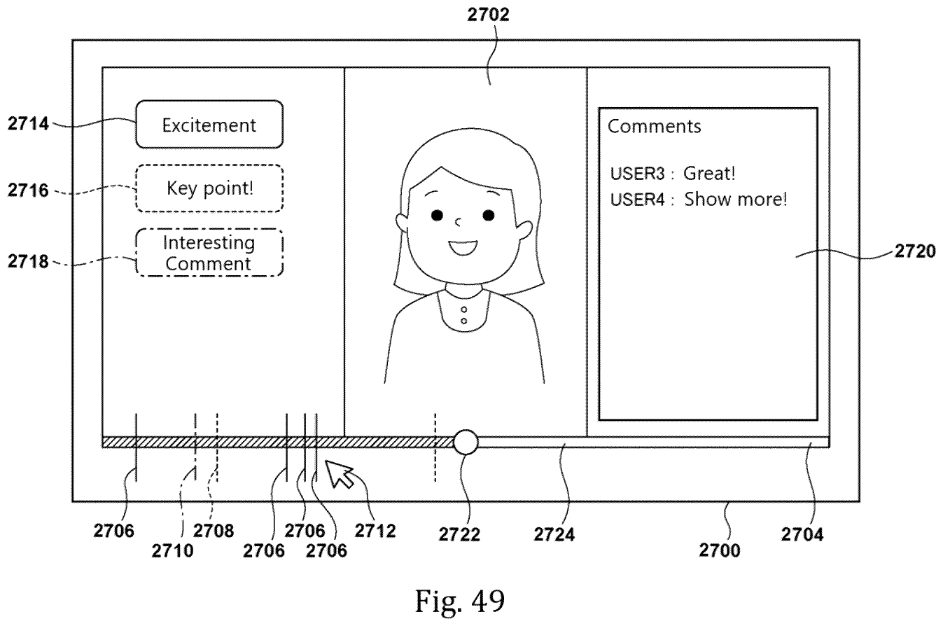

FIG. 23 is a data structure diagram showing an example of an ML model DB 1340 in FIG. 20. The ML Model DB 1340 holds information on ML models for realizing the AI viewers that participate in the AI training livestream. The ML model DB 1340 holds a model ID that identifies an ML model, the properties set for the ML model, and the model data on the ML model, in association with each other. The properties include gender, age, category, personality, and interests, similar to those in FIG. 22. If the ML model is realized by an API (Application Programming Interface), the model data includes a URL (Uniform Resource Locator) to be included in the API call for the ML model.

In this embodiment, the administrator determines the properties of the ML model and makes the ML model learn the viewing history of real-life viewers having the determined properties. In the example in FIG. 23, the administrator obtains the viewing history of a real-life user(s) having user properties of male, 30s, VIP, and impatient from the user DB 1318, and makes the ML model “MD1” learn the obtained viewing history. As a result, the ML model “MD1” outputs reactions to the behavior of the livestreamer that would be made by a real-life viewer who is male, in his/her 30s, a VIP, and impatient. Such ML model learning may be accomplished by known machine learning techniques.

Referring again to FIG. 20, upon reception of a request to start a livestream over the network NW from the user terminal 1020 of the livestreamer, the livestream information providing unit 1302 enters in the stream DB 1314 a stream ID identifying this livestream and the livestreamer ID of the livestreamer who delivers the livestream. When the livestream information providing unit 1302 receives a request for information about livestreams from the out-of-livestream communication unit 404 of a user terminal of an active user over the network NW, the livestream information providing unit 1302 refers to the stream DB 1314 and generates a list of currently available livestreams. The livestream information providing unit 1302 transmits the generated list to the requesting user terminal over the network NW. The out-of-stream UI control unit 402 of the requesting user terminal generates a livestream selection screen based on the received list and shows the livestream selection screen on the display of the user terminal.

Once the out-of-livestream UI control unit 402 of the user terminal receives the active user's selection of a livestream on the livestream selection screen, the out-of-livestream UI control unit 402 generates a livestream request including the stream ID of the selected livestream, and transmits the livestream request to the server 1010 over the network NW. The livestream information providing unit 1302 starts to provide, to the requesting user terminal, the livestream identified by the stream ID included in the received livestream request. The livestream information providing unit 1302 updates the stream DB 1314 such that the user ID of the active user of the requesting user terminal is included in the viewer IDs associated with the stream ID. In this way, the active user can be a viewer of the selected livestream.

The relay unit 1304 relays the video data from the user terminal 1020 of the livestreamer to the user terminals 1030 of the viewers in the livestream started by the livestream information providing unit 1302. The relay unit 1304 receives from the viewer-side communication unit 204 a signal that represents user input made by a viewer during the livestream, or during reproduction of the video data. The signal that represents user input may be an object designation signal that indicates designation of an object displayed on the display of the user terminal 1030, and the object designation signal includes the viewer ID of the viewer, the livestreamer ID of the livestreamer delivering the livestream that the viewer watches, and an object ID that identifies the object. When the object is a gift icon, the object ID is a gift ID. The object designation signal in that case is a gift use signal indicating that the viewer uses a gift for the livestreamer. Similarly, the relay unit 1304 receives from the livestreamer-side communication unit 110 of the livestreaming unit 100 in the user terminal 1020 a signal that represents user input by the livestreamer during reproduction of the video data, such as an object designation signal.

The gift processing unit 1308 updates the user DB 1318 so as to increase the reward for the livestreamer according to the reward to be awarded of the gift identified by the gift ID included in the gift use signal. Specifically, the gift processing unit 1308 refers to the gift DB 1320 to specify a reward to be awarded for the gift ID included in the received gift use signal. The gift processing unit 1308 then updates the user DB 1318 to add the specified reward to be awarded to the reward for the livestreamer ID included in the gift use signal.

The payment processing unit 1310 processes payment of a price of the gift by the viewer in response to reception of the gift use signal. Specifically, the payment processing unit 1310 refers to the gift DB 1320 to specify the price points of the gift identified by the gift ID included in the gift use signal. The payment processing unit 1310 then updates the user DB 1318 to subtract the specified price points from the points of the viewer identified by the viewer ID included in the gift use signal.

The training unit 1330 manages and controls AI training livestreams. The training unit 1330 includes a setting unit 1332, a progress processing unit 1334, an evaluation unit 1336, and a feedback unit 1338.

Upon reception of a request to start an AI training livestream over the network NW from the user terminal 1020 of the livestreamer, the setting unit 1332 enters in the stream DB 1314 a stream ID identifying this AI training livestream, the livestreamer ID of the livestreamer who performs the AI training livestream, a training flag with the value “Y”, and the statuses of the AI viewers. The setting unit 1332 enters the AI viewers designated in the start request (the AI viewers designated by the livestreamer) in the statuses. For example, if the livestreamer designates an AI viewer identified by the ML model “MD1”, the setting unit 1332 copies the model data of the ML model “MD1”, assigns the AI viewer ID “MD1_1” to the AI viewer realized by the copy, and enters the AI viewer ID “MD1_1” in the statuses. When the setting of the AI viewer is completed, the livestream information providing unit 1302 starts providing an AI training livestream to the user terminal of the livestreamer who made the start request.

In the AI training livestream started by the setting unit 1332, the progress processing unit 1334 receives video data from the livestreamer's user terminal 1020 over the network NW and transmits reaction data including reactions of the AI viewers to that user terminal 1020 over the network NW. The progress processing unit 1334 receives from the livestreamer-side communication unit 110 of the livestreaming unit 100 in the user terminal 1020 a signal that represents user input by the livestreamer during reproduction of the video data, such as an object designation signal. The video data includes the behavior of the livestreamer in the AI training livestream the participants of which include the livestreamer and multiple viewers including the AI viewers realized by the ML model, as described above.

The progress processing unit 1334 obtains reactions output by the ML model, the ML model taking as input the behavior of the livestreamer included in the received video data and outputting the reactions that would be made by a viewer with the properties set thereto. The progress processing unit 1334 extracts image data and text data from the video data and inputs them into the ML models for all AI viewers participating in the AI training livestream. The progress processing unit 1334 obtains the reactions output from each ML model in response to the input. The progress processing unit 1334 inserts the obtained reactions into reaction data. The reaction data may include the AI viewer statuses, the total amount of pseudo-gift, the total number of comments, the score, the number of viewers, and the streaming duration for the AI training livestream held in the stream DB 1314. Since the livestreamer's user terminal reflects the AI viewer's reactions (e.g., use of gifts, input of comments, etc.) on the livestreaming room screen based on the received reaction data, the reaction data serves to realize the AI viewer's reactions on the livestreamer's user terminal.

When a pseudo-gift is used by an AI viewer, the progress processing unit 1334 updates, in the stream DB 1314, the status, the total amount of pseudo-gift, and the score associated with the AI training livestream in which the pseudo-gift was used. In the example in FIG. 21, when the AI viewer “MD1_1” uses a pseudo-gift of 30 points in the AI training livestream “ST1”, 30 points are added to the pseudo-gift of “MD1_1” in the statuses associated with “ST1”, amounting to 70, and 30 points are added to the total amount of pseudo-gift associated with “ST1”, amounting to 1530. The score is also updated using a predetermined formula. However, since the pseudo-gift does not affect the reward for the livestreamer in this embodiment, the reward for the livestreamer “LR1” in FIG. 22 is not changed by the above use of the pseudo-gift.

The progress processing unit 1334 inputs the reactions output by the ML model of each AI viewer participating in the AI training livestream to the ML models of the other AI viewers.

The evaluation unit 1336 evaluates the AI training livestream and/or the livestreamer of the AI training livestream based on the reactions output by the ML models corresponding to the multiple AI viewers participating in the AI training livestream. The evaluation unit 1336 calculates the score of the AI training livestream in real-time and updates the stream DB 1314 with the calculated score. The score is an indicator of excitement in the AI training livestream. The score varies depending on, for example, the number of viewers, streaming duration, number of comments, content of comments, total amount of pseudo-gift, and the number of AI viewers who gave pseudo-gifts. The score, total amount of pseudo-gift, and total number of comments are examples of indicators of livestreamer performance in the AI training livestream. The evaluation unit 1336 may also conduct evaluation using information from non-AI training livestreams performed by the same livestreamer, in addition to the information obtained from the AI training livestream.

When the AI training livestream is ended, the evaluation unit 1336 analyzes the archived data of the AI training livestream to generate improvement suggestion comments for the livestreamer of the AI training livestream. The generation of the improvement suggestion comments may be accomplished by rule-based methods or by machine learning techniques. In the rule-based case, this can be accomplished by having the server store a combination of a range of values for parameters such as scores representing the performance of the AI training livestream and the number of viewers, and pre-input improvement suggestion comments, in association with each other. The evaluation made by the evaluation unit 1336 may include an evaluation of the reactions of individual AI viewers, an evaluation of the reactions of an AI viewer group (such as the reactions of a novice viewer group), and suggestions for livestream contents. The reactions of an AI viewer group is, for example, how favorably it is received by the novice group or how favorably it is received by the VIP group.

The feedback unit 1338 transmits the results of the evaluation by the evaluation unit 1336 to the user terminal of the livestreamer of the relevant AI training livestream over the network NW. If the AI training livestream is in progress, the results of the evaluation include the current values of the score, the statuses of the AI viewers, the total amount of pseudo-gift, the total number of comments, the number of viewers, and the streaming duration. When the AI training livestream is ended, the results of the evaluation include the final values of the score, the statuses of the AI viewers, the total amount of pseudo-gift, the total number of comments, the number of viewers, the streaming duration, and the improvement suggestion comments generated. With respect to learning of the ML model, the server 10 may be configured to learn actual viewer reactions as teacher data to increase the sophistication of the corresponding AI viewer reactions.

The operation of the livestreaming system 1 with the above configuration will be now described. FIG. 24 is a flowchart showing a series of steps performed in an AI training livestream. The server 1010 receives a request to start an AI training livestream from the livestreamer's user terminal 1020 over the network NW (S1202). The server 1010 starts providing a livestream (i.e., an AI training livestream) in which multiple AI viewers participate (S1204). The server 1010 receives video data recording the livestreamer's behavior from the livestreamer's user terminal 1020 over the network NW (S1206). The server 1010 extracts the livestreamer's behavior from the received video data (S1208). The server 1010 inputs the extracted behavior into the ML models corresponding to the AI viewers (S1210). The server 1010 obtains multiple reactions output by multiple ML models (S1212). The server 1010 updates the evaluation parameters of the AI training livestream based on the multiple reactions obtained (S1214). The evaluation parameters include the total amount of pseudo-gift, total number of comments, score, and number of viewers.

The server 1010 transmits the obtained multiple reactions and updated evaluation parameters to the livestreamer's user terminal 1020 over the network NW (S1216). The server 1010 determines whether or not it has received a livestream end instruction from the livestreamer's user terminal 1020 (S1218). When it has not yet received a livestream end instruction (NO in S1218), the process returns to step S1206. If it has received a livestream end instruction (YES in S1218), the server 1010 generates evaluation information for the ended AI training livestream (S1220). The server 1010 transmits the generated evaluation information to the livestreamer's user terminal 1020 over the network NW (S1222).

FIG. 25 is a representative screen image of a livestream preparation screen 1710 displayed on the display of the livestreamer's user terminal 1020. The livestream preparation screen 1710 includes a Start Livestream button 1712 for receiving an instruction to start a normal livestream (not AI training livestream) and a Start Training button 1714 for receiving an instruction to start an AI training livestream. The livestream preparation screen 1710 is configured to receive various settings for an AI training livestream. The livestream preparation screen 1710 includes a first selection region 1716 that allows the livestreamer to select whether the AI viewers to be included in the AI training livestream are randomly selected by the system or pre-designated by the livestreamer. The livestream preparation screen 1710 includes a second selection region 1718 that allows the livestreamer to select whether or not to permit the AI viewers to enter or leave the AI training livestream in the middle thereof. The livestream preparation screen 1710 includes a third selection region 1720 that allows the livestreamer to select whether or not to allow real-life viewers (non-AI viewers) to participate in the AI training livestream. The livestream preparation screen 1710 includes an AI viewer setting region 1722 that displays details of participating AI viewers and allows addition, modification, and deletion of participating AI viewers by the livestreamer, if the livestreamer chooses to pre-designate AI viewers in the first selection region 1716. The AI viewer setting region 1722 displays the properties and a Change button 1724 for each AI viewer intended to participate in the AI training livestream. When the Change button 1724 is designated (e.g., tapped), the user terminal 1020 superimposes a list of AI viewers who are candidates for the new participant on the livestream preparation screen 1710. This list may be generated by the user terminal 1020 referring to the ML model DB 1340 on the server 1010 over the network NW. The AI viewer setting region 1722 includes an Add AI Viewer button 1726. When the Add AI Viewer button 1726 is designated, a list similar to the one displayed when the Change button 1724 is designated is displayed, and the information of the AI viewer selected from the list is added to the AI viewer setting region 1722.

When the livestreamer makes desired settings in the first selection region 1716, second selection region 1718, third selection region 1720, and AI viewer setting region 1722 and designates the Start Training button 1714, the user terminal 1020 generates a request to start AI training livestream including the selection and input results in the first selection region 1716, second selection region 1718, third selection region 1720, and AI viewer setting region 1722, and transmits it to the server 1010 over the network NW.

When Designate is selected in the first selection region 1716, the process is performed as described above, and the AI viewers designated by the livestreamer in the AI viewer setting region 1722 will be the initial participant in the AI training livestream. When Random is selected in the first selection region 1716, the initial participants are randomly selected from the ML models registered in the ML model DB 1340.

If Permit is selected in the second selection region 1718, AI viewers will newly enter or leave the livestream depending on the score in the AI training livestream. For example, many AI viewers may enter the livestream when the score rises acutely, or a particular AI viewer may leave the livestream when the likability rating of that particular AI viewer falls below a threshold value.

FIG. 26 is a representative screen image of a livestreaming room screen 1700 in the AI training livestream on the display of the livestreamer's user terminal 1020. The livestreaming room screen 1700 includes multiple objects representing multiple reactions of multiple AI viewers, generated based on the reaction data received from the server 1010. The livestreaming room screen 1700 includes a video image 1728 of the livestreamer obtained by reproducing the video data transmitted by the video transmission unit 106 of the user terminal 1020, a comment display region 1730, an end livestream button 1732, an AI viewer status display region 1734, and an evaluation parameter display region 1736. The livestreamer-side UI control unit 108 of the user terminal 1020 superimposes various objects such as the comment display region 1730, the end livestream button 1732, the AI viewer status display region 1734, and the evaluation parameter display region 1736 on the video image 1728 obtained by reproducing the video data, to generate the livestreaming room screen 1700.

The comment display region 1730 may include comments entered by the AI viewers, comments entered by real-life viewers in the case where they can participate in the livestream, and notifications from the system. The notifications from the system may include information on which AI viewer gave what pseudo-gift to the livestreamer. The livestreamer-side UI control unit 108 generates the comment display region 1730 that includes comments of the AI viewers included in the reactions received from the server 1010, and the livestreamer-side UI control unit 108 inserts the generated comment display region 1730 in the livestreaming room screen 1700.

The end livestream button 1732 is an object for receiving an instruction from the livestreamer to terminate the delivery of the AI training livestream. When the end livestream button 1732 is tapped, the livestreamer-side communication unit 110 generates a livestream end instruction and transmits it to the server 1010 over the network NW.

The AI viewer status display region 1734 displays the status of each AI viewer participating in the AI training livestream. The AI viewer status display region 1734 displays, for each AI viewer, the properties 1738, emotion 1740, and likability rating 1742 of the AI viewer, and objects 1744 representing the total amount of pseudo-gift used by the AI viewer so far. The livestreamer-side UI control unit 108 generates the AI viewer status display region 1734 based on the reactions received from the server 1010, and the livestreamer-side UI control unit 108 inserts the generated AI viewer status display region 1734 in the livestreaming room screen 1700.

The evaluation parameter display region 1736 displays the current evaluation parameters of the AI training livestream. The evaluation parameter display region 1736 displays the total amount of pseudo-gift, total number of comments, score, number of viewers, and streaming duration. The livestreamer-side UI control unit 108 generates the evaluation parameter display region 1736 based on the reactions received from the server 1010, and the livestreamer-side UI control unit 108 inserts the generated evaluation parameter display region 1736 in the livestreaming room screen 1700.

The livestreamer views the AI viewer status display region 1734 and the evaluation parameter display region 1736 on the livestreaming room screen 1700, to check how the AI viewers react to his/her own behavior in the livestream and make trial-and-error attempts to determine what kind of behavior will make the livestream more exciting.

FIG. 27 is a representative screen image of a livestreaming room screen 1700 in the AI training livestream on the display of the livestreamer's user terminal 1020. FIG. 27 corresponds to the case where the livestreamer is under fire. The server 1010 determines whether or not the AI training livestream is under fire based on the reactions of AI viewers participating in the AI training livestream and the values of the evaluation parameters. For example, if the score is lower than a threshold and the likability ratings of all AI viewers are lower than a threshold, the AI training livestream is determined to be under fire. If it is determined that the AI training livestream is under fire, the livestreamer-side UI control unit 108 superimposes an object 1748 indicating that the livestream is under fire on the livestreaming room screen 1700.

FIG. 28 is a representative screen image of a livestreaming room screen 1700 in the AI training livestream on the display of the livestreamer's user terminal 1020. FIG. 28 corresponds to the case where the evaluation of the AI training livestream rises acutely. The server 1010 determines whether or not the AI training livestream is in an acute rise based on the reactions of AI viewers participating in the AI training livestream and the values of the evaluation parameters. For example, if the score is higher than a threshold and the likability ratings of all AI viewers are higher than a threshold, the AI training livestream is determined to be in an acute rise. If it is determined that the AI training livestream is in an acute rise, the livestreamer-side UI control unit 108 superimposes an object 1746 indicating that the livestream is in an acute rise on the livestreaming room screen 1700.

Thus, with the objects 1746 and 1748 displayed on the livestreaming room screen 1700 to indicate the status of the AI training livestream, the livestreamer can grasp the status of his/her livestream at a glance.

FIG. 29 is a representative screen image of a livestream ending screen 1750 displayed on the display of the livestreamer's user terminal 1020. When the livestreamer taps the end livestream button 1732, a livestream end instruction is transmitted to the server 1010. The server 1010 transmits the results of the evaluation of the ended AI training livestream to user terminal 1020. The livestreamer-side UI control unit 108 generates the livestream ending screen 1750 based on the results of the evaluation received from the server 1010 and shows the screen on the display. The livestream ending screen 1750 includes a parameter display region 1752 for displaying evaluation parameters at the end of the AI training livestream, and an improvement suggestion comment display region 1754 for displaying improvement suggestion comments.

FIG. 31 is a representative screen image of a livestream selection screen 1600 on a user terminal display of an active user. The livestream selection screen 1600 includes thumbnails 1602 representing livestreams in the list of currently available livestreams (including AI training livestreams set to accept real-life viewers) received from the server 1010. The out-of-livestream UI control unit 402 generates the livestream selection screen 1600 based on the list of livestreams obtained from the server 1010 and shows the screen on the display. In the livestream selection screen 1600, thumbnails corresponding to AI training livestreams and other thumbnails are displayed in a distinguishable manner. In the example shown in FIG. 31, the thumbnail corresponding to the AI training livestream is shown with the mark 1604.

FIG. 30 is a representative screen image of a livestreaming room screen 1608 displayed on the display of the user terminal 1030 of a real-life viewer participating in the AI training livestream. The livestreaming room screen 1608 displays a video image generated by the user terminal 1020 of the livestreamer in real time. The livestreaming room screen 1608 includes a video image 1610 of a livestreamer obtained by reproducing the video data received from the server 1010, a comment display region 1618, a quit viewing button 1620, an evaluation parameter display region 1636, and a message display region 1622. The livestreaming room screen 1608 has neither a region for receiving an input of comments nor a region for receiving an instruction for the use of gifts. In the example shown in FIG. 30, the use of gifts and the input of comments by real-life viewers are prohibited in the AI training livestream. The message display region 1622 expresses that. The real-life viewers can watch the process of the livestreamer's growth through viewing the livestreaming room screen 1608.

In the above embodiment, the databases may be stored on a hard disk or semiconductor memory, for example. By reading the present disclosure, those skilled in the art would understand that each element or component can be realized by a CPU not shown, a module of an installed application program, a module of a system program, or a semiconductor memory that temporarily stores the contents of data read from a hard disk, and the like.

In the livestreaming system 1 according to this embodiment, AI viewers can participate in a livestream. The AI viewers provide reactions to the behavior of the livestreamer. This allows the livestreamer to proceed with the livestream without real-life viewers, or to activate the livestream by having real-life viewers participate in addition to the AI viewers. The livestreamers can enhance their livestreaming skills by conducting the AI training livestream with multiple AI viewers. The livestreaming system 1 can provide a useful means of training, particularly for livestreamers who are just beginning to deliver livestreams.

### Third Embodiment

In the second embodiment, it was described that AI viewers are used to train a livestreamer. In the third embodiment, a viewer generates and uses an AI viewer that is his/her “double”.

FIG. 32 is a block diagram showing functions and configuration of a server 1050 relating to the third embodiment. The server 1010 includes a livestream information providing unit 1302, a relay unit 1304, a gift processing unit 1308, a payment processing unit 1310, a model generating unit 1350, a model deploying unit 1352, a stream DB 1354, a user DB 1318, a gift DB 1320, and an ML model DB 1356.

FIG. 33 is a data structure diagram showing an example of the stream DB 1354 in FIG. 32. The stream DB 1354 stores an stream ID for identifying a livestream on a livestreaming platform provided by the livestreaming system 1, a livestreamer ID, which is a user ID for identifying the livestreamer who provides the livestream, viewer IDs, which are user IDs for identifying viewers of the livestream (including AI viewers), a total number of comments posted in the livestream, a score of the livestream, a number of viewers of the livestream (including AI viewers), and a streaming duration of the livestream, in association with each other.

FIG. 34 is a data structure diagram showing an example of an ML model DB 1356 in FIG. 32. The ML model DB 1356 holds information on ML models generated by a user or generated according to an instruction from a user to realize AI viewers corresponding to that user or other users designated by that user. The ML model DB 1356 holds a model ID that identifies an ML model, a corresponding user ID that identifies a user corresponding to the ML model, the model data of the ML model, and a gift budget assigned to the ML model by the user who generated it, in association with each other.

Returning to FIG. 32, the model generating unit 1350 receives from the user terminal of a user (hereinafter referred to as the double-generating user) a request to generate an AI viewer corresponding to that user or another user designated by that user (hereinafter collectively referred to as the double target user). The model generating unit 1350 obtains from the user DB 1318 the viewing history of the double target user designated in the received generation request. The model generating unit 1350 generates a learned ML model by causing an unlearned ML model to learn the obtained viewing history. Through learning, the learned ML model will output the reactions that would be made by the double target user (real-life user). In this sense, the double target user is one of the properties of the corresponding ML model or AI viewer, and thus the corresponding user ID that identifies the user corresponding to the ML model is included in the properties of the ML model or AI viewer. The ML model that has learned the viewing history of viewer A can be said to have the “viewer A property”. The model generating unit 1350 enters the information on the generated learned ML model in the ML model DB 1356. The model generating unit 1350 inquires the gift budget of the double generating user and enters the obtained answer in the ML model DB 1356.

The AI viewer uses the gift within the gift budget in a manner similar to the use of the pseudo-gift in the first embodiment. The gifts used by AI viewers and the gifts used by real-life viewers have similar effects. When an AI viewer uses a gift, the gift processing unit 1308 and the payment processing unit 1310 perform the same processing as when a real-life viewer uses a gift.

The model deploying unit 1352 performs processing for allowing the AI viewers realized by the ML models generated by the model generating unit 1350 to participate as viewers in various livestreams. For example, the model deploying unit 1352 may receive reservations to allow the AI viewers to participate in livestreams. In this case, the model deploying unit 1352 receives the designation of a livestreamer by the double generating user, and when that livestreamer starts a livestream, the model deploying unit 1352 allows the AI viewer of the double target user to participate in that livestream. Alternatively, when an active user designates a thumbnail on the livestream selection screen, the model deploying unit 1352 may allow the active user to select whether the active user or an AI viewer corresponding to the active user will participate in the livestream. Alternatively, when a viewer is watching a livestream of one livestreamer and another livestreamer followed by the viewer starts a livestream, the model deploying unit 1352 may transmit a push notification to the viewer's user terminal, and the push notification may inquire whether to allow the AI viewer corresponding to the viewer to participate in the livestream started by the other livestreamer. Alternatively, the model deploying unit 1352 may allow a livestreamer to select an AI viewer prior to start of a livestream or during a livestream, and allow the selected AI viewer to participate in the livestream.

The model deploying unit 1352 may record the interaction between the AI viewer and the livestreamer in the livestream. The model deploying unit 1352 may provide the interaction itself or a summary of the interaction to the double generating user. By obtaining summaries from multiple AI viewers generated, the double generating user can grasp the state, the level of excitement, and the content of conversations of multiple livestreams without actually participating in those livestreams.

The operation of the livestreaming system including the server 1050 with the above configuration will be now described. FIG. 35 is a flowchart showing a series of steps performed in a livestream in which an AI viewer participates. The server 1050 determines whether or not the condition for participation of a particular AI viewer in a particular livestream have been met (S1250). The participation condition is as described above in the description of model deploying unit 1352. For example, the participation condition is met when the active user taps a thumbnail of the livestream and then chooses to allow the AI viewer corresponding to the active user to participate in the livestream.

If the participation condition is met (YES in S1250), the server 1050 allows the particular AI viewer to participate in the particular livestream (S1252). The server 1050 receives video data recording the livestreamer's behavior from the livestreamer's user terminal 1020 over the network NW (S1254). The server 1050 extracts the livestreamer's behavior from the received video data (S1256). The server 1050 inputs the extracted behavior into the ML model corresponding to the particular AI viewer (S1258). The server 1050 obtains reactions output by the ML model (S1260). The server 1050 transmits the obtained reactions to the livestreamer's user terminal 1020 and the user terminals of other viewers over the network NW (S1262).

The server 1050 determines whether or not the predetermined leaving condition has been met for the AI viewer participating in the livestream (S1264). The leaving condition is met, for example, when the likability rating output by the AI viewer falls below a predetermined threshold. If the leaving condition is met (YES in S1264), the server 1050 allows the particular AI viewer to leave the particular livestream (S1268). If the leaving condition is not met (NO in S1264), the server 1050 determines whether or not it has received a livestream end instruction from the livestreamer's user terminal 1020 (S1266). When the server has not yet received a livestream end instruction (NO in S1266), the process returns to step S1254. When the server has received a livestream end instruction (YES in S1266), the process ends.

FIG. 36 is a representative screen image of a livestream selection screen 1800 on a user terminal display of an active user. The livestream selection screen 1800 includes thumbnails 1802 representing livestreams in the list of currently available livestreams received from the server 1050. The out-of-livestream UI control unit 402 generates the livestream selection screen 1800 based on the list of livestreams obtained from the server 1050 and shows the screen on the display. When the active user designates or taps a certain thumbnail 1802 on the livestream selection screen 1800, the out-of-livestream UI control unit 402 superimposes on the livestream selection screen 1800 a selection region 1804 for the active user to select whether the active user himself/herself or an AI viewer corresponding to the active user will participate in the livestream corresponding to the designated thumbnail 1802. The selection region 1804 includes an enter button 1806 for the active user himself/herself to participate in the livestream, and a bot participation button 1807 for the AI viewer corresponding to the active user to participate in the livestream.

FIG. 37 is a representative screen image of a livestreaming room screen 1808 shown on the display of the viewer's user terminal 1030. The livestreaming room screen 1808 displays a video image generated by the user terminal 1020 of the livestreamer in real time. The livestreaming room screen 1808 includes a video image 1810 of the livestreamer obtained by reproducing the video data received from the server 1050, a gift object 1812, a comment input region 1816, a comment display region 1818, and a quit viewing button 1820.

FIG. 37 corresponds to the case where an active user (different from the viewer watching the livestreaming room screen 1808 in FIG. 37) tapped the bot participation button 1807 in the livestream selection screen 1800 in FIG. 36, and the AI viewer corresponding to that active user has joined in the livestream. More specifically, a thumbnail C, which corresponds to a livestream A progressing through the livestreaming room screen 1808 in FIG. 37 that a viewer B is watching, is displayed on the livestream selection screen 1800. An active user D, who is different from the viewer B, sees the livestream selection screen 1800, taps the thumbnail C, and then taps the bot participation button 1807. Then, a message 1819 indicating that an AI viewer of the active user D has entered the livestream is displayed in the comment display region 1818 of the livestreaming room screen 1808 in FIG. 37, which the viewer B is watching.

In the livestreaming system with the server 1050 according to this embodiment, a viewer can have an AI viewer who performs viewing activities similar to his/her own and allow the AI viewer to participate in the livestream on his/her behalf. Thus, it is possible to have the AI viewer participate in a livestream even when he/she is busy, asleep at night, or watching other livestreams, so that he/she can maintain his/her own presence and connection with the livestreamer.

The ML model may be configured to realize situations and scenarios that may arise in a livestream in the second embodiment. The server 1010 will randomly, or as directed by the livestreamer, configure the ML model to simulate a particular situation in an AI training livestream. For example, the server 1010 simulates a scene that is about to be under fire, by forcibly setting the emotion of all participating AI viewers to “anger”. Alternatively, the server 1010 simulates a scene where viewers are likely to leave, by forcibly lowering the average likability rating of participating AI viewers. Alternatively, the ML model can be set up to simulate different times of day, such as lunch break, evening, and late night.

In the second embodiment, a case was described in which multiple AI viewers participate in an AI training livestream, but this is not limitative. For example, when livestreamers are realized by ML models, a single livestream may be provided in which multiple AI livestreamers (livestreamers realized by ML models) participate. In this case, the server will realize a conversation between the AI livestreamers by inputting the output of one AI livestreamer to another AI livestreamer. Real-life users viewing this livestream can enjoy conversations between the AI livestreamers and can also participate in the livestream with gifts and comments. The system may be configured to allow the viewers to designate the topic of this livestream. When AI viewers are allowed to participate in this livestream, it is possible to enjoy the interaction between multiple AI livestreamers plus AI viewers.

The second embodiment may be configured to allow the livestreamer to set his or her own level. The server 1010 will allow AI viewers according to the set level to participate in the AI training livestream. For example, if the livestreamer's level is set to Level 1 (novice), AI viewers who also have the property of being a novice are allowed to participate in the AI training livestream. If the livestreamer's level is set to level 100 (professional livestreamer), AI viewers with the property of being VIP are allowed to participate in the AI training livestream.

The second embodiment may be configured to allow for setting in which AI viewers are regarded as a group. For example, the server may be configured to allow the livestreamer to set a half of the AI viewers to be AI viewers with the property of being a novice. Alternatively, the server may also be configured to allow the livestreamer to set 70% of the AI viewers to be AI viewers who are charged monthly (Army). The server may generate patterns of viewer groups by analyzing the viewing history of actual viewers.

In the second embodiment, the server may be configured to compare and analyze livestreamers who practiced using AI training livestreams with other livestreamers, and output the results.

In the second embodiment, the evaluation unit may capture and analyze the sound of an AI training livestream (or even a regular livestream) for evaluation. Basically, the sound balance is good in the livestream of a quality livestreamer. For example, there is no or relatively little silent time, and even if the livestreamer is not talking, the background music is played in a good balance, allowing the viewer to have a pleasant time. The balance of volume is also related to the quality of the livestream. For example, unbalanced volume (particularly if too low) compared to other livestreams will lead to a decrease in the quality of the livestream. Therefore, the evaluation unit may generate an evaluation of the AI training livestream by capturing and analyzing the presence and length of silent periods in the AI training livestream and/or the balance of sound and/or volume. Machine learning may be used to adjust the balance of volume and voice production to be comfortable for humans (viewers) in livestreams.

In the second embodiment, the server may be configured to allow the livestreamer to designate a particular event and set a goal of ranking in that event. In this case, the server allows the livestreamer to select an event in which he/she wants to succeed, before starting the AI training livestream. The server will set up AI viewers that are the same or similar to the viewers of the livestreams of a livestreamer previously successful (e.g., ranked in top 5) in the genre of that event. The evaluation unit will make evaluation and provide feedback on an AI training livestream by comparing it to the livestreams of a livestreamer previously successful in the genre of that event. According to this example, the livestreamer can get feedback on the perspective of making a dream come true (e.g., wanting to be on a model runway). This can meet the needs of livestreamers who are top or non-top livestreamers wanting to be number one at this event and delivering livestreams on a livestreaming platform for that purpose. Alternatively, the server can made prediction and provide feedback about an event genre (music, modeling, etc.) in which the livestreamer is likely to be successful, based on the similarity between the interactions in the AI training livestreams and the interactions in the livestreams of the livestreamers ranked high such as in the top 5 in previous events of the same genre as the designated event. An example of feedback goes like “If you improve this point, you might have been ranked in this past event (based on the similarity of livestream contents with the winning livestreamers and interactions)”. Novice and mid-level livestreamers can be encouraged to use the AI training livestream before participating in an event, thereby to find similar events, such as events in genres in which they are likely to win. Thus, they are encouraged to participate in such events. This will increase motivation of the livestreamers, who will find a chance to win an event and encouraged to participate the event, thus creating competition among participating livestreamers and leading to the vitalization of the livestreaming platform.

The technical ideas relating to the second and/or third embodiment may be represented by the following items.

### <Item 1>

A server comprising:
means for receiving, from a terminal of a livestreamer of a livestream over a network, data including behavior of the livestreamer, participants of the livestream including the livestreamer and a plurality of viewers including a virtual viewer realized by a machine learning model;
means for obtaining a reaction output by the machine learning model, the machine learning model taking as input the behavior of the livestreamer and outputting the reaction that would be made by a viewer with a property set thereto; and
means for transmitting data for realizing the reaction to the terminal over the network.

### <Item 2>

The server of Item 1, wherein a plurality of different virtual viewers participate in the livestream, each of the virtual viewers has a corresponding property set thereto, and each of the virtual viewers is realized by a corresponding machine learning model.

### <Item 3>

The server of Item 1, wherein only virtual viewers can participate in the livestream as viewers.

### <Item 4>

The server of Item 1, wherein the reaction output by the machine learning model includes at least one of emotion, degree of interest, and likability rating of the virtual viewer corresponding to the machine learning model for the livestream or the livestreamer.

### <Item 5>

The server of Item 1, wherein the reaction output by the machine learning model includes input of a comment and/or use of a gift in the livestream by the virtual viewer corresponding to the machine learning model.

### <Item 6>

The server of Item 2, wherein each of the machine learning models corresponding to the plurality of virtual viewers takes as input the reactions output by the machine learning models corresponding to other virtual viewers.

### <Item 7>

The server of Item 2, further comprising:
means for evaluating the livestream and/or the livestreamer of the livestream based on the reactions output by the machine learning models corresponding to the plurality of virtual viewers; and
means for transmitting results of evaluation to the terminal of the livestreamer over the network.

### <Item 8>

The server of Item 1, further comprising:
means for maintaining viewing history of a real-life user on a livestreaming platform provided by the server; and
means for causing the machine learning model to learn the viewing history,
wherein the machine learning model having learned the viewing history learns to output reactions that would be made by the real-life user.

### <Item 9>

A method, comprising:
receiving, from a terminal of a livestreamer of a livestream over a network, data including behavior of the livestreamer, participants of the livestream including the livestreamer and a plurality of viewers including a virtual viewer realized by a machine learning model;
obtaining a reaction output by the machine learning model, the machine learning model taking as input the behavior of the livestreamer and outputting the reaction that would be made by a viewer with a property set thereto; and
transmitting data for realizing the reaction to the terminal over the network.

### <Item 10>

A computer program for causing a terminal of a livestreamer of a livestream, participants of which include the livestreamer and a plurality of different virtual viewers realized by a plurality of different machine learning models, to perform the functions of:
transmitting data including behavior of the livestreamer to a server providing the livestream over a network;
receiving, from the server over the network, data for realizing a plurality of reactions output from the plurality of machine learning models by inputting the behavior to the plurality of machine learning models; and
displaying a plurality of objects representing the plurality of reactions on a display based on the data.

### Fourth Embodiment

Japanese Patent No. 7288254 discloses a video editing technique suitable for live commerce archiving.

With the increased and varied demands for video content, efficient and flexible editing processes are becoming increasingly important. In particular, selecting appropriate scenes from long videos and livestreams and editing them in an attractive manner is a time-consuming and labor-intensive task. The existing systems fail to adequately address at least one of the following points.
1. Efficient extraction of scenes from large amounts of material
2. Editing support that takes into account the context and intention of the content
3. Real-time editing support for live content
4. Editing recommendation that takes into account viewer interests and reactions
5. Dynamic reflection of editorial intention and preferences

The fourth embodiment of the disclosure was made in light of these issues, and one object is to provide a technique that allows for more efficient and flexible editing of livestreams. The fourth embodiment allows for more efficient and flexible editing of livestreams.

The fourth embodiment relates to video analytics, machine learning, content editing support, media production workflow optimization, and real-time livestreaming technologies. The object of the embodiments in this disclosure is to solve at least one of the following issues.
1. Automatic identification and extraction of scenes suitable for editing from long videos
2. Editorial suggestions based on the context and intention of the content.
3. Real-time generation of editable highlights during a livestream
4. Analysis of viewer reactions and interests and suggestion of effective editorial strategies
5. Integration of multiple video sources to create consistent editorial content
6. Significantly improved efficiency of the editing process and reduced production time
7. Expanded editorial creativity and facilitated collaboration with AI
8. Provision of a flexible mechanism to reflect user intentions and priorities

In the livestreaming system relating to the fourth embodiment, the system automatically generates a clip from the archive of livestreams. A portion of an archived livestream or video data related to such a portion is referred to as a “clip” of this livestream. When multiple clips are generated from an archive, the video data in that archive is the “original” video data for each clip. The livestreaming system presents information on the generated clips to the editor, who inputs the desired clips and editing instructions indicating the editing policy into the system. Based on the designated clips and the editing instructions, the livestreaming system generates edited video using a machine learning model for editing (hereinafter referred to as the editing ML model).

This provides innovative solutions that combine creativity and efficiency in the rapidly changing video production and delivery market. High-quality content creation can be supported by optimally combining human creativity with AI processing capabilities, while significantly reducing the burden of conventional editing work. In particular, the real-time processing capability and flexible prompt-based control features open up new possibilities in the field of livestream editing and facilitates interaction with the editor.

The livestreaming system 2001 relating to the fourth embodiment has the same configuration as the livestreaming system 1 shown in FIG. 1. A user terminal 2020 of a livestreamer and a user terminal 2030 of a viewer in the livestreaming system 2001 have the same configuration as the user terminal 20 shown in FIG. 2.

FIG. 38 is a block diagram showing functions and configuration of a server 2010 relating to the fourth embodiment. The server 2010 includes a support integration system. The support integration system will assist a livestreamer in editing the archive of his/her own livestreams. In particular, this system provides the livestreamer's user terminal with various functions to facilitate editing operations such as merging and modifying clips generated from the archive. The server 2010 includes a livestream information providing unit 2302, a relay unit 2304, a gift processing unit 2308, a payment processing unit 2310, a support integration system 2322, a stream DB 2314, a user DB 2318, and a gift DB 2320. The gift DB 2320 has the same configuration as the gift DB 320 in FIG. 6.

The support integration system 2322 will assist an editor in editing the archive clips of livestreams. The support integration system 2322 analyzes a livestream in real time and assists the livestreamer in marking important scenes. The support integration system 2322 generates clips based on viewer reactions (comments, likes, viewing time, etc.). The support integration system 2322 integrates multiple clips generated from multiple different archives to automatically compose an optimal viewing experience. The support integration system immediately generates edited videos (also called highlight videos) after the livestream is ended, and automatically posts them to the platform. The support integration system 2322 generates a personalized digest version tailored to the viewer demographic. The support integration system 2322 automatically detects inappropriate content and warns the editor. The support integration system 2322 automatically detects technical problems (poor audio, disturbed video, etc.) during a livestream and suggests corrections during the clip editing phase. The support integration system 2322 integrates the simultaneous livestreams of multiple livestreamers during a live event to provide a unified editorial view. The support integration system 2322 has a generative AI model (editing ML model) for removing background music and proposing and embedding new background music. The support integration system 2322 has a prompt-based importance specification function. For example, editors can preset instructions such as “emphasize exciting scenes” or “give priority to educational content.” Real-time instructions such as “emphasize product introduction for the next five minutes” can be given even during a livestream. The ML model for extraction interprets these instructions and reflects them in scene extraction and highlight generation. The support integration system 2322 implements a livestreamer interaction flag system. The support integration system 2322 provides flag buttons that can be easily operated by the livestreamer on the livestreaming screen (e.g., “excitement,” “key point,” “interesting comment,” etc.). The support integration system 2322 automatically time-stamps the moment a flag is applied and automatically generates clips of the livestream based on the type and frequency of the flag. The support integration system 2322 performs flag-linked recommendation optimization. The support integration system 2322 will prioritize clipping out the sections with the “excitement” flag applied by the livestreamer and generate clips of such sections. The support integration system 2322 will process the sections with the “key point” flag to emphasize them when creating the educational digest video. The support integration system 2322 generates a highlight video with viewer participation, based on the “interesting comment” flag.

These functions of the support integration system 2322 enable the livestreamer's own senses and judgment to be directly reflected in the editing process, and realize editing that takes into account subtle nuances and context that cannot be captured by AI alone, making it possible to create highlight videos that retain the realism and unique atmosphere of livestreams.

The support integration system 2322 includes an archive generating unit 2324, a clip generating unit 2326, an editing content obtaining unit 2328, an editing processing unit 2330, an edited video providing unit 2332, an archive DB 2334, a clip DB 2336, and an edited video DB 2338.

FIG. 39 is a data structure diagram showing an example of the stream DB 2314 in FIG. 38. The stream DB 2314 holds information regarding livestreams currently taking place. The stream DB 2314 stores a stream ID for identifying a livestream on a livestreaming platform provided by the livestreaming system 2001, a livestreamer ID, which is a user ID for identifying the livestreamer who provides the livestream, viewer IDs, which are user IDs for identifying viewers of the livestream, and a score of the livestream, in association with each other.

In the livestreaming platform provided by the livestreaming system 2001 of the embodiment, when a user livestreams, the user is referred to as a livestreamer, and when the same user views a livestream delivered by another user, the user is referred to as a viewer. Therefore, the distinction between a livestreamer and a viewer is not fixed, and a user ID entered as a livestreamer ID at one time may be entered as a viewer ID at another time.

The score is an indicator of excitement in the livestream. A livestream with a high score value is recognized as “exciting” or “popular”. The score varies depending on, for example, the number of viewers, streaming time, number of comments, number of shares, number of gifts received, number of viewers who gave gifts, and number of cheers.

FIG. 40 is a data structure diagram showing an example of the user DB 2318 of FIG. 38. The user DB 2318 holds information regarding users. The user DB 2318 stores a user ID for identifying a user, points held by the user, a reward given to the user, and a level of the user, in association with each other.

The points are an electronic representation of value circulated in the livestreaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

The level is an indicator of the user's past performance as a livestreamer on the livestreaming platform. In other embodiments, the level may be an indicator of the user's past performance as a viewer on the livestreaming platform or it may be an indicator of the user's past performance as a livestreamer and as a viewer. The level may increase or decrease depending on the number of times the user has delivered a livestream, the streaming time of the livestreams, the total viewed time of the livestreams, the total viewing time as a viewer of livestreams, the number and/or amount of gifts the user has given, the number and/or amount of gifts the user has received, the number of comments, etc. Alternatively, the level may be evaluated and determined by the administrator based on reviews about the livestreamer, user satisfaction, and comments posted during the livestream. Alternatively, the level may be automatically determined based on predetermined rules or by a ML model for determining the level.

FIG. 41 is a data structure diagram of an example of the archive DB 2334 in FIG. 38. The archive DB 2334 holds data related to archives of livestreams that have been or are being performed on the livestreaming platform. The archive DB 2334 holds an archive ID for identifying an archive of a livestream, a livestreamer ID of the livestreamer who delivered the livestream archived, a stream ID of the livestream archived, delivery date and time of the livestream, video data of the archive, flag data, comment data, gift data, and viewer count data, in association with each other. In this embodiment, an archive of a livestream is generated simultaneously with the progress of the livestream. Therefore, the archive DB 2334 also holds archives of ongoing livestreams. In the example in FIG. 41, the archive “ARCO2” is the archive of the livestream “ST92” that is currently in progress, and therefore the end time in the delivery date and time is “ongoing”.

The flag data is related to flags applied by the livestreamer during a livestream. In this embodiment, a livestreamer of a livestream can apply flags at desired timings during the livestream. The type of the flag applied in this manner and the timing at which it was applied are held in the archive DB 2334 as the flag data. The flag data includes, for each flag type or flag ID, the time the flag was applied by the livestreamer. This time is expressed as a time with the start of the archive as zero. In the example in FIG. 41, the flag data records, for the archive “ARCO1”, that the flag “FLGA” was applied at times “0:05”, “0:13”, and “0:44” of the livestream “ST80” corresponding to the livestreamer “GHK”, the flag “FLGB” was applied at time “0:33”, and the flag “FLGC” was applied at times “0:06”, “0:10”, and “0:11”.

The comment data holds information on comments entered by participants (livestreamers and viewers) within livestreams. The comment data holds the time when the comment was posted, the user ID of the user who posted the comment, and the comment, in association with each other.

The gift data holds information on gifts used within livestreams. The gift data records what gifts were used by whom and when. The gift data holds the time when the gift was used, the user ID of the user who used the gift, and the gift ID of the gift, in association with each other.

The viewer count data records the number of viewers of the livestream at predetermined time intervals. The viewer count data holds the time the number of viewers was obtained and the number of viewers obtained, in association with each other.

FIG. 42 is a data structure diagram showing an example of the clip DB 2336 in FIG. 38. The clip DB 2336 holds information on clips generated from the archive. The clip DB 2336 holds a clip ID identifying a clip, video data of the clip, an archive ID identifying an archive from which the clip was generated, a stream ID identifying the livestream corresponding to the archive, a livestreamer ID identifying the livestreamer of the livestream, start time and end time of the clip in the archive, a tag assigned to the clip, and a reason why the clip was generated, in association with each other. The clip ID may be a URL.

The video data of a clip includes video data related to a portion of the original archive or livestream. The video data may include video data generated by the livestreamer's user terminal and data of objects such as gift effects and comments superimposed on the video.

In the example in FIG. 42, clip “CL1” is a clip cut from the archive “ARC01” of the livestream “ST80” of livestreamer “GHK”, and is a 7-second video obtained by cutting out the portion between 0:05 (5 seconds after start) and 0:12 (12 seconds after start) of the archive “ARC01” The clip “CL1” is assigned the tags “highlight” and “action,” which records that this clip was generated because the viewer reactions were highly positive.

FIG. 43 is a data structure diagram showing an example of an edited video DB 2338 in FIG. 38. The edited video DB 2338 holds the data of edited videos generated by the support integration system 2322. The edited video DB 2338 holds an edited video ID that identifies an edited video, a creator ID that is the user ID of the user who created the edited video, video data of the edited video, an original clip ID that is the clip ID of at least one clip from which the edited video was created, an original video ID that is the edited video ID of the edited video from which a variation is created if the edited video is a variation, and a target property of the variation if the edited video is a variation, in association with each other.

In this embodiment, the support integration system 2322 receives the clip ID of the clip to be edited and the editing policy from the editor. The support integration system 2322 inputs the clip to be edited and the editing policy into the editing ML model and obtains the edited video output from the editing ML model. For this edited video, the clip ID of the clip input into the editing ML model is the original clip ID. The editing ML model is configured to output different versions of the edited video for each target property. In the example shown in FIG. 43, the editing ML model generates, from the original edited video “EV01”, a variation “EV02” for the target property “Level 0-10”, a variation “EV03” for the target property “Male in 20s”, and a variation “EV04” for the target property “Chatty”.

Referring again to FIG. 38, upon reception of a notification from the user terminal 2020 of a livestreamer that the livestreamer starts a livestream over the network NW, the livestream information providing unit 2302 enters in the stream DB 2314 the stream ID identifying this livestream and the livestreamer ID of the livestreamer who delivers the livestream. When the livestream information providing unit 2302 receives a request for information about livestreams from the out-of-livestream communication unit 404 of a user terminal of an active user over the network NW, the livestream information providing unit 2302 refers to the stream DB 2314 and generates a list of currently available livestreams. The livestream information providing unit 2302 transmits the generated list to the requesting user terminal over the network NW. The out-of-livestream UI control unit 402 of the requesting user terminal generates a livestream selection screen based on the received list and shows the livestream selection screen on the display of the user terminal.

Once the out-of-livestream UI control unit 402 of the user terminal receives the active user's selection of a livestream on the livestream selection screen, the out-of-livestream UI control unit 402 generates a livestream request including the stream ID of the selected livestream, and transmits the livestream request to the server 2010 over the network NW. The livestream information providing unit 2302 starts to provide, to the requesting user terminal, the livestream identified by the stream ID included in the received livestream request. The livestream information providing unit 2302 updates the stream DB 2314 such that the user ID of the active user of the requesting user terminal is included in the viewer IDs associated with the stream ID. In this way, the active user can be a viewer of the selected livestream.

The relay unit 2304 relays the video data from the user terminal 2020 of the livestreamer to the user terminals 2030 of the viewers in the livestream started by the livestream information providing unit 2302. The relay unit 2304 receives from the viewer-side communication unit 204 a signal that represents user input made by a viewer during the livestream, or during reproduction of the video data. The signal that represents user input may be an object designation signal that indicates designation of an object displayed on the display of the user terminal 2030, and the object designation signal includes the viewer ID of the viewer, the livestreamer ID of the livestreamer delivering the livestream that the viewer watches, and an object ID that identifies the object. When the object is a gift icon, the object ID is a gift ID. The object designation signal in that case is a gift use signal indicating that the viewer uses a gift for the livestreamer. Similarly, the relay unit 2304 receives from the livestreamer-side communication unit 110 of the livestreaming unit 100 in the user terminal 2020 a signal that represents user input by the livestreamer during reproduction of the video data, such as an object designation signal. When the object is a flag button, the object ID is a flag ID. In such a case, the object designation signal is a flag application signal indicating the application of the flag by the livestreamer.

The gift processing unit 2308 updates the user DB 2318 so as to increase the reward for the livestreamer according to the reward to be awarded of the gift identified by the gift ID included in the gift use signal. Specifically, the gift processing unit 2308 refers to the gift DB 2320 to specify a reward to be awarded for the gift ID included in the received gift use signal. The gift processing unit 2308 then updates the user DB 2318 to add the specified reward to be awarded to the reward for the livestreamer ID included in the gift use signal.

The payment processing unit 2310 processes payment of a price of the gift by the viewer in response to reception of the gift use signal. Specifically, the payment processing unit 2310 refers to the gift DB 2320 to specify the price points of the gift identified by the gift ID included in the gift use signal. The payment processing unit 2310 then updates the user DB 2318 to subtract the specified price points from the points of the viewer identified by the viewer ID included in the gift use signal.

The archive generating unit 2324 generates an archive of the a livestream in parallel with the progress of the livestream, and enters the generated archive into the archive DB 2334. Once the archive generating unit 2324 receives from a livestreamer's user terminal 2020 a notification that the livestreamer is going to start a livestream, the archive generating unit 2324 starts recording the video data of the livestream provided by the user terminal 2020. The archive generating unit 2324 enters the archive ID, livestreamer ID, stream ID, delivery date and time, and the recorded video data into the archive DB 2334 in association with each other.

When detecting a comment posted in the livestream, the archive generating unit 2324 enters the information of the posted comment into the comment data of the archive DB 2334. When a comment is entered at a user terminal of a participant in a livestream, the user terminal generates a comment input signal including the stream ID of the livestream, the user ID of the participant, and the entered comment, and transmits the signal to the server 2010 over the network NW. When the comment input signal is received, the archive generating unit 2324 enters the user ID included in the signal, the comment included in the signal, and the time when the signal was received, into the comment data corresponding to the archive ID associated with the stream ID included in the signal, in association with each other.

When detecting the use of a gift in the livestream, the archive generating unit 2324 enters the information of the used gift into the gift data of the archive DB 2334. When a gift use signal is received, the archive generating unit 2324 enters the gift ID included in the gift use signal, the time when the gift use signal was received, and the viewer ID included in the gift use signal, into the gift data corresponding to the archive of the livestream in which the gift was used, in association with each other.

The archive generating unit 2324 measures the number of viewers at predetermined time intervals during the livestream and enters the measurement results into the viewer count data of the archive DB 2334.

When receiving a flag application signal from the livestreamer's user terminal, the archive generating unit 2324 enters the flag ID and the time when the flag was applied included in the received flag application signal, into the flag data corresponding to the archive of the livestream in which the flag was applied.

The clip generating unit 2326 generates a plurality of different clips, each of which is a portion of the archive of the livestream. The clip generating unit 2326 generates a plurality of clips based on the reactions of the viewers of the livestream corresponding to the archive and the actions of the livestreamer of that livestream. The actions of the livestreamer of the livestream include the application of a flag by the livestreamer at a desired timing during the livestream.

The clip generating unit 2326 generates clips from the archive of the livestream held in the archive DB 2334 and enters the generated clips into the clip DB 2336. The clip generating unit 2326 generates clips automatically, i.e., regardless of whether it has received an instruction from the livestreamer or a viewer. When detecting the end of a livestream, the clip generating unit 2326 may start generating clips from the archive of the ended livestream. Alternatively, the clip generating unit 2326 may generate clips from the archive up to the present of the livestream in parallel with the progress of the livestream.

The clip generating unit 2326 obtains the video data, flag data, comment data, gift data, and viewer count data of the archive held in the archive DB 2334, and generates multiple clips by processing the obtained data in a predetermined clip generation algorithm. The clip generation algorithm may determine the range to be clipped from the archive based on at least one of the score, flags, comments, gifts, and viewer count. The clip generation algorithm may be configured to allow the user or administrator to set the above factors and the relative weighting among the above factors. The clip generation algorithm may be implemented by a learned ML model for extraction, or it may be implemented on a rule-basis. In this example, the clip generation algorithm is configured to identify and determine the ranges of portions of the archive where viewer reactions were relatively highly positive, where a relatively large amount of gift was used, and where the score increase was relatively high.

The clip DB 2336 may determine a tag corresponding to the obtained archive by analyzing the video data of the archive, and enter the determined tag in the clip DB 2336. An ML model for determining a tag may be used to determine the tag.

The editing content obtaining unit 2328 obtains, from the editor's user terminal over the network NW, the editing content that the editor wants to make to the multiple clips. When receiving from the editor's user terminal a request to start editing that includes the editor's user ID, the editing content obtaining unit 2328 extracts from the clip DB 2336 the clip of the livestream for which the editor is the livestreamer and the information associated with that clip, and transmits them to the requesting user terminal. The multiple clips extracted here are clips from livestreams for which the editor is the livestreamer, and thus may include clips generated from different livestreams of the same livestreamer. For example, the multiple clips to be extracted may include a first clip that is a part of a first livestream of one livestreamer and a second clip that is a part of a second livestream (different from the first livestream) of the same livestreamer. In the example shown in FIG. 42, when the editor is the livestreamer “GHK”, the clips “CL1”, “CL2”, and “CL3” of the livestream “ST80” and the clip “CL4” of the livestream “ST79” are extracted and provided to the user terminal of the editor “GHK”. Thus, the support integration system 2322 enables multi-source editing of highlight videos.

The editing content obtaining unit 2328 obtains, from the editor's user terminal over the network NW, selection information indicating at least one clip selected by the editor from among the plurality of clips transmitted as described above, and the editor's editing instruction. The selection information includes the clip IDs of the selected clips, the order of the clips as adjusted by the editor, and the tags and/or annotations applied by the editor to the selected clips. The editing content obtaining unit 2328 enters the tags included in the selection information into the clip DB 2336.

The editing processing unit 2330 obtains the edited video data output by the editing ML model to which the selection information and editing instruction have been input. The editing processing unit 2330 includes a learned editing ML model. This editing ML model receives as input the clips and editing instruction designated in the selection information. In particular, the editing instruction is included in the prompt of the editing ML model. The editing ML model generates a single video data by arranging the clips designated in the selection information in the order designated in the selection information and performing image processing according to the editing instruction. The editing ML model outputs the generated video data as edited video data. The editing ML model of the editing processing unit 2330 may be implemented using technologies described, for example, in “How to Generate Videos with luma ai | How to Generate and Connect Videos |” by AI & IT Monetization Laboratory, Jun. 16, 2024, URL:

https://note.com/kouhukutokane/n/nd428318ec852, and “Merge Videos” by VIDIO, URL: https://www.vidio.ai/ja-JP/tools/video-joiner.

The editing ML model of the editing processing unit 2330 generates and outputs multiple versions of video data, each corresponding to a different target property, based on the edited video data generated as described above. For each target property, the editing processing unit 2330 inputs the description corresponding to that target property into the editing ML model in the form of a prompt. The editing ML model re-edits the edited video data according to the description in the prompt, to generate and output a version of the edited video data corresponding to the target property. For example, if a description corresponding to the target property “chatty” is included in the prompt, the editing ML model re-edits the edited video to emphasize the portion of the clip with the tag of chatting in the edited video, so as to generate a version of the video data corresponding to the target property “chatty”.

The edited video providing unit 2332 provides edited video data to the editor's user terminal over the network NW. The edited video providing unit 2332 enters into the edited video DB 2338 the edited video data and multiple versions thereof obtained by the editing processing unit 2330.

The operation of the livestreaming system 2001 with the above configuration will be now described. FIG. 44 is a flowchart showing a series of steps performed on a user terminal of an editor during editing. When receiving the editor's instruction to start editing, the editor's user terminal generates a request to start editing that includes the editor's user ID and transmits the request to the server 2010 over the network NW (S2202). The user terminal receives from the server 2010 the clips of the livestream for which the editor is the livestreamer, and the information associated with that clips (S2204). The user terminal displays an editing screen on the display that includes a list of thumbnails of the received clips (S2206). The editor previews a thumbnail (S2208).

If the editor is not interested in the previewed thumbnail (NO in S2210), the editor previews another thumbnail (back to step S2208). If the editor is interested in the previewed thumbnail or corresponding clip (YES in S2210), the editor designates that thumbnail of interest (S2212). The user terminal displays detailed information about the clip corresponding to the designated thumbnail (S2214) and plays the clip in the preview window of the editing screen (S2216).

If the editor does not select the clip after viewing the clip played in the preview window (NO in S2218), the editor previews another thumbnail (back to step S2208). If the editor selects the clip after viewing the clip played in the preview window (YES in S2218), the user terminal enters or adds the selected clip into the selection list (S2220). If the editor wishes to view other clips (YES in S2222), the editor previews another thumbnail (back to step S2208). If the editor determines that there are no other clips to view (NO in S2222), the user terminal receives from the editor adjustments of the order of the selected clips shown in the selection list (S2224). The user terminal receives the addition of tags and/or annotations by the editor to each selected clip shown in the selection list (S2226). The user terminal receives input of an editing instruction (S2228). The user terminal performs a confirmation process for confirming the selection and input by the editor (S2230). If the editor does not confirm the selection of the clips and the content of the editing instruction (NO in S2232), the user terminal receives modification of the editor's selection and/or input (S2234). The process then returns to step S2230. If the editor confirms the selection of the clips and the content of the editing instruction (YES in S2232), the user terminal transmits the clip selection results and the editing instruction to the server 2010 (S2236). The user terminal generates selection information including the selection list, the adjusted order, and the tags and/or annotations input, and transmits the selection information together with the editing instruction to the server 2010.

FIG. 45 is a flowchart showing a series of steps performed on the server 2010 during editing. The server 2010 receives from the editor's user terminal the request to start editing that includes the editor's user ID (S2302). The server 2010 obtains from the clip DB 2336 information on the clips corresponding to the editor, i.e., the clips generated from past livestreams (archives) performed by the editor as a livestreamer (S2304). The information on the clips includes the clips of the livestream for which the editor is the livestreamer, and the information associated with that clips. The server 2010 transmits the obtained information on the clips to the requesting user terminal (S2306). The server 2010 receives the editor's selection of the clips and the editing instruction from the editor's user terminal (S2308). The server 2010 inputs the selected clips and the editing instruction into the editing ML model (S2310).

The editing ML model performs the video editing process (S2312). This video editing process includes interpretation and execution of editing instructions (S2314), automatic generation of transitions between clips (S2316), application of effects and background music (S2318), and checking and adjustment to ensure overall consistency (S2320).

The server 2010 transmits the video generated and output by the editing ML model to the editor's user terminal (S2322). The server 2010 receives the results of the editor's adjustment of the video from the editor's user terminal (S2324). If the received adjustment result indicates a re-editing instruction (YES in S2326), the server 2010 receives the editing instruction for re-editing from the editor's user terminal (S2328). The process then returns to step S2312. If the received adjustment result does not indicate a re-editing instruction (NO in S2326), the server 2010 finalizes the adjusted video as the edited video and enters it in the edited video DB 2338 (S2330). The server 2010 generates variations of the edited video corresponding to the target properties and enters the generated variations in the edited video DB 2338 (S2332).

FIG. 46 is a representative screen image of an editing screen 2500 displayed on the display of the editor's user terminal. When the editor's user terminal transmits a request to start editing to the server 2010 and receives the information on the clips from the server 2010, the user terminal generates the editing screen 2500 based on the received information and shows it on the display. The editing screen 2500 includes clip thumbnails 2502 included in the information on the clips, a preview window 2504, a clip detail display region 2506 that displays detailed information on the selected clip, a selected clip display region 2508 that displays the clip titles 2510 of the clips included in the selection list, an editing instruction input region 2512 that receives input of an editing instruction by the editor in a text input format, a confirm button 2514, and a cancel button 2516. The thumbnails 2502 are thumbnails of clips that can be selected by the editor, i.e., clips of a livestream performed by the editor. In FIG. 46, the system suggests “exciting portions” in the archive in the form of the generated clips, from which the livestreamer can select several clips by tapping or other operation. The selected clips are then compressed to create a single video.

The editor selects, by tapping, a thumbnail 2502 of interest from among multiple thumbnails 2502. The preview window 2504 plays the clip corresponding to the tapped thumbnail 2502, and the clip detail display region 2506 displays detailed information on that clip. If the editor decides that the clip is to be edited, he or she taps again the corresponding thumbnail 2502. When detecting the tap, the user terminal adds the corresponding clip to the selection list and also adds the clip title 2510 of the corresponding clip in the selected clip display region 2508. If the editor wants to undo selection of a clip, he or she should make a long tap on the clip title 2510 of that clip. The user terminal removes this clip with the long-tapped clip title 2510 from the selection list. The editor adjusts the order of the clips in the highlight video by dragging and dropping the clip titles 2510 in the selected clip display region 2508. The editor enters the desired tags and/or annotations in the clip detail display region 2506.

When the editor selects a clip, enters an editing instruction, and taps the confirm button 2514, the user terminal generates selection information including the selection list, the order adjusted in the selected clip display region 2508, and the tags and/or annotations entered through the clip detail display region 2506, and transmits to the server 2010 the selection information together with the editing instruction entered in the editing instruction input region 2512.

FIG. 47 is a representative screen image of a livestreaming room screen 2630 displayed on the display of the livestreamer's user terminal 2020 during a livestream. The livestreaming room screen 2630 includes a video image 2632 of the livestreamer obtained by reproducing the video data transmitted by the video transmission unit 106, a comment display region 2634, an end livestream button 2636, and objects related to application and display of flags. The livestreamer-side UI control unit 108 superimposes various objects such as the end livestream button 2636, the comment display region 2634, and the objects related to application and display of flags, on the video image 2632 obtained by reproducing the video data, to generate the livestreaming room screen 2630. Thus, the objects related to application and display of flags are associated with the livestreamer's video image 2632. The flag may indicate a portion that the livestreamer wants to use later.

The comment display region 2634 may include comments entered by the viewer and notifications from the system. The notifications from the system may include information about who gave what gift to the livestreamer. The livestreamer-side UI control unit 108 generates the comment display region 2634 including comments of other viewers received from the server 2010 and notifications from the system, and the livestreamer-side UI control unit 108 inserts the generated comment display region 2634 in the livestreaming room screen 2630.

The end livestream button 2636 is an object for receiving an instruction from the livestreamer to terminate the delivery of the livestream.

The objects related to application and display of flags include a time axis object 2638, an excitement flag object 2640, a key point flag object 2642, an interesting comment flag object 2644, an excitement button 2646, a key point button 2648, and an interesting comment button 2650. The time axis object 2638, the excitement flag object 2640, the key point flag object 2642, and the interesting comment flag object 2644 together constitute a graphical user interface that represents the timings at which the flags are applied in the livestream. The right end of the time axis object 2638 indicates the present time, and the left end indicates the start time of the livestream. Both the excitement flag object 2640 and the excitement button 2646 are represented by solid lines, indicating that they correspond to each other. Both the key point flag object 2642 and the key point button 2648 are represented by dashed lines, indicating that they correspond to each other. Both the interesting comment flag object 2644 and the interesting comment button 2650 are represented by a dashed-dotted line, indicating that they correspond to each other. These correspondences may be expressed by other visual features such as color and size, instead of line type. The position of each flag object in the time axis object 2638 represents the timing at which the flag was applied. The example in FIG. 47 shows that after the livestream was started, the key point flag was first applied by the livestreamer, followed by the excitement flag, and then the interesting comment flag. This allows the livestreamer to easily grasp the portions with flags.

The livestreamer taps the excitement button 2646 when he/she feels the excitement of the livestream during the livestream, taps the key point button 2648 when he/she feels a key point, and taps the interesting comment button 2650 when he/she finds interesting comments. When detecting a tap on any button during the livestream, the livestreamer-side UI control unit 108 of the user terminal receives the tap as a button designation by the livestreamer. The livestreamer-side communication unit 110 of the user terminal generates a flag application signal including information identifying the designated button, i.e., a flag ID indicating whether the designated button is the excitement button 2646, the key point button 2648, or the interesting comment button 2650, and the timing or time when the button was designated. The livestreamer-side communication unit 110 then transmits the generated flag application signal to the server 2010 over the network NW. In this embodiment, the excitement button 2646 corresponds to the flag ID “FLGA” in FIG. 41, the key point button 2648 corresponds to the flag ID “FLGB” in FIG. 41, and the interesting comment button 2650 corresponds to the flag ID “FLGC” in FIG. 41.

FIG. 48 is a representative screen image of a livestreaming room screen 2630 displayed on the display of the livestreamer's user terminal 2020 during a livestream. FIG. 48 shows the state immediately after a tap on the excitement button 2646 in the livestreaming room screen 2630 of FIG. 47. The livestreaming room screen 2630 in FIG. 48 shows a new excitement flag object 2654 near the right end of the time axis object 2638. The new excitement flag object 2654 corresponds to the tap on the excitement button 2646. At the same time, the livestreaming room screen 2630 shows text 2652 indicating that a flag button has been tapped and a sticky has been added.

FIG. 49 is a representative screen image of an archive browsing screen 2700 displayed on the display of the active user's user terminal. This active user is viewing the archive of his/her own livestream on the archive browsing screen 2700. The archive browsing screen 2700 includes an archive reproducing region 2702 that displays the video obtained by reproducing the archive, a progress bar 2704 that indicates the current reproducing position of the video being reproduced in the archive reproducing region 2702, objects related to application and display of flags, and a comment display region 2720 for displaying comments.

The out-of-livestream UI control unit 402 of the user terminal reproduces the archive received from the server 2010 and displays the resulting video in the archive reproducing region 2702. At the same time, the out-of-livestream UI control unit 402 updates the display of the progress bar 2704 to indicate the current reproducing position of the video. The progress bar 2704 includes a thumb object 2722 and a bar object 2724. The bar object 2724 represents the entire length of the archive by its total length. The position of the thumb object 2722 on the bar object 2724 indicates the current reproducing position.

The objects related to application and display of flags include an excitement flag object 2706, a key point flag object 2708, an interesting comment flag object 2710, an excitement button 2714, a key point button 2716, and an interesting comment button 2718. The progress bar 2704, the excitement flag object 2706, the key point flag object 2708, and the interesting comment flag object 2710 together constitute a graphical user interface that represents the timings at which the flags are applied during delivery of the livestream or viewing of the archive. The correspondences in the display style between the flag objects and the buttons are the same as those described in FIG. 47. The position of each flag object in the progress bar 2704 represents the timing at which the flag was applied.

The active user taps the excitement button 2714 when he/she feels the excitement of the livestream during viewing of his/her own archive, taps the key point button 2716 when he/she feels a key point, and taps the interesting comment button 2718 when he/she finds interesting comments. When detecting a tap on any button during viewing of the archive, the out-of-livestream UI control unit 402 of the user terminal receives the tap as a button designation by the active user. The out-of-livestream communication unit 404 of the user terminal generates a flag application signal including a flag ID corresponding to the designated button and the timing or time when the button was designated. The out-of-livestream communication unit 404 then transmits the generated flag application signal to the server 2010 over the network NW.

When the active user manipulates the cursor 2712 on the archive browsing screen 2700 in FIG. 49 and places the cursor 2712 at a position on the progress bar 2704, the out-of-livestream UI control unit 402 may display the partial video of the archive including the timing indicated by the position of the cursor 2712 in the archive reproducing region 2702. For example, if the position of cursor 2712 on progress bar 2704 indicates 3 minutes 35 seconds after the start of the archive, a 30-second partial video or clip ranging from 3 minutes 20 seconds to 3 minutes 50 seconds of the archive may be reproduced in the archive reproducing region 2702. In addition, the comment display region 2720 may show the comments posted during that 30-second period.

Alternatively, it is also possible that the system identifies exciting portions in the archive and such portions are picked up and displayed on the progress bar 2704 as round dots. When one of these round dots is tapped, this portion of the video may be automatically reproduced for several tens of seconds. In this case, it is easier for the livestreamer to find the exciting portions.

In the above embodiment, the DBs may be implemented by, for example, hard disks or semiconductor memory. By reading the present disclosure, those skilled in the art would understand that each element or component can be realized by a CPU not shown, a module of an installed application program, a module of a system program, or a semiconductor memory that temporarily stores the contents of data read from a hard disk, and the like.

With the livestreaming system 2001 according to this embodiment, the editing process of combining clips of a livestream to generate a single highlight video can be performed more efficiently and/or more easily. When the editor selects a target clip and enters an editing instruction, the ML model automatically performs labor-intensive video processing, merging, and transition processing, thereby reducing the burden of editing work.

In addition, the livestreaming system 2001 according to this embodiment can combine clips from different livestreams to create a highlight video, which allows for a more flexible editing process with a high degree of freedom.

In the livestreaming system 2001 according to this embodiment, the livestreamer can apply flags during delivery of a livestream or viewing of an archive. These flags are used for automatic generation of clips. This allows the operation and intention of the livestreamer to be incorporated into the clip generation criteria. As a result, the clips generated are more in line with the livestreamer's intention, and thus user satisfaction is improved.

In addition, since there are multiple types of flags, the livestreamer can select the right flag for the situation. Since a graphical user interface is provided that shows when and which flags were applied by the livestreamer, it is easier for the livestreamer to grasp the flag application state.

In the fourth embodiment, it was described that clips are automatically generated by the system, but this is not limitative. For example, a livestreamer or a viewer may be able to manually generate clips from an archive or a livestream. The livestreaming system may be configured to assist in this manual generation.

In the fourth embodiment, it was described that the editor selects desired clips from the clips generated from the archive of his/her livestream to generate a highlight video, but this is not limitative. For example, the system may be configured to allow an editor to generate a highlight video by selecting desired clips from clips generated from the archives of livestreams of other livestreamers.

The conversion rate from the price points of a gift to a reward to be awarded in the fourth embodiment is merely an example, and the conversion rate may be appropriately set by the administrator of the livestreaming system, for example.

The technical idea according to the fourth embodiment may be applied to live commerce or virtual livestreaming using an avatar that moves in synchronization with the movement of the livestreamer instead of the image of the livestreamer. In the present embodiment, the video data related to the livestream that is generated at the user terminal of the livestreamer is relayed by the server and sent to the user terminal of the viewer. The present invention, however, is not limited to such. For example, the technical ideas of the present embodiment can also be applied to a virtual livestreamer in place of an actual livestreamer. A virtual livestreamer is an AI virtual livestreamer having an appearance represented by an avatar, emits audio produced by a text-to-speech (TTS) engine, and says what is generated by a machine learning model receiving comments posted by viewers. In this case, the livestreamer has no user terminal, and the server performs the livestreamer-side processes.

In the fourth embodiment, the editing ML model may generate thumbnails according to target properties, in addition to the versions according to the target properties. When a viewer views an editor's profile screen on the display of the user terminal, the thumbnails of the highlight videos that appear on the profile screen are the thumbnails according to the target property of that viewer. When another viewer with a different target property accesses the same editor's profile screen, the thumbnails of the highlight videos that appear on the profile screen are different from the thumbnails mentioned above.

The fourth embodiment according to this disclosure may include at least one of the following elements.
1. Intelligent scene analysis engine configured to:
   split long videos into meaningful units (scenes, topics, statements, etc.);
   use image analysis, speech recognition, and natural language processing technologies in an integrated manner; and
   evaluate the importance, emotional impact, and technical quality of each scene.
2. Context understanding module configured to:
   analyze the context and intention of the entire video; and
   identify genre, target viewers, and narrative structure.
3. Editorial suggestion generating engine configured to:
   suggest the optimal editorial order based on the context and intention of the content; and
   generate suggestions for different editing styles (dynamic, emotional, informative, etc.)
4. Real-time highlight generation module configured to:
   identify important scenes in real time during a livestream; and
   automatically generate instantly editable highlight clips.
5. Viewer reaction analysis engine configured to:
   analyze viewer comments, engagement, and viewing patterns; and
   identify popular scenes and topics and reflect them in editorial strategies.
6. Multi-source integration editor configured to:
   extract related scenes from multiple video sources and integrate them; and
   provide multiple perspectives while maintaining a consistent narrative.
7. AI-assisted editing interface configured to:
   enable intuitive drag-and-drop operation for advanced editing; and
   display AI-based editing suggestions in real time to help editors make decisions.
8. Automatic transition/effect generator configured to:
   automatically generate smooth transitions between scenes; and
   suggest appropriate visual effects to match the mood of the content.
9. Personalized content variation generator configured to:
   automatically generate multiple versions from the same material for different target viewers; and
   adjust length, tone, and focus point.
10. Quality assurance/consistency checker configured to:
   automatically check edited content for technical quality and consistency; and
   point out potential problems (e.g., audio discrepancies, visual discontinuities).
11. Prompt-based importance specification module configured to:
   allow users to specify editorial intention and emphasis through natural language or GUI;
   customize AI analysis and suggestions based on specified importance; and
   allow priority changes during the editing process by dynamic prompt adjustment.
12. Livestreamer interaction/flag system configured to:
   allow livestreamers to apply flags such as “excitement” with a single touch during a livestream;
   record and analyze the type of flags applied and timing and frequency of such application; and
   transmit flag data to AI analysis engine in real time for editorial recommendations.
13. Flag-linked recommendation optimization engine configured to:
   incorporate flags applied by the livestreamer into the recommendation algorithm as a key indicator;
   combine flag data and viewer reaction data for more accurate extraction of important scenes; and
   provide different weights for different types of flags to reflect diverse “excitement” qualities.

The livestreaming system 2001 according to the fourth embodiment produces at least one of the following effects.
1. Significant efficiency and time savings in the video editing process
2. Facilitation of high-quality and consistent content production
3. Instant editing and delivery of live content
4. Development of effective editorial strategies based on viewer interests
5. Simplification of integrated content production from multiple sources
6. Expansion of the creativity of editors for opening up possibilities of new expression
7. Facilitation of personalization and diversification of content
8. Effective integration of user intention and AI capabilities for more precise editing assistance
9. Facilitation of a creative editorial process by flexibly addressing diverse editorial needs
10. More accurate and realistic editing support that instantly reflects the intuitive judgment of livestreamers
11. Highly personalized content generation through collaboration between humans (livestreamers) and AI
12. The editor can input the instructions (intentions) indicating the key portions to select the best portions.

The technical ideas relating to the fourth embodiment are also applicable to the following examples.
1. News production support system configured to:
   automatically extract the best clips from long news footage to fit the context of the news; and
   generate highlight in real time and instantly edit and deliver it during live news broadcasts.
2. Automatic sports highlight generation system configured to:
   analyze game footage from multiple cameras and automatically extract the most memorable moments; and
   generate personalized highlight videos while taking viewer reactions into consideration.
3. Educational content optimization tool configured to:
   create effective summary videos by extracting key points from long lecture videos; and
   generate multiple versions of an explanation with the level of detail adjusted according to the learner's level of understanding.
4. Marketing video customization system configured to:
   automatically customize the same product introduction video for different target viewers; and
   efficiently generate multiple versions for A/B testing.
5. Social media content optimization tool configured to:
   automatically generate clips optimized for each platform from long video content; and
   analyze viewer engagement and suggest highly viral edits.
6. Documentary production support system configured to:
   suggest optimal scenes from a large amount of shooting material in accordance with the narrative structure; and
   integrate multiple interview videos to create a consistent story line.

The technical ideas relating to the fourth embodiment may be represented by the following items.
1. A means for analyzing video content to automatically identify and extract scenes suitable for editing.
2. A means for understanding the context and intention of the content and suggesting the best editorial order.
3. A means for generating highlights in real time during a livestream.
4. A means for analyzing viewer reactions and interests and reflecting them in editorial strategies.
5. A means for extracting and integrating related scenes from multiple video sources.
6. A means for providing AI-assisted intuitive editing interface.
7. A means for generating automatic transitions between scenes and effects.
8. A means for automatically generating multiple versions for different targets from the same material.
9. A means for automatically checking the quality and consistency of edited content.
10. A means for users to specify editorial intention and emphasis through natural language or GUI, and customize AI analysis and suggestions.
11. A means for applying a flag by a simple operation by a livestreamer during a livestream.
12. A means for recording and analyzing data of applied flags and reflecting them in editorial recommendations.
13. An AI-driven video content analysis and editing support integration system, including a means for optimizing recommendation algorithms by integrating flag data with other analysis data.

The following is a list of examples of applications of the fourth embodiment.
1. Continuous improvement of deep learning models and expansion of learning data
2. Support for new video formats and platforms
3. Improved real-time processing capabilities at edge devices
4. Examination of legal aspects of privacy and content rights
5. Further integration with creator workflows
6. Advanced integrated analysis of multimodal materials (video, audio, text)
7. Customization for different genres and industry-specific needs
8. Continuous feature improvements and enhancements based on user feedback
9. Development of more advanced prompt interpretation capabilities to keep pace with advances in natural language processing technology
10. Implementation of personalized prompt suggestions based on learning of the user's editing style and preferences
11. Support for international content production by integrating multiple language support and automatic translation functions
12. Support for augmented reality (AR) and virtual reality (VR) content
13. Improved rights management and transparency of content using blockchain technology
14. Understanding and reflecting viewer reactions in more detail through advanced emotion analysis technology
15. Development of AI-based creative editing suggestion functions (e.g., suggestions of new transition effects and narrative structure)
16. Development of environmentally friendly and efficient processing algorithms (Green AI)
17. Enhanced integration with other creative tools (image editing software, 3D modeling tools, etc.)
18. Addition of automatic selection and generation of music and sound effects
19. Realization of intuitive editing operations through user gestures and voice commands
20. Clarification of grounds for editorial suggestions by improving the Explainable AI model

As these diverse examples demonstrate, this system is applicable to a wide range of industries and content types, and its versatility and scalability provide major advantages.

In the fourth embodiment, a comment rate, or an amount of comments per unit of time, may be used as an indicator for determining exciting portions of an archive or livestream. The comment rate may be determined by measuring comments from the viewers and livestreamer, or comments from the viewers only (not including the livestreamer). A comment criterion may be established to select comments that contribute to the calculation of the comment rate. For example, comments with fewer characters than a predetermined minimum number may be excluded from the calculation of the comment rate.

The technical ideas relating to the fourth embodiment may be represented by the following items.

### <Item 1>

A server comprising:
means for generating a plurality of different video data, each of which is a portion of an original video data;
means for obtaining, from a terminal of a user over a network, information indicating at least one video data selected by the user from among the plurality of video data;
means for obtaining, from the terminal over the network, an editing instruction by the user;
means for obtaining edited video data output by a machine learning model to which the information and the editing instruction have been input; and
means for providing the edited video data to the terminal over the network.

### <Item 2>

The server of Item 1, wherein the plurality of video data includes video data that is a portion of an original first video data and video data that is a portion of an original second video data.

### <Item 3>

The server of Item 1, wherein the machine learning model outputs a plurality of edited video data, each corresponding to a different viewer property.

### <Item 4>

The server of Item 1, wherein the information includes an order of video data adjusted by the user and a tag and/or an annotation applied by the user to each selected video data.

### <Item 5>

The server of Item 1,
wherein the original video data is video data related to a livestream, and
wherein the means for generating the plurality of different video data generates the plurality of video data based on a reaction of a viewer of the livestream and an action of a livestreamer of the livestream.

### <Item 6>

The server of Item 5, wherein the action of the livestreamer of the livestream includes application of a flag by the livestreamer at a desired timing during the livestream.

### <Item 7>

A computer program for causing a terminal of a livestreamer of a livestream to perform the functions of:
displaying an object on a display of the terminal during the livestream in association with a video of the livestream;
receiving designation of the object by the livestreamer during the livestream; and
transmitting, to a server over a network, a timing at which the object was designated in the livestream.

### <Item 8>

The computer program of Item 7,
wherein displaying the object includes displaying a plurality of different objects, and
wherein transmitting the timing includes transmitting, to the server over the network, information identifying the designated object and the timing at which the object was designated.

### <Item 9>

The computer program of Item 7, wherein the computer program further causes the terminal to perform the function of displaying on the display of the terminal a graphical user interface representing the timing at which the object was designated in the livestream.

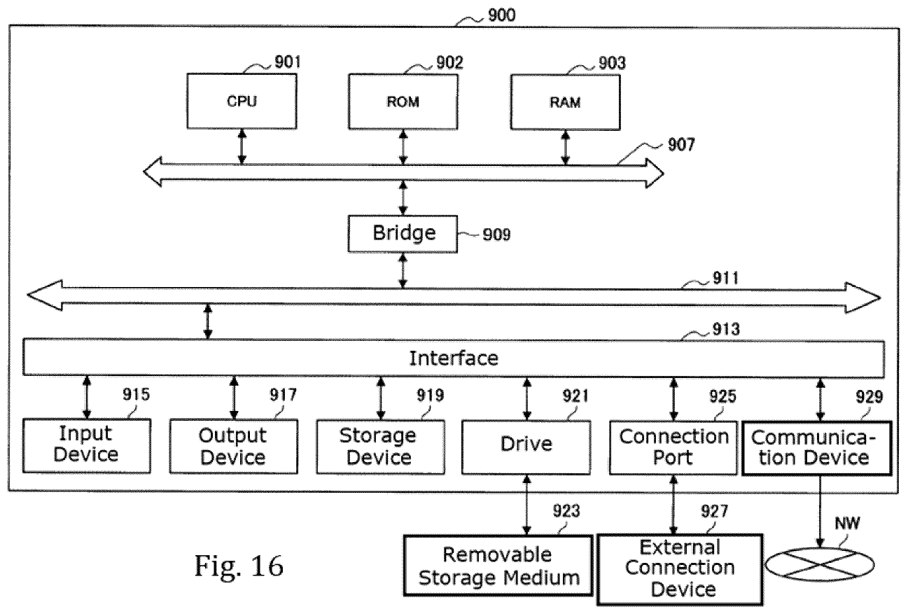

Referring to FIG. 16, the hardware configuration of an information processing device according to the first to fourth embodiments will be now described. FIG. 16 is a block diagram showing an example of a hardware configuration of an information processing device according to the first to fourth embodiments. The illustrated information processing device 900 may, for example, realize the server and the user terminals in the first to fourth embodiments.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). The CPU 901 is an example of a hardware structure that can realize the functions performed by the constituent elements described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the livestreaming unit 100, the image capturing control unit 102, the audio control unit 104, the video transmission unit 106, the livestreamer-side UI control unit 108, the livestreamer-side communication unit 110, the viewing unit 200, the viewer-side UI control unit 202, the viewer-side communication unit 204, the out-of-livestream processing unit 400, the out-of-livestream UI control unit 402, the out-of-livestream communication unit 404, the livestream information providing unit 302, the relay unit 304, the gift processing unit 308, the payment processing unit 310, the summary generating unit 322, the detail generating unit 324, the summary generating model 326, the detail generating model 328, the candidate comment generating unit 330, the training unit 1330, the setting unit 1332, the progress processing unit 1334, the evaluation unit 1336, the feedback unit 1338, the model generating unit 1350, the model deploying unit 1352, the support integration system 2322, the archive generating unit 2324, the clip generating unit 2326, the editing content obtaining unit 2328, the editing processing unit 2330, and the edited video providing unit 2332 may be embodied as circuitry programmed to realize such functions.

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the servers 10, 1010, 2010 and the user terminals 20, 30, 1020, 1030, 2020, 2030 in the embodiments. The ROM 902 stores programs, calculation parameters, and the like used by the CPU 901. The RAM 903 serves as a primary storage that stores programs including sets of instructions to be used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and give instructions for processing to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the mounted removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the livestreaming system in the embodiments have been described. These embodiments are merely an example, and it will be understood by those skilled in the art that various modifications are possible by combining the respective components and processes, and that such modifications are also within the scope of the present disclosure.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server may be realized by a device(s) other than the server, for example, the user terminals. At least some of the functions realized by the user terminals may be realized by a device(s) other than the user terminals, for example, the server. For example, the superimposition of a predetermined frame image on an image of the video data performed by the viewer's user terminal may be performed by the server or may be performed by the livestreamer's user terminal.

What is claimed is:

1. A server comprising a circuitry, wherein the circuitry is configured to:
obtain, at a first point of time during progress of a livestream, first time-series data representing content of the livestream recorded as the livestream progresses;
generate summary information of the livestream as of the first point of time based on the first time-series data obtained;
obtain, at a second point of time during progress of the livestream later than first point of time, second time-series data representing content of the livestream recorded as the livestream progresses; and
generate summary information of the livestream as of the second point of time based on the second time-series data obtained.

2. The server of claim 1, wherein the circuitry is further configured to transmit the summary information as of the first point of time over a network to a terminal of a viewer who has participated in the livestream before the second point of time, and transmit the summary information as of the second point of time over a network to a terminal of a viewer who has participated in the livestream after the second point of time.

3. The server of claim 1, wherein the circuitry is configured to generate the summary information as of the first point of time by inputting the first time-series data to a machine learning model, and generate the summary information as of the second point of time by inputting the second time-series data to the machine learning model.

4. The server of claim 3, wherein the circuitry is further configured to receive information for adjusting the machine learning model from a terminal of a livestreamer of the livestream when the livestream is started.

5. The server of claim 1, wherein the circuitry is configured to obtain time-series data and generate summary information periodically.

6. The server of claim 1, wherein the first point of time is a point of time at which a viewer participated in the livestream, and the second point of time is a point of time at which another viewer participated in the livestream.

7. The server of claim 6, wherein the circuitry is configured to generate the summary information as of the first point of time according to a property of the viewer, and generate the summary information as of the second point of time according to a property of the other viewer.

8. A terminal of a livestreamer of a livestream, comprising:
one or more processors; and
memory storing one or more computer programs configured to be executed by the one or more processors,
the one or more computer programs including instructions for:
transmitting a request to a server over a network;
receiving, from the server over the network, summary information of a livestream in progress, the summary information having content that is variable according to a timing at which the request takes place;
starting reproduction of a video related to the livestream; and
displaying the summary information on a display as the reproduction of the video is started.

9. The terminal of claim 8, wherein displaying the summary information includes:
displaying an object on the display as the reproduction of the video is started; and
displaying the summary information on the display when designation of the object is received.

10. The terminal of claim 8,
wherein receiving the summary information includes receiving, along with the summary information, detailed information including more detailed content about the livestream than the summary information, and
wherein displaying the summary information includes:
displaying an object on the display as the summary information is provided; and
providing the detailed information when designation of the object is received.

11. The terminal of claim 8, wherein the one or more computer programs further include instructions for:
receiving, from the server over the network, a plurality of candidate comments having content that is variable according to a timing at which the request takes place; and
displaying the plurality of candidate comments on the display as the summary information is provided.

12. The terminal of claim 8,
wherein starting the reproduction includes starting the reproduction of the video related to the livestream in a first mode,
wherein displaying the summary information includes providing the summary information as the reproduction of the video in the first mode is started,
wherein the one or more computer programs include further instructions for:
causing the terminal to start reproduction of the video in a second mode in response to reception of a predetermined user input in the first mode, and
wherein disclosure of information on a user of the terminal is more restricted in the first mode than in the second mode.

13. A method, comprising:
obtaining, at a first point of time during progress of a livestream, first time-series data representing content of the livestream recorded as the livestream progresses;
generating summary information of the livestream as of the first point of time based on the first time-series data obtained;
obtaining, at a second point of time during progress of the livestream later than first point of time, second time-series data representing content of the livestream recorded as the livestream progresses; and
generating summary information of the livestream as of the second point of time based on the second time-series data obtained.

14. The method of claim 13, further comprising transmitting the summary information as of the first point of time over a network to a terminal of a viewer who has participated in the livestream before the second point of time, and transmitting the summary information as of the second point of time over a network to a terminal of a viewer who has participated in the livestream after the second point of time.

15. The method of claim 13, wherein the summary information as of the first point of time is generated by inputting the first time-series data to a machine learning model, and the summary information as of the second point of time is generated by inputting the second time-series data to the machine learning model.

16. The method of claim 15, further comprising receiving information for adjusting the machine learning model from a terminal of a livestreamer of the livestream when the livestream is started.

17. The method of claim 13, wherein time-series data is obtained periodically, and summary information is generated periodically.

18. The method of claim 13, wherein the first point of time is a point of time at which a viewer participated in the livestream, and the second point of time is a point of time at which another viewer participated in the livestream.

19. The method of claim 18, wherein the summary information as of the first point of time is generated according to a property of the viewer, and the summary information as of the second point of time is generated according to a property of the other viewer.

20. The method of claim 13, further comprising:
receiving, from a terminal of a livestreamer of a livestream over a network, data including behavior of the livestreamer, participants of the livestream including the livestreamer and a plurality of viewers including a virtual viewer realized by a machine learning model;
obtaining a reaction output by the machine learning model, the machine learning model taking as input the behavior of the livestreamer and outputting the reaction that would be made by a viewer with a property set thereto; and
transmitting data for realizing the reaction to the terminal over the network.
